(19) United States
(12) Patent Application Publication
(10) Pub. No.: US 2023/0110467 A1
(43) Pub. Date: Apr. 13, 2023

(54) COLLECTIVE PERCEPTION SERVICE REPORTING TECHNIQUES AND TECHNOLOGIES

(71) Applicants: Satish C. Jha, Portland, OR (US); Kathiravetpillai Sivanesan, Portland, OR (US); Vesh Raj Sharma Banjade, Portland, OR (US); Arvind Merwaday, Beaverton, OR (US); Leonardo Gomes Baltar, Muenchen (DE)

(72) Inventors: Satish C. Jha, Portland, OR (US); Kathiravetpillai Sivanesan, Portland, OR (US); Vesh Raj Sharma Banjade, Portland, OR (US); Arvind Merwaday, Beaverton, OR (US); Leonardo Gomes Baltar, Muenchen (DE)

(21) Appl. No.: 18/079,499

(22) Filed: Dec. 12, 2022

Related U.S. Application Data
(60) Provisional application No. 63/309,283, filed on Feb. 11, 2022.

(51) Int. Cl. G08G 1/01; B60W 60/00

(52) U.S. Cl. CPC G08G 1/0141; B60W 60/00; B60W 2556/45; B60W 2554/404

(57) ABSTRACT

The present disclosure is related to connected vehicles, computer-assisted and/or autonomous driving vehicles, Internet of Vehicles (IoV), Intelligent Transportation Systems (ITS), and Vehicle-to-Everything (V2X) technologies, and in particular, to enhanced collective perception service (CPS) reporting mechanisms. The enhanced collective perception reporting mechanisms utilize multiple collective perception message (CPM) reporting mechanisms to share CPS data with reduced communication overhead, reduced latency, reduced processing complexity, and at the same time, enabling sharing information related to perceived and/or detected objects.

### RELATED APPLICATIONS

The present application claims priority to U.S. Provisional App. No. 63/309,283 filed on Feb. 11, 2022, the contents of which is hereby incorporated by reference in its entirety.

### TECHNICAL FIELD

The present disclosure is generally related to connected vehicles, computer-assisted and/or autonomous driving vehicles, Internet of Vehicles (IoV), Intelligent Transportation Systems (ITS), and Vehicle-to-Everything (V2X) technologies, and in particular, to enhanced collective perception reporting mechanisms.

### BACKGROUND

Intelligent Transport Systems (ITS) comprise advanced applications and services related to different modes of transportation and traffic to enable an increase in traffic safety and efficiency, and to reduce emissions and fuel consumption. Various forms of wireless communications and/or Radio Access Technologies (RATs) may be used for ITS. Cooperative Intelligent Transport Systems (C-ITS) have been developed to enable an increase in traffic safety and efficiency, and to reduce emissions and fuel consumption. The initial focus of C-ITS was on road traffic safety and especially on vehicle safety. C-ITS includes Collective Perception Service (CPS), which supports ITS applications in the road and traffic safety domain by facilitating information sharing among ITS stations.

### BRIEF DESCRIPTION OF THE DRAWINGS

In the drawings, which are not necessarily drawn to scale, like numerals may describe similar components in different views. Like numerals having different letter suffixes may represent different instances of similar components. Some implementations are illustrated by way of example, and not limitation, in the figures of the accompanying drawings in which:

FIGS. 1 and 2 illustrates example Collective Perception Message (CPM) structures.

FIGS. 3, 4, and 5 illustrate example costmaps for perception.

FIG. 6 shows an example process of for alternating between multiple CPM reporting mechanisms.

FIG. 7 depicts an example of alternating periodic CPM reporting mechanisms.

FIG. 8 depicts an example CPM generation process.

FIG. 9 depicts an example perceived object container candidate selection process.

FIG. 10 depicts an example costmap container candidate selection process.

FIG. 11 depicts an example CPM segmentation process.

FIG. 12 illustrates an operative Intelligent Transport System (ITS) environment and/or arrangement.

FIG. 13 depicts an ITS-S reference architecture.

FIG. 14 depicts a collective perception basic service (CPS) functional model.

FIGS. 15 and 16 depict CPM generation management architectures.

FIG. 17 depicts example object data extraction levels for the CPS.

FIG. 18 depicts a vehicle station.

FIG. 19 depicts a personal station.

FIG. 20 depicts a roadside infrastructure node.

FIG. 21 depicts example components of an example compute node.

### DETAILED DESCRIPTION

### 1. Collective Perception Services

As alluded to previously, CPS supports ITS applications (apps) in the domain of road and traffic safety by facilitating information sharing among ITS-Ss. Collective Perception reduces the ambient uncertainty of an ITS-S about its current environment, as other ITS-Ss contribute to context information. By reducing ambient uncertainty, it improves efficiency and safety of the ITS. Aspects of CPS are described in ETSI TS 103 324 v.0.0.22 (2021-05) and ETSI TS 103 324 v.0.0.44 (2022-11) (“[TS103324]”), the contents of which is hereby incorporated by reference in its entirety.

CPS provides syntax and semantics of Collective Perception Messages (CPM) and specification of the data and message handling to increase the awareness of the environment in a cooperative manner. CPMs are exchanged in the ITS network between ITS-Ss to share information about the perceived environment of an ITS-S such as the presence of road users, other objects, and perceived regions (e.g., road regions that together with the contained object allow receiving ITS-Ss to determine drivable areas that are free from road users and collision-relevant objects). This allows CPS-enabled ITS-Ss to enhance their environmental perception not only regarding non-V2X-equipped road users and drivable regions, but also increasing the number of information sources for V2X-equipped road users. A higher number of independent sources generally increases trust and leads to a higher precision of the environmental perception.

A CPM contains a set of detected objects and regions, along with their observed status and attribute information. The content may vary depending on the type of the road user or object and the detection capabilities of the originating ITS-S. For detected objects, the status information is expected to include at least the detection time, position, and motion state. Additional attributes such as the dimensions and object type may be provided. To support the CPM interpretation at any receiving ITS-S, the sender can also include information about its sensors, like sensor types and fields of view

In some cases, the detected road users or objects are potentially not equipped with an ITS-S themselves. Such non-ITS-S equipped objects cannot make other ITS-Ss aware of their existence and current state and can therefore not contribute to the cooperative awareness. A CPM contains status and attribute information of these non-ITS-S equipped users and objects that have been detected by the originating ITS sub-system. The content of a CPM is not limited to non-ITS-S equipped objects but may also include measured status information about ITS-S equipped road users. The content may vary depending on the type of the road user or object and the detection capabilities of the originating ITS sub-system. For vehicular objects, the status information is expected to include at least the actual time, position and motion state. Additional attributes such as the dimensions, vehicle type and role in the road traffic may be provided.

The CPM complements the Cooperative Awareness Message (CAM) (see e.g., ETSI EN 302 637-2 v1.4.1 (2019-04) (“[EN302637-2]”)) to establish and increase cooperative awareness. The CPM contains externally observable information about detected road users or objects and/or free space. The CP service may include methods to reduce duplication of CPMs sent by different ITS-Ss by checking for sent CPMs of other stations. On reception of a CPM, the receiving ITS-S becomes aware of the presence, type, and status of the recognized road user or object that was detected by the transmitting ITS-S. The received information can be used by the receiving ITS-S to support ITS apps to increase the safety situation and to improve traffic efficiency or travel time. For example, by comparing the status of the detected road user or received object information, the receiving ITS-S sub-system is able to estimate the collision risk with such a road user or object and may inform the user via the HMI of the receiving ITS sub-system or take corrective actions automatically. Multiple ITS apps may rely on the data provided by CPS. It is assigned to domain app support facilities in ETSI TS 102 894-1 v1.1.1 (2013-08) (“[TS102984-1]”).

On reception of a CPM, the receiving (Rx) ITS-S becomes aware of the presence, type, and status of the recognized road user, object, and/or region that was detected by the transmitting (Tx) ITS-S. The received information can then be used by the Rx ITS-S to support ITS apps to increase the safety situation and to improve traffic efficiency or travel time. For example, by comparing the status of the detected road user or received object information, the Rx ITS-S can estimate the collision risk with that road user or object and may inform the user via the HMI of the Rx ITS-S or take corrective actions automatically. Multiple ITS apps may thereby rely on the data provided by the CPS.

Currently, CPM reporting mechanisms report individual objects (IOs) in CPMs, where two containers in a CPM carry information about perceived objects, namely a perceived object container (POC) and a free space addendum container (FSAC) (see e.g., [TS103324]). IO-based CPM reporting mechanisms (“IO-CPM reporting”) generate CPMs (“IO-CPMs”) including details of each detected object (e.g., location/position, type, dimension, kinematic attributes, and/or other parameters, conditions, or criteria of each perceived object). However, IO-CPM reporting reports each perceived object (e.g., road user) as separate objects, which can be very inefficient in terms of resource consumption/efficiencies, such as in scenarios including the presence of large number of objects or overlapping view of objects. For example, reporting each individual perceived object in case of large number of perceived objects creates huge communication overhead. In case of overlapped view of objects or occlusion of objects in the FOV of sensors, perception of all objects itself is challenging task. In such situations, a layered costmap or an occupancy grid based collective perception may be bandwidth and computationally efficient.

['031] and ['723] discuss CPS based on layered costmap (LCM) sharing for scenarios such as presence of large number of objects or overlapping view of objects or occlusion of objects in the field of view (FoV) of sensors at an ITS-S. A new CPM container, referred to herein as a costmap container (CMC) or as an LCM container (LCMC), can be included in a CPM to describe and report a costmap (or an LCM). In some cases, a CMC may replace or complement the POC and FSAC thereby significantly reducing communication overhead. In case of LCMC inclusion, one or more layers of the LCM reports information about a specific type of objects in a rectangular occupancy grid. Each cell in a rectangular occupancy grid (e.g., costmap around a Tx ITS-S) carries a cost (e.g., a value indicating whether a corresponding cell is safe, caution, or lethal to traveling or moving through) or occupancy indication (e.g., unknown, occupied, or not occupied) of the cells with a corresponding confidence level.

It has been observed that costmap-based CPMs (“CM-CPMs”) reduce the overall size of the CPMs and provide fixed message size independent of the number of detected objects and reduces data fusion complexity and resource consumption at the Rx ITS-S as association among objects reported by various neighbors is not needed. However, costmap-based CPM reporting mechanisms (“CM-CPM reporting”) may lose some information (or provide coarse information) of detected objects in the environment, such as information about location/position, type, dimension, kinematic attributes, and/or other parameters, conditions, or criteria of objects may be coarse or not readily available. On the other hand, IO-CPM reporting is effective in reporting details of each detected object. However, in crowded scenarios with large number of objects or overlapping view of objects in the FoV of sensors, IO-CPM reporting may be complex (e.g., as IO detection may not be possible), requires CPMs to have very large sizes, and/or can take several transmission cycles to report all objects in one or multiple CPMs. This may lead to large communication overhead and/or inefficient resource consumption, higher latency, and higher processing complexity at the Rx ITS-S. Therefore, these types of reporting mechanisms (i.e., CM-CPM reporting and IO-CPM reporting) are complementary to each other.

The present disclosure provides various mechanisms to utilize these two reporting mechanisms to acquire CPS data with reduced communication overhead, reduced latency, reduced processing complexity at Rx ITS-Ss, and at the same time, sharing suitable details of detected/perceived objects.

A first mechanism alternates between using periodic IO-CPM reporting and CM-CPM reporting. In some implementations, IO-CPM reporting is performed with longer periodicity than a periodicity of the CM-CPM reporting with periodic CM-CPM reporting complementing in between two consecutive IO-CPM reporting. For example, one or more CM-CPM reporting periods may take place within a IO-CPM reporting period.

A second mechanism adjusts the periodicities for the IO-CPM reporting and CM-CPM reporting. This may include dynamically adjusting the periodicities and/or semi-statically adjusting the periodicities. A third mechanism includes event-based IO-CPM reporting (e.g., in addition to periodic IO-CPM reporting) to share details of critical or desired object detection immediately with Rx ITS-Ss. The third mechanism may be used with the second mechanism or separately from the second mechanism.

A fourth mechanism provides co-existence of POCs and CMCs to enable overhead efficient CPM without losing details of detected objects. In some implementations, the CPMs may or may not include the FSAC. In some implementations, additional data fields/flags can be included for various containers (e.g., POC, FSAC, CMC) to provide association among CPMs transmitted using the different CPM reporting mechanisms. Additionally or alternatively, new DEs/DFs can be provided in the CMC to provide height value (e.g., Z-direction) occupied by perceived objects (e.g., tunnel roof, parking garage clearance, bridge or overpass, objects on bridges or overpasses, overhead tree branches, drones or other flying objects, and/or the like). Multiple formats/configurations are provided to specify the height information in the CMC in an efficient way (e.g., in terms of overhead and/or message size).

A fifth mechanism determines a confidence level of a cell in the CM for scenarios including when multiple confidence levels are reported by neighbors for a cell in overlapped costmap grid, and when an object spans multiple cells in the costmap.

The technical solutions discussed herein allow collective perception to take place among proximate (neighboring) ITS-S for efficient, safe, and coordinated autonomous driving environments.

1.1. Collective Perception Message Contents and Formats

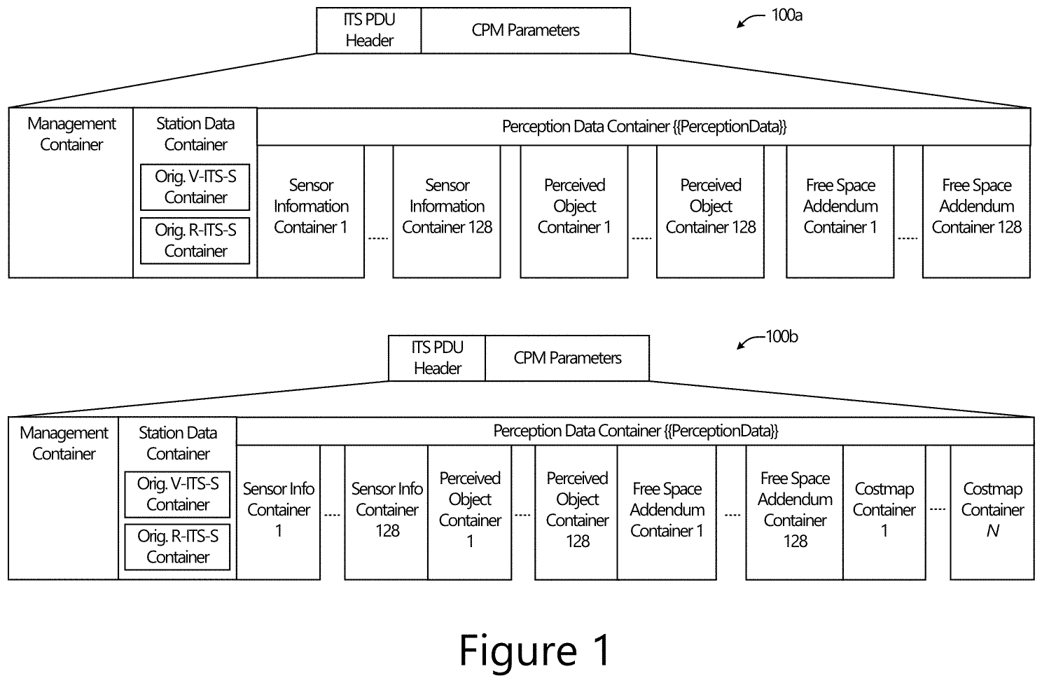

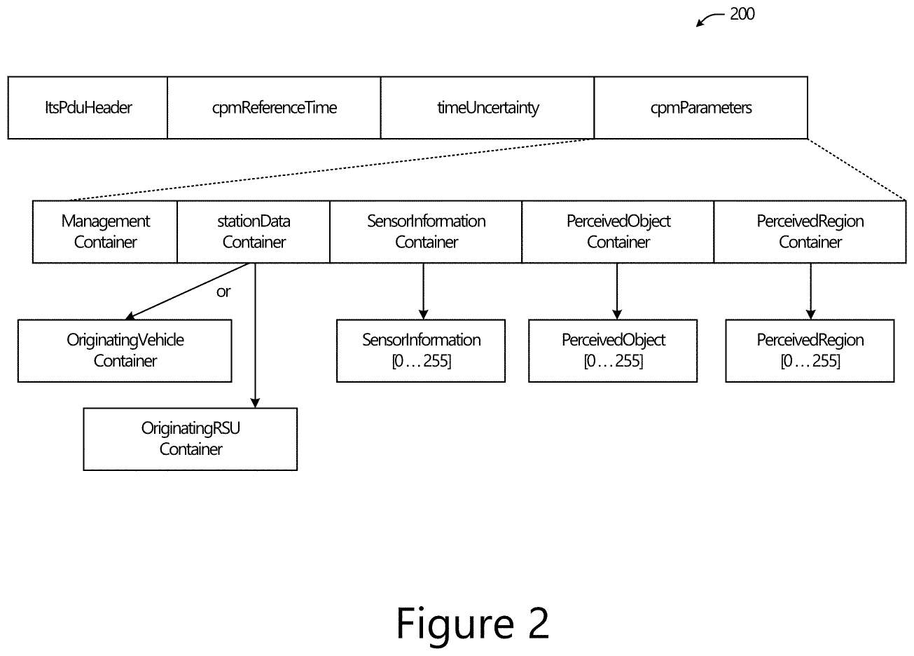

The CPS is a facility layer entity that operates the CPM protocol, which provides services including: sending and receiving of CPMs (e.g., CPM 100a, 100b, and/or 200 discussed infra with respect to (w.r.t) FIGS. 1 and 2). The CPS uses the services provided by the protocol entities of the ITS networking & transport layer to disseminate the CPM 100.

Sending CPMs 100 comprises the generation and transmission of CPMs 100. In the course of CPM 100 generation, the originating (Tx) ITS-S composes the CPM 100, which is then delivered to the ITS networking & transport layer (N&T) for dissemination. The dissemination of CPMs 100 may vary depending on the applied communication system. CPMs 100 are sent (e.g., broadcasted or transmitted) by the originating ITS-S to all ITS-Ss within a direct communication range. This range may be influenced in the originating ITS-S by changing the Tx power depending on the relevance area. CPMs 100 are generated periodically with a rate controlled by the CPS in the originating ITS-S. The generation frequency is determined by taking into account the dynamic behavior of the detected object status (e.g., change of position, speed, or direction) sending of CPMs 100 for the same perceived object by another ITS-S, as well as the radio channel load and/or channel conditions. Upon receiving a CPM 100, the CPS makes the content of the CPM 100 available to the ITS apps and/or to facilities within the receiving ITS-S, such as a Local Dynamic Map (LDM) (see e.g., ETSI TR 102 863 v1.1.1 (2011-06) (“[TR102863]”)).

FIG. 1 illustrates the structure of CPMs 100a and 100b, and FIG. 2 illustrates the structure of a CPM 200. Aspects discussed herein w.r.t CPMs 100a and 100b are also applicable to CPM 200. For purposes of the present disclosure, the terms “CPMs 100” or “CPM 100” may refer to either CPM 100a, CPM 100b, or CPM 1600, individually; all of CPMs 100a, 100b, and 1600, collectively; or any combination of CPM 100a, CPM 100b, and 1600. The CPM 200 in FIG. 2 is an alternative representation of the CPMs 100a and 100b.

The CPMs 100 enable ITS-Ss to share sensor information, perceived object lists, free space addenda (also referred to as “perceived region”), and layered costmaps. A CPM 100 comprises a common ITS PDU header and multiple containers, which together constitute a CPM 100. Each container comprises a sequence of optional or mandatory data elements (DEs) and/or data frames (DFs). The DEs and DFs included in the CPM format are based on the ETSI Common Data Dictionary (CDD) (see e.g., ETSI TS 102 894-2 v1.3.1 (2018-08) (“[TS102894-2]”)) and/or makes use of certain elements defined in “Intelligent transport systems—Cooperative ITS—Using V2I and I2V communications for apps related to signalized intersections”, International Organization for Standardization (ISO) Technical Committee (TC) 204, Ed. 2 (2019-06) (“[CEN-ISO/TS19091]”). Some or all DEs and DFs are defined in Annex A of [TS103324].

Regardless of which type of ITS-S disseminates a CPM 100, the management container provides information regarding the ITS—S type and the reference position of the ITS-S. CPMs 100 can be disseminated either by a moving ITS-S (e.g., a V-ITS-S 1210) or by a stationary ITS-S (e.g., an R-ITS-S 1230). Support for other types of ITS-Ss can be added using, for example, the ASN.1 extensibility feature. To allow for simplified future extensibility of the CPM 100, ASN.1 Information Object Classes are employed for the station data and perception data containers.

CPMs 100 include an ITS PDU header. The ITS PDU header is a common header that includes the information of the protocol version, the message type, and the ITS-S identifier (ID) of the originating ITS-S. The ITS PDU header is included as specified in [TS102894-2]. Detailed data presentation rules of the ITS PDU header in the context of a CPM 100 is as specified in Annex A of [TS103324].

The management container provides basic information about the originating ITS-S, regardless of whether it is a V-ITS-S 1210 or R-ITS-S 1230. The container includes the ITS—S type, reference position and optional information about the current message segment as part of the messageSegmentInfo. Message segmentation is managed according to clause 6.1.4 in [TS103324]. The reference position is used for referencing objects relative to a provided global position. The reference point to be provided is detailed in [EN302890-2]. For V-ITS-Ss 1210, the reference point refers to the ground position of the centre of the front side of the bounding box of the V-ITS-Ss 1210. For R-ITS-Ss 1230, the reference point refers to an arbitrary position on a road segment or intersection. This point is used to determine the offset to other data points.

In case of a CPM 100 generated by a V-ITS-S 1210, the station data container of type CpmStationDataContainer containing the information object OriginatingVehicleITSSContainer is present and contain the dynamic information of the originating ITS-S. In case of a CPM 100 generated by an R-ITS-S 1230, the originating roadside ITS-S container of type CpmStationDataContainer containing the information object OriginatingRoadsideITSSContainer may be present. If present, this container provides references to identification numbers provided by the MAP message (see e.g., [CEN-ISO/TS19091]) disseminated be the same R-ITS-S 1230.

The sensor information container (SIC) of type CpmPerceptionDataContainer containing the information object SensorInformationContainer may be present to provide information about the sensory capabilities that are available to an ITS-S and/or an ITS sub-system. Depending on the ITS—S type of the originating ITS-S, different container specifications are available to encode the properties of a sensor. The SICs are attached at a lower frequency than the other containers (see e.g., [TS103324]).

The originating vehicle ITS-S container comprises information about the dynamics of the vehicle ITS sub-system disseminating the CPM 100, and is included in every CPM 100 transmitted by a vehicle ITS-S. Such information is required to transform objects described in the POC of the same CPM 100 into a target reference frame, such as a vehicle centered coordinate system (see e.g., Road vehicles—Vehicle dynamics and road-holding ability—Vocabulary, INTERNATIONAL ORGANIZATION FOR STANDARDIZATION (ISO), TC 22, SC 33, Ed. 2 (2011-12) and/or ISO 8855 (11/2013) (“[ISO8855]”)). The originating vehicle ITS-S container is encoded as specified in Annex A of [TS103324]. More specifically, the following rules apply.

The vehicle orientation angle provides means to transmit the actual orientation of the vehicle opposed to the vehicle heading which references the orientation of the provided velocity vector magnitude only. The container also provides means to include a description for trailers attached to a towing vehicle (e.g., for trucks). Different layouts for attached trailers are possible. Providing the TrailerData is required to transform objects detected by a sensor mounted to a trailer into a receiving ITS-S's reference frame. Every trailer added to the description of a vehicle includes a TrailerData container which can be added up to two times. Each TrailerData provides a new reference point ID, incrementing from 1. The reference point ID 0 always refers to the reference point of the towing vehicle. An offset to a hitch point in the longitudinal direction according to [ISO8855] from the towing vehicle's reference point is provided. The trailer's dimensions are provided by defining the trailer's front and rear overhang w.r.t the trailer's hitch point, as depicted. The width of the trailer may be provided optionally. The hitch angle is also optionally available. More configurations for providing reference points for ITS-S can be found in [EN302890-2].

In case a CPM 100 is generated by an R-ITS-S 1230, the Originating Roadside ITS-S Container of Type CpmStationDataContainer containing the information object OriginatingRoadsideITSSContainer may be present. If present, it provides references to identification numbers provided by the MAP Message (see e.g., [CEN-ISO/TS19091]) disseminated be the same R-ITS-S 1230. The Originating Roadside ITS-S Container includes two parameters to reference information received by the MAP message (see e.g., [CEN-ISO/TS19091]) disseminated by the same roadside ITS-S. Either, the IntersectionReferenceID or the RoadSegmentID can be used to refer to the road infrastructure provided by the road lane topology service. In case the OriginatingRoadsideITSSContainer is included, the R-ITS-S 1230 also transmits a MAP message. In case of R-ITS-S 1230 disseminating the CPM 100, the reference position refers to the reference position as defined in [CEN-ISO/TS19091] (e.g., an arbitrary point on the intersection).

The SIC lists information about individual sensor(s) attached to an ITS-S. The SIC is of type CpmPerceptionDataContainer containing the information object sensorInformationCpmContainer. The SIC is encoded as specified in Annex A of [TS103324]. More specifically the following rules apply:

This container type offers the possibility to provide descriptive information about the sensory properties that are available in an ITS-S. Every described sensor is assigned an ID which is in turn utilized in the POC to relate measured object information to a particular sensor. Additionally, each provided sensor information DF is accompanied by a sensor categorization to indicate the type of the perception system. This can be a specific sensor type such as a radar or LIDAR sensor up to a system providing fused object information from multiple sensors. As different sensor types may be attached to an ITS-S, e.g., radar, LIDAR, combined sensor fusion system and alike, this container provides different possibilities for describing the properties of a sensor-system.

Two types of descriptions are differentiated: sensors which are mounted on vehicles, is described using the vehicleSensor description DF. Stationary sensors (e.g., sensors mounted on a roadside infrastructure or the like) are described using a stationarySensor variant DF. The perception area of a perception system can be inferred on the receiving ITS-S by the data provided in the SensorInformationContainer.

Either variant is used to describe the sensory capabilities of the disseminating ITS-S. This can be the actual parameters of a perception-system, e.g., its actual perception range, or the applicable perception area of the perception system, e.g., the area in which objects will be detected by the perception system.

A vehicleSensor type description provides information about sensors mounted to vehicles. The properties of these perception systems are defined by providing the mounting position of a sensor w.r.t a specific reference point on the vehicle. The range and horizontal as well as optional vertical opening angles are provided to describe the sensor's frustum. In case a sensor has multiple detection areas, up to ten perception areas for a sensor can be encoded. The provided offset from a reference point on the vehicle serves as the origin of a sensor-specific local Cartesian coordinate system.

In case of a perception system mounted to a roadside infrastructure, the stationarySensorRadial DF provides a similar concept to describe the roadside system's perception capabilities. The position provided by the offset from a reference point shall serve as the origin of a sensor-specific local Cartesian coordinate system. Being provided with the sensor position and the opening angles, the receivers of the CPM 100 can determine the sensor measurement area by projecting the area defined by the opening angles on the ground.

For stationary sensors, alternative DFs for describing the perception system's perceived area are provided in case the origin of a sensor system should or cannot be revealed. This is particularly useful if the perception area is generated by combining several separate systems which however act as one sensor. A geographical representation of a system's perception area can be expressed in terms of a circular, rectangular, ellipsoidal or a polygon area. Due to their geographical reference of the reference point, these types are applicable to stationary sensors only.

The optional FreeSpaceConfidence DE may be used to provide information that a particular sensor is able to provide confirmed measurements about detected free space. The indication states an isotropic confidence level that is assumed for the entire detection area. FreeSpaceConfidence is used to indicate the corresponding confidence as specified herein and/or in [TS103324].

In combination with received objects, a receiver may employ the free space confidence indication to compute the resulting free space by applying a simple ray-tracing algorithm. The perception area may be assumed to be free with an isotropic FreeSpaceConfidence, generated by the DetectionArea DF. Not all objects known to a Tx ITS-S will be reported in every CPM 100. The receiver should ensure that suitable tracking and prediction mechanisms for previously transmitted objects are employed to update the shadowed area accordingly.

The received geometric extension of a PerceivedObject may be used to compute the resulting shadowed area for each object. For this purpose, a simple ray-tracing approach may be utilized. A ray thereby connects from the origin of a particular sensor to the outermost corner-points of the received object geometry and extends to the perception range of a particular sensor. The area behind the object from the perspective of the sensor mounting point is considered as shadowed. No indication about the free space confidence can be given behind a shadowing object. A description in three dimensions may be applied. In case an object is detected by a sensor with a certain height above ground (e.g., a signage gantry), the same ray-tracing approach is employed for a three-dimensional representation.

In case the shadowing model does not apply, the shadowingApplies DE of the SensorInformation is set to False to indicate that no shadowing model can be computed on the receiving side for this sensor

The perceived object container (POC) of type CpmPerceptionDataContainer containing the information object PerceivedObjectContainer may be present for objects that have been perceived by an ITS-S and/or an ITS sub-system. It provides information about the detected object w.r.t the disseminating ITS-S. Classifications and positions matched to road data can also be provided. A POC is added to the CPM 100 for each detected object as defined in [TS103324]. In some implementations, the POC is only added for objects that have been detected according to POC inclusion rules 1521 (see e.g., [TS103324]).

The POC is of type CpmPerceptionDataContainer containing the information object PerceivedObjectContainer. One goal of the CPM 100 is to share information about perceived objects. For that purpose, the kinematic attitude state along with additional information on an object is provided through the POC.

The total number of perceived objects is provided in the variable numberOfPerceivedObjects in the PerceivedObjectContainer. Due to the message generation rule as specified in [TS103324] and the associated object inclusion scheme, the number of included objects does not have to equal the numberOfPerceivedObjects of the received CPM 100.

An Rx ITS-S should not assume that the received PerceivedObjects in the POC represents all objects known to the Tx ITS-S. An Rx ITS-S has to listen for further CPMs 100 from the same Tx ITS-S for a predefined or configured amount of time (e.g., at least one second) until all objects have been received. The container enables a detailed description of the dynamic state and properties of a detected object. The information regarding the location and dynamic state of the perceived object is provided in a coordinate system that is used for the description of the object's state variables in case of a vehicle sharing information about a detected object (see e.g., [ISO8855] and [TS103324]). In case an R-ITS-S 1230 is disseminating the CPM 100, the reference position refers to the reference position as defined in [CEN-ISO/TS19091] and/or [TS103324] (e.g., an arbitrary point on the intersection).

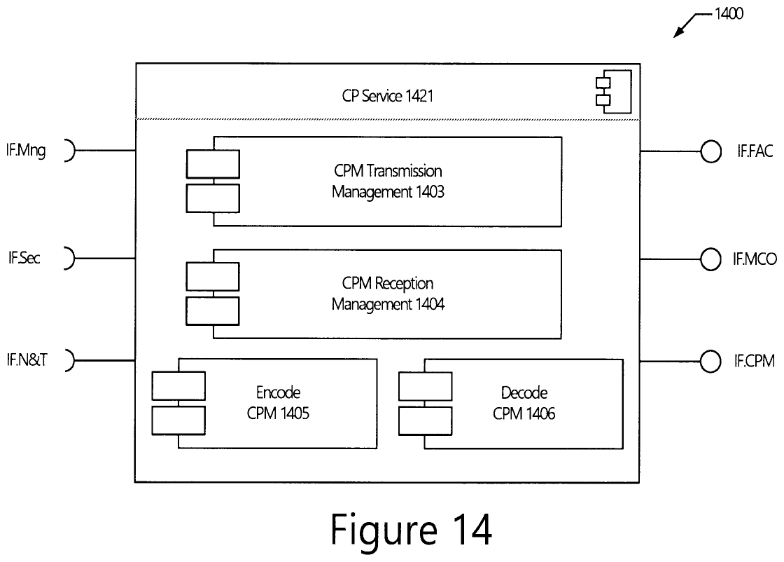

Every object is described by at least providing the distance and speed in the x/y plane of the respective coordinate system w.r.t an ITS-S's reference point, as depicted in FIG. 14 in [TS103324] for the case of a vehicle ITS-S. The reference point of a measurement is also provided as part of the message.

The full kinematic attitude state of an object is represented in an 18-dimensional kinematic state and attitude space. The corresponding state vector is represented as follows:

state_{Obj}=(dₓ,d_{y},d_{z},vₓ,v_{y},v_{z},aₓ,a_{y},a_{z},θᵣₒₗₗ,θ_{pitch},θ_{yaw},ωᵣₒₗₗ,ω_{pitch},ω_{yaw},αᵣₒₗₗ,α_{pitch},α_{yaw})^{T}

In the above state vector representation, dᵢ, vᵢ, aᵢ represents the distance, speed and acceleration and θᵢ, ωᵢ, αᵢ, correspondingly represents angle, angular speed and acceleration. Additionally, vₚ is a planar speed magnitude, and vₓ, v_{y} is a cartesian planar speed. These parameters are mutually exclusive, and the same applies to acceleration. Hence, the kinematic state is at most 18 dimensional in this example. The speed and acceleration magnitudes are measured in the direction of θ_{yaw}. Negative values indicate movement or accelerating backwards. In some implementations, the kinematic state can be extended or otherwise represented using a polar coordinate representation of velocity and acceleration. In these implementations, two or more different vectors may be defined (e.g., for Cartesian or polar). Annex C in [TS103324] provides an example for how to interpret a received kinematic state and attitude description.

The POC is encoded, for example, as specified in Annex A in [TS103324]. More specifically, the following rules can apply.

An objectID is assigned to each detected object. This ID is taken from a range of monotonously increasing numbers and is maintained per object, as long as an object is perceived and new sensor measurements are assigned to the object. The range of allowed objectIDs is between 0 and 255. As soon as objectID 255 has been assigned to an object, the next object is assigned the next free ID, starting from ID 0 in a round-robin fashion.

A time of measurement (ToM) is provided for each object as the time difference for the provided measurement information w.r.t the generation delta time stated in the CollectivePerceptionMessage DF. In some implementations, an interpretation for the ToM which is always relative to the GenerationDeltaTime encoded in the message and the time which corresponds to when the state space information about a detected object is made available. The GenerationDeltaTime always corresponds to the latest point in time when the latest reference position is available on the transmitting side. Upon receiving the message, the receiver shall compute its own local GenerationDeltaTime based on its current absolute timestamp. The difference between the encoded GenerationDeltaTime in the received CPM 100 and the local GenerationDeltaTime represents the age of the CPM 100. The received encoded ToM then needs to be added to the age of the CPM 100 to compute the age of the encoded object. Positive ToM s thereby indicate that the ToM needs to be added to the message age on the receiver side, as the state space of the object has been created before the transmitter's GenerationDeltaTime and is therefore older. Negative time values indicate that the ToM needs to be subtracted from the age of the CPM 100 as the state space of the described object has been determined after the transmitter's GenerationDeltaTime has been created. The ToM includes any processing time of a sensor or data fusion system. In case the fused object state information is transmitted, the ToM references the point in time to which the state space has been predicted.

The age of the detected object is provided for each object. The objectAge reflects the time how long the object is already known to the sender's system at the time of message generation.

For every component provided in the kinematic state and attitude space of an object in the CPM 100 (see e.g., [TS103324]), the corresponding standard deviation of the Probability Density Function (PDF) is provided to a pre-defined confidence level (e.g., 95%).

In addition, correlation information may be provided for each component. If correlation information is provided, the number of correlation entries shall correspond to the size of the kinematic state and attitude space, e.g., given a state space vector of length n, the corresponding correlation matrix is of size n×n. Correlation is represented in a vectorised form for each column of the corresponding lower-triangular positive semidefinite correlation matrix ordered in the same fashion as the provided kinematic attitude state components stated in clause 7.6.1 in [TS103324]. The correlation is mathematically symmetric (e.g., corr(x,y)=corr(y,x)) for any two given random variables. Therefore, every component of the kinematic attitude state shall only provide the correlation information with the remaining, subsequent components.

A one-value indication about the overall information quality on a perceived object may be provided in the objectConfidence DE. The object characteristics contributing to the object confidence are (1) object age; (2) sensor or system specific detection confidence; and (3) detection success. The objectAge is provided in the CPM 100, whereas the detection confidence and the detection success indication are system specific assessments of the ITS-S's object detection system. Detection success describes the assessment whether a given measurement has successfully perceived the object (e.g., binary assessment). In some implementations, a moving average is specified for the computation of the objectConfidence and detection confidence because they are not invariant to time as they can change, may split up, fuse, and/or the like.

If provided, the objectConfidence at a discrete time instant t, is determined according to the following process: First, an exponential moving average is computed for the system specific confidence c with factor α, 0≤α≤1, wherein if t==0: EMA₀=c₀; if t>0: EMAₜ=α*Dₜ+(1−α)*EMAₜ₋₁. Second, the rating r_{c}=floor(EMAₜ*15) is computed. Third, the first and second steps are repeated for the detection success d to obtain rating r_{d}. Fourth, the object age rating rₒₐ=min{└OA/100┘, 15} is computed. Fifth, the object confidence

$$objectConfidence = floor ( \frac{{w}_{d} * {r}_{d} + {w}_{c} * {r}_{c} + {w}_{oa} * {r}_{oa}}{{w}_{d} + {w}_{c} + {w}_{oa}} )$$

is computed with weights w_{d}, w_{c} and wₒₐ. The specification of factor α and weights w_{d}, w_{c} and wₒₐ is provided elsewhere.

The object class “groupSubClass” is used to report a VRU group or cluster. A VRU group contains a set of VRUs (e.g., VRU 1216, 1210v) perceived by the ITS-S generating the CPM 100. Reporting of group of VRUs as a single object is reducing the size of the CPM 100. A VRU cluster contains a set of VRUs reported in a VRU awareness message (VAM) received by the ITS-S generating the CPM 100. A VRU cluster or a VRU group can be updated by adding information (e.g., shape, cardinality, profile, and the like) perceived by the ITS-S generating the CPM 100. Conditions for clustering operations are specified in [TS103300-3].

VRU clustering operations are part of the VRU basic service specified in [TS103300-3] and is intended to optimize the resource usage in the ITS-S by reducing the number of individual messages. A VRU group or cluster is characterized in a CPM 100 by parameters defining the size of the group in terms of number of objects (e.g., clusterCardinalitySize) and/or a type of the group (e.g., clusterProfiles) to identify all the VRU profile types that are believed to be in the VRU group or cluster.

If the group is associated with a VRU cluster, a clusterId indicates the identifier of the associated VRU cluster. A group is not always associated to a VRU cluster, and in this case, no clusterId is indicated or included. [TS103300-3] includes a ClusterBreakupReason to break a cluster if the cluster leader notices that the cluster is reported in a CPM 100. The ITS-S generating the CPM 100 with VRU cluster needs correctly evaluate this field at all times in received VAMs.

The free space addendum container (FSAC) of type CpmPerceptionDataContainer containing the information object FreeSpaceAddendumContainer may be present to describe changes to a computed free space description. In the CPM 200 of FIG. 2, the FSAC is replaced with a perceived region container (PRC), and the following discussion regarding the FSAC is also applicable to the PRC.

The FSAC is attached to express different confidence levels for certain areas within the DetectionArea of a particular sensor. The FSAC is of type CpmPerceptionDataContainer containing the information object FreeSpaceAddendumContainer. The FSAC in the context of a CPM 100 is encoded as specified in Annex A in [TS103324]. Specifically, the following rules may apply. In some implementations, the FSAC is only added if the confidence indication needs to be altered w.r.t the isotropic confidence level indication provided in the SensorInformationContainer.

As such, the FSAC may be interpreted even if a received CPM 100 does not contain the SensorInformationContainer. This can be the case when a sensor cannot utilize its entire DetectionArea to reliably provide a free space indication, or in case the shadowing model detailed in [TS103324] does not apply for a particular object (e.g., in case of a radar sensor measuring two vehicles driving behind each other).

Two possible applications of the FSAC are possible: an isotropic free space confidence provided in the SensorInformationContainer of level l₁ does not apply to the entire DetectionArea of the sensor. Instead, part of the computed shadowed area behind one of the object has a different free space confidence of level l₂ (e.g., as a result of sensor fusion processes). This area is described by providing a FreeSpaceArea DF as part of the FreeSpaceAddendum container. Additionally, the sensor system is only able to provide a free space confidence indication for a confined area within its DetectionArea. A different confidence level l₃ applies to the depicted grey area, expressed as an additional FreeSpaceAddendum container.

The shadowingApplies DE of the FreeSpaceAddendum container is used to indicate if the simple tracing approach to compute the shadowed area behind objects also applies for the areas described in the FreeSpaceAddendum container. In case of a Tx also providing its own dimensions, the area occupied by the transmitting ITS-S shall also be considered as occupied. Information about the geometric dimensions of a transmitting ITS-S may be provided in the CPM 100 or additional transmitted messages such as the CAM.

The order given by the freeSpaceID of provided FreeSpaceAddendum containers for each sensor in one or several messages is thereby overwriting the confidence level indication of an overlapping FreeSpaceAddendum container of the same sensor in an ascending fashion. The confidence level indication l₃ with freeSpaceID 2 overlaps the confidence levels l₁ (from the SensorInformationContainer) and l₂ (from the first FreeSpaceAddendum container with freeSpaceID 1) represents the dominating confidence level indication within the prescribed area. Additionally or alternatively, a freeSpaceAddendum container may be added in another CPM 100. Furthermore, overlapping can be managed by using the same freeSpaceID for each FreeSpaceAddendum container, and other information may be included to describe an overlapping order between the freeSpaces indicated by the corresponding freeSpaceAddendum containers.

A FreeSpaceAddendumContainer may be located partially outside of the detectionArea. By providing a FreeSpaceAddendum container outside of the detectionArea, simpler shapes for the FreeSpaceArea may be leveraged to decrease the message size. The timeOfMeasurement DE of the FreeSpaceAddendum container contains the measurement time of the freespace, relative to the cpmReferenceTime. The freeSpaceConfidence DE of the FreeSpaceAddendum container expresses the free space confidence that applies to the area provided in thefreeSpaceArea DF. The freeSpaceConfidence corresponds to the sensor or system specific detection confidence. An optional list of sensorIds links to the corresponding sensorInformationContainer and may be provided to indicate which sensor provided the corresponding free space confidence indication. In some implementations, a moving average is specified for the computation of the freeSpaceConfidence because it is not invariant to time as the freeSpaceConfidence can change, may split up, fuse, and/or the like.

FIG. 1 shows a CPM 100a, which enables ITS-Ss to share individual perceived objects. A POC of type PerceptionData can be added for every object that has been perceived by an ITS-S (e.g., up to maximum of 128). The POC provides information about the detected object w.r.t the disseminating ITS-S. The FSAC express different confidence levels as a free space confirmation for certain areas within the DetectionArea of a particular sensor. The FSAC container is added only if the confidence indication needs to be altered w.r.t the isotropic confidence level indication provided in the SIC. The CPM 100a may be used for IO-CPM reporting.

FIG. 1 also shows a layered costmap based CPM 100b, which can be used for the CM-CPM reporting. In CPM 100b, a CostmapContainer of type PerceptionData or of type CpmPerceptionDataContainer is added to the CPM 100b to share overall dynamic environment perceived by the Tx ITS-S as a cost-based occupancy grid. The CostmapContainer provides information about the perceived environment for a rectangular area around the disseminating ITS-S with respect to the disseminating ITS-S. The CMC may be more efficient in certain situations such as presence of large number of objects or overlapping view of objects or occlusion of objects in the FOV of sensors at the ITS-S. This container is only added if costmap has been selected according to the inclusion rules 1521 discussed infra and/or in [TS103324]. In some implementations, 1 to N CMCs (where N is a number, including 0) are included in the CPM 100b. Additionally or alternatively, the CPM 100b includes the 1 to N CMCs with the POCs and FSACs or without the POCs and FSACs.

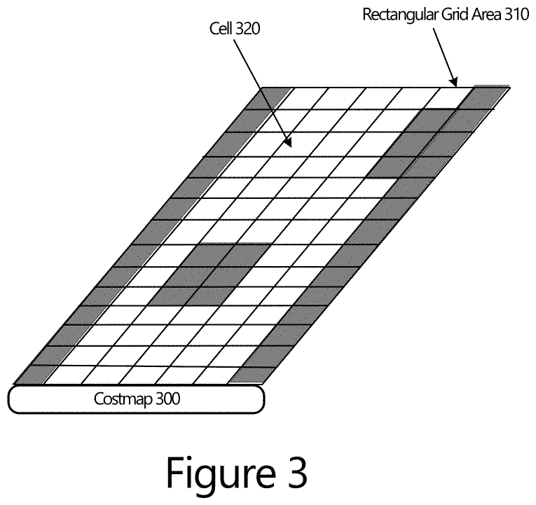

FIG. 3 shows an example costmap 300, which can be used for the collective perception service (CPS). A cost map (or “costmap”) is a data structure that contains a 2D grid of costs (or “cost values”) that is/are used for path planning. In other words, a costmap represents the planning search space around an ITS-S (e.g., V-ITS-S 1210, R-ITS-S 1230, VRU 1210v, robot, drone, or other movable object). Costmaps are used for navigating or otherwise traveling through dynamic environments populated with objects. For many use cases, such as CA/AD vehicles and/or (semi-)autonomous robotics, the travel path not only takes into account the starting and ending destinations, but also depends on having additional information about the larger contexts. Information about the environment that the path planners use is stored in the costmap. Traditional costmaps (also referred to as “monolithic costmaps”) store all of the data (costs) in a singular grid.

The grid or cell values in the costmap are cost values associated with entering or traveling through respective grids or cells. The “cost” or cost value in each cell of the costmap represents a cost of navigating through a that grid cell. The CostmapContainer considers grid-based representation of a cost map where each cell carries a cost (or cost value) or a probability that specific types of objects (e.g., obstacles, VRUs 1216, 1210v, and the like) is/are present in the cell. In some implementations, the state of each grid cell is one of free, occupied, or unknown. In these implementations, the cost value refers to a probability or likelihood that a given cell is free (unoccupied), occupied by an object, or unknown. In some implementations, the state of each grid cell may be one of safe, caution, or lethal to drive through the cell. In these implementations, the cost value refers to a probability or likelihood that a given cell is safe to drive through, lethal to drive through, or somewhere in between safe and lethal (e.g., caution). Additionally, the “costs” of the cost map can be a cost as perceived by the ITS-S at a current time and/or a cost predicted at a specific future time (e.g., at a future time when the station intends to move to a new lane under a lane change maneuver). The ITS-Ss may follow a global grid with the same size (or hierarchical grid sizes) of cell representation. In hierarchical cell size, cell sizes are integer multiples of each other.

The CMC is encoded as specified in Annex A of [TS103324]. More specifically, the following rules may apply: Each ITS-S prepares a costmap 300 for a rectangular area 310 of specified dimensions in its FoV, where the rectangular area 310 is further divided into smaller rectangular cells 320 (note that not all cells 320 are labeled in FIG. 3 for the sake of clarity). For example, the rectangular area 310 can be divided into n cells by m cells, where n and m are numbers. This rectangular area 310 is described by providing ReportedCostMapGridArea DF as part of the CostmapContainer. Dimensions of each cell is described by GridCellSizeX and GridCellSizeY DEs. The center of the reported rectangular grid area is specified w.r.t the reference position of the disseminating ITS-S. The cost (or cost value) of each cell is calculated by the disseminating ITS—S based on its local sensors, information shared by neighbors (e.g., perceived objects indicated by received CPMs 100) and a static map available to the Tx ITS-S.

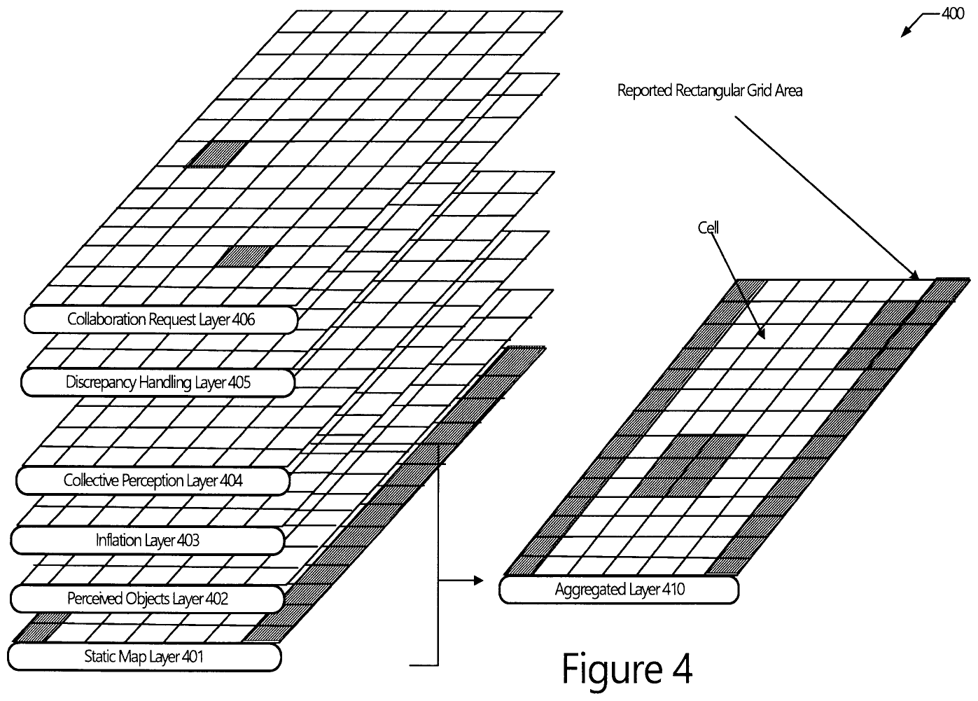

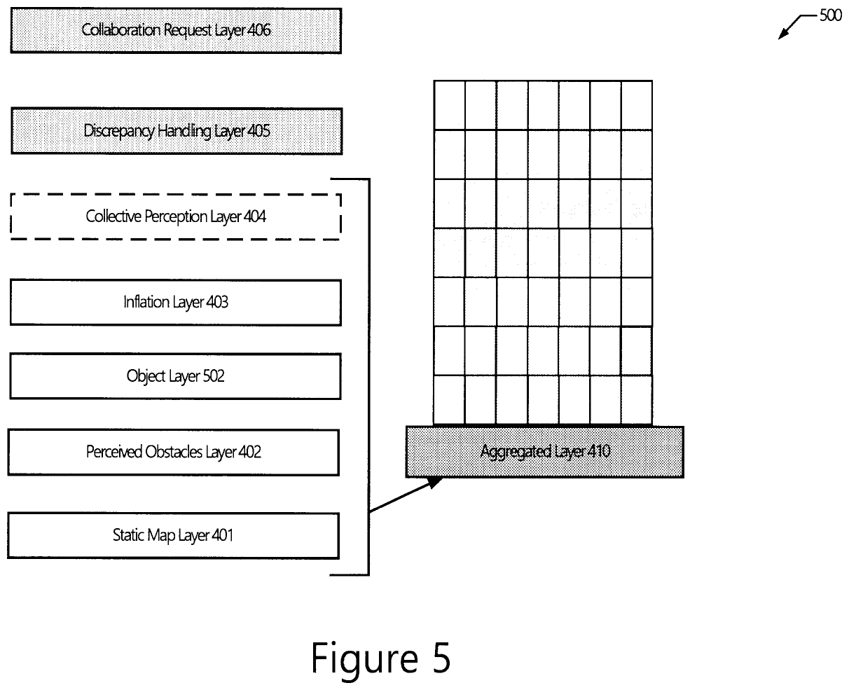

The cost value of each cell is specified along with confidence level. The cost and confidence level for cells can be specified in different formats where formats are specified by PerGridCellCostValueConfigType and PerGridCellConfidenceLevelConfigType DFs for cost and confidence level, respectively. For example, a cost value can be conveyed using a simple 1 bit value (e.g., Occupied, notOccupied) or several bits specifying a probability of presence of an object in the cell 320. Similarly, confidence level can be as simple as 1 bit (e.g., belowA Threshold, aboveOrEqualToAThreshold) or several bits specifying a confidence level range (e.g., from 0 to oneHundredPercent). The costmap 300 (or costmap layer 410, 510 in FIGS. 4 and 5) is updated periodically with a period T_Costmap_Update. In some implementations, the T_Costmap_Update is selected to be smaller than or equal to the CPM generation event periodicity (T_GenCpm).

In some implementations, an ITS-S may maintain costmaps 300 of different sizes. For example, the ITS-S may maintain a local costmap 300 for its own use, which may be larger in size (e.g., in terms of the grid 310 and/or the size of the data structure (stored file)) in comparison to the size of a costmap 300 prepared for sharing with neighbors. Additionally or alternatively, the Tx ITS-S may select a larger costmap cell size to reduce size of a CostmapContainer in case of network congestion and/or based on other parameters, conditions, or criteria. Additionally or alternatively, the Tx ITS-S select size optimized formats (e.g., requiring fewer bits per cell) for cost and confidence level for reported costmap 300 in case of network congestion and/or based on other parameters, conditions, or criteria.

In some examples, the costmap 300 is a monolithic costmap. Additionally or alternatively, the costmap 300 may be an LCM generated as discussed infra w.r.t FIGS. 4 and 5 and/or as discussed in Int'l App. No. PCT/US2021/034031 filed on 25 May 2021 (“['031]”) and Int'l App. No. PCT/US2020/038723 filed on 19 Jun. 2020 (“['723]”), the contents of each of which are hereby incorporated by reference in their entireties.

FIGS. 4 and 5 show example LCMs 400, and 500, respectively. The LCMs 400, 500 maintain an ordered list of layers, each of which tracks the data related to a specific functionality and/or sensor type. The data for each layer is then accumulated into an aggregated layer 410 (sometimes referred to as a “master costmap 410”). As mentioned previously, reporting each perceived object (PO) as an IO in a CPM 100 can be very inefficient for at least some scenarios (e.g., when there are a large number of objects, there is an overlapping view of objects, and/or when there is an occlusion of objects in the sensors' FoV). A new container called ‘LayeredCostMapContainer’ or ‘CostmapContainer’ is added to the CPM 100 to share a costmap 300 or LCM 400 to enable compact and efficient sharing of perceived environment among proximity ITS-Ss under CPS. For purposes of the present disclosure, the term “CostmapContainer” may refer to either a ‘LayeredCostMapContainer’ or a ‘CostmapContainer’, unless the context dictates otherwise.

A CostmapContainer of type PerceptionData is added to the CPM 100 to share overall dynamic environment perceived by a Tx ITS-S as a cost-based occupancy grid. Each ITS-S prepares and updates more than one layer or types of cost maps as shown in FIGS. 4 and 5. A disseminating ITS-S may have prepared more than one layer or type (e.g., up to 8) of a cost map as shown in FIGS. 4 and 5. The LCM 400 maintains an ordered list of layers, each of which tracks the data related to a specific functionality and/or sensor type, and the data for each layer is then accumulated into the aggregated cost map layer 410. In LCM-based implementations, the disseminating ITS-S shares an aggregated costmap layer (e.g., aggregated layer 410, 510 in FIGS. 4 and 5) and may share one or more of the other layers depending on the bandwidth, access layer congestion information, and/or other parameters, conditions, or criteria. Each shared costmap layer type is specified by a CostMapLayerType DF.

Different layers have different rates of change, and therefore, different layers are updated at different frequencies based on factors such as the speed of the vehicle, weather, environmental conditions, and/or the like.

The aggregated layer 410 is prepared from other cost map layers (static layer 401, perceived objects layer 402, inflation layer 403, and collective perception (CP) layer 404) as shown in FIGS. 4 and 5. The layers are updated upwards from the static map layer 401 in the order as shown by FIGS. 4 and 5 while preparing or updating aggregated costmap layer 410 (also referred to as “aggregate layer 410” or the like). That is, information in static costmap layer 401 is first incorporated in the aggregated cost map layer 410 followed by adding information from the perceived object layer 402, inflation layer 403, and CP layer 404.

The static costmap layer 401 maintains information about static or semi-static objects and roadside infrastructure, while other Layers of the cost map 400, 500 maintain costs due to dynamic objects and safety requirements of these objects. For example, the static costmap layer 401 occupancy grid represents the permanent structures on the road and roadside; the perceived object layer 402 occupancy grid represents the obstacles (dynamic/static) on the road and roadside perceived by local sensors; the inflation layer 403 occupancy grid represents buffer zone around obstacles or permanent structures; the CP Layer 404 occupancy grid represents perceived objects received from one or more neighbors; the discrepancy handling layer 405 occupancy grid shows the grid cells where there are discrepancies between received and own cost values or confidence levels for grid cells; and the collaboration request layer 406 occupancy grid indicates grid cells where the ego ITS-S could not determine the perception with required confidence level.

The static map layer 401 includes a static map of various static and/or semi-static objects (e.g., roadside infrastructure, buildings, and/or the like), which is used for global planning. The static map 401 is an occupancy grid that represents the permanent structures on road/road-side. The static map layer 401 is pre-determined a priori based on static structures on the road and/or at the road-side.

The static map 401 can be generated with a simultaneous localization and mapping (SLAM) algorithm a priori or can be created from an architectural diagram. Since the static map is the bottom layer of the global LCM, the values in the static map may be copied into the aggregated costmap 410 directly. If the station or robot is running SLAM while using the generated map for navigation, the LCM approach allows the static map layer to update without losing information in the other layers. In monolithic costmaps, the entire costmap would be overwritten. The other layers of the LCM maintain costs due to dynamic objects, as well as safety and personal privacy requirements of these objects.

The perceived objects (obstacles) layer 402 includes determine perceived objects that are obstacles to be considered during driving. The perceived objects (obstacles) layer 402 collects data from high accuracy sensors such as lasers (e.g., LiDAR), Red Blue Green and Depth (RGB-D) cameras, and/or the like, and places the collected high accuracy sensor data in its own 2D grid. In some implementations, the space between the sensor and the sensor reading is marked as “free,” and the sensor reading's location is marked as “occupied.” The method used to combine the perceived obstacles layer's values with those already in the costmap can vary depending on the desired level of trust for the sensor data. In some implementations, the static map data may be over-written with the collected sensor data, which may be beneficial for scenarios where the static map may be inaccurate. In other implementations, the obstacles layer can be configured to only add lethal or VRU-related obstacles to the aggregated costmap.

The inflation layer 403 implements an inflation process, which inserts a buffer zone around lethal obstacles and/or objects that could move. Locations where the VDU would definitely be in collision are marked with a lethal cost, and the immediately surrounding areas have a small non-lethal cost. These values ensure that that VDU does not collide with lethal obstacles, and attempts to avoid such objects. The updateBounds method increases the previous bounding box to ensure that new lethal obstacles will be inflated, and that old lethal obstacles outside the previous bounding box that could inflate into the bounding box are inflated as well.

The CP layer 404 includes the cumulative costmap (occupancy grid(s)/cell(s)) received from one or more neighbor ITS-Ss, and determines the costs of cells based on perceived objects indicated by CPMs 100 received from neighbor stations. The CP layer 404 enables the ITS-S to update its costmap for the region where its own (on-board) sensors may not have a “good” view or any view.

The collaboration request costmap layer 406 and the discrepancy handling costmap layer 405 enable collaboration among neighbors to achieve better and reliable costmap layers. The discrepancy handling layer 405 enables indicating and resolving discrepancies in perception among neighboring ITS-Ss. The discrepancy handling layer 405 specifies cells where on-board sensor cannot determine perception with a confidence level higher than a threshold. In some implementations, a majority voting mechanism may be used for this purpose, where the cost value of each cell is agreed on by majority voting among participating ITS-Ss.

The collaboration request layer 406 enables the Tx ITS-S to request neighbors to help enhancing the cost of some cells for which the Tx ITS-S does not have high confidence level to determine a value. The collaboration request layer 406 determines and specifies any discrepancy between costmaps received from neighbor ITS-Ss with that perceived by local sensors. The collaboration request layer 406 specifies cells where on-board sensors cannot determine perception with a confidence level at and/or higher than a threshold.

In some cases, vehicles in a proximity may observe different cost values for some cell(s) (e.g., due to sensing errors at one or more stations, different levels of angle of views of the sensors at vehicles to these cells, and/or the like). In such a scenario, CP can help in correcting any discrepancy in the costmap. The discrepancy handling layer 405 is to indicate discrepancy among cost values of neighbors. After receiving such indication of discrepancy in the discrepancy handling layer 405, nodes may re-evaluate sensing and cost map calculations for these cells and share among neighbors.

The collaboration request layer 406 allows a station to request neighbors to help to enhance the cost of some cells for which the station may not have high confidence levels to determine a cost value. One or more neighbors may include the perceived cost value (and other information like perceived object at these cells) in its CPM 100. If available, neighbors may respond by sending a unicast CPM 100 in this case.

Additionally or alternatively, a proxemics layer may be included (not shown by FIG. 4), which may be used to detect objects and/or spaces surrounding IOs. The proxemics layer may also collect data from high accuracy sensors such as lasers (e.g., LiDAR), RGB-D cameras, and/or the like. In some implementations, the proxemics layer may use lower accuracy cameras or other like sensors. The proxemics layer may use the same or different sensor data or sensor types as the perceived objects layer 404. The proxemics layer uses the location/position and velocity of detected objects (e.g., extracted from the sensor data representative of IOs, such as VRUs and the like) to write values into the proxemics layer's costmap, which are then added into the aggregated costmap along with the other layer's costmap values. In some implementations, the proxemics layer uses a mixture of Gaussians models and writes the Gaussian values for each object into the proxemics layer's private costmap. In some implementations, the generated values may be scaled according to the amplitude, the variance, and/or some other suitable parameter(s).

The aggregated cost map layer 410 is updated periodically with a period T_Agg_CML_Update. The T_Aggregated_CML_Update is selected smaller than or equal to the CPM generation event periodicity (T_GenCpm). The static cost map layer 401 is updated immediately whenever a change in static or semi-static objects and roadside infrastructure is identified. The CP layer 404 is updated whenever a new cost map layer or a new detected object is received from one or more neighbours. The CP layer 404 is also updated periodically to remove obsolete information such as an object reported by neighbour(s) is no more being reported by neighbour(s). Inflation cost map layer 403 is updated whenever an object is detected by local sensor or received from neighbour(s) CPM 100, where the object requires buffer zone around it for safe driving. Periodic update of inflation cost map layer can be performed to reduce obsolete entry. The collaboration request layer 406 and discrepancy handling layer 405 are not maintained at the ITS-S and are created on-demand whenever they are selected to be included in the CPM 100. The ITS-S may check need for collaboration request layer 406 and discrepancy handling layer 405 at each opportunity of including an LCM in the CPM 100.

The disseminating ITS-S shares its aggregated costmap layer 410 and may share one or more of the other layers based on available bandwidth, access layer congestion information, channel conditions, and/or other conditions or parameters. Each shared costmap layer type is specified by CostMapLayerType DF. The collaboration request layer 406 enables the disseminating ITS-S to request neighbor ITS-Ss to help enhancing the confidence of some cells for which the disseminating ITS-S does not have a relatively high confidence level to determine an appropriate cost value. The discrepancy handling layer 405 enables indicating and resolving discrepancies in perception among neighboring stations.

In some implementations, majority voting can be used by various stations to agree upon a cost value of individual cells. That is, the cost indicated by a majority of neighboring stations (or the average of nearby majority costs) is considered as being correct/agreed. Such agreement is performed for each cell with discrepancy individually. All neighbors will update the correct/agreed cost. Here, the votes of neighbors can be skewed based on their trustworthiness and/or based on other criteria/parameters. Additionally or alternatively, neighbors having a better angle of view, quality of data, or the like, can be given more weight(s) to select correct/agreed cost for a cell. In case of discrepancy in costmaps among neighbors, how to utilize neighbors cost map reports is up to ITS-S fusion algorithm implementation.

FIG. 5 shows a modified layered cost map 500 that includes the various layers discussed previously w.r.t FIG. 4. Specifically, the static map layer 501 may correspond to the static map layer 401, the perceived obstacles layer 502 may correspond to the perceived objects layer 402, the inflation layer 503 may correspond to the inflation layer 403, the CP layer 504 may correspond to the CP layer 404, the discrepancy handling layer 506 may correspond to the discrepancy handling layer 406, the collaboration request layer 506 may correspond to the collaboration request layer 406, and the aggregated layer 510 may correspond to the aggregated layer 410.

Additionally, the layered cost map 500 also includes a separate objects layer 502 that includes various detected objects (e.g., VRUs and/or VRU clusters) reporting. Here, detected objects are reported as a separate objects cost map layer 502 with DEs/DFs in the CMC to enable reporting, for example, VRUs 1216, 1210v and/or VRU clusters as a separate costmap layer. Since VRUs 1216, 1210v can have higher priority for safety compared to other perceived objects, the objects layer 502 may be shared more frequently than the aggregated layer 510 and/or other layers in the cost maps 400, 500.

1.2. Collective Perception Message Reporting Mechanisms

1.2.1. Alternating CPM Reporting Mechanisms

As discussed previously, two types of reporting mechanisms can be used to include or indicated perceived objects in CPMs 100, including CM-CPM reporting (e.g., which includes reporting CPMs 100 that include CMCs) and IO-CPM reporting (e.g., which includes reporting CPMs 100 that include POCs and FSACs). CM-CPM reporting reduces the overall message size and also provides fixed message size independent of number of detected objects and reduces data fusion at the Rx ITS-S as association among objects reported by various neighbors is not needed. However, CM-CPMs 100 may have less information (or provide coarse information) of detected objects in the environment than the IO-CPMs 100 used in IO-CPM reporting. On the other hand, IO-CPM reporting is effective in reporting more details of each detected object than CPMs 100 used in CM-CPM reporting. However, in crowded scenarios with large number of objects or overlapping view of objects in the FoV of sensors, IO reporting may be complex (as 10 detection may not be possible), requires a relatively large size CPM 100, and/or can take several CPM 100 transmission cycles to report all objects as there is a limit of maximum number of objects in a CPM 100. This may lead to increased communication overhead, higher latency, and higher processing complexity at the Rx ITS-S. The solutions discussed herein reduce the communication overhead needed for such systems and arrangements.

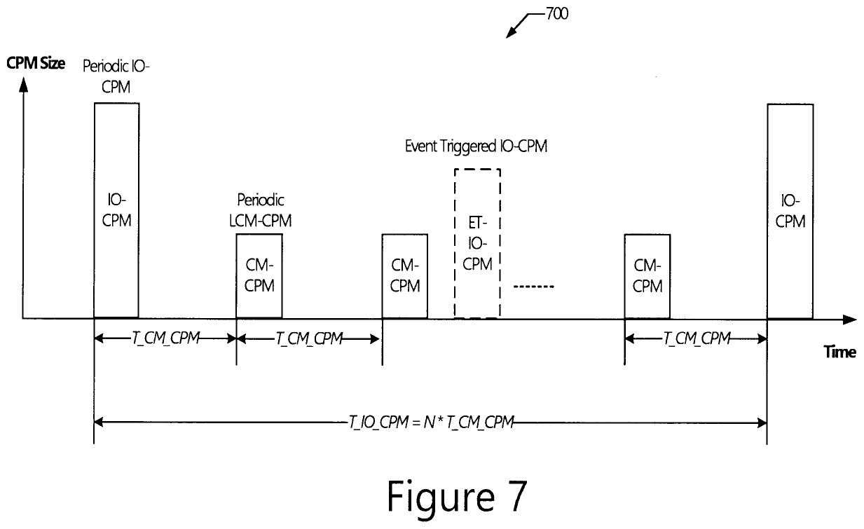

In various implementations, IO-CPM reporting and CM-CPM reporting are performed on a periodic or cyclical basis. Here, IO-CPM reporting has a period of T_IO_CPM and CM-CPM reporting has a period of T_CM_CPM where T_IO_CPM≥T_CM_CPM. In some examples, T_IO_CPM is integer multiples of T_CM_CPM such that one or more CM-CPMs 100 (e.g., CPM 100b) is reported in between at least two consecutive IO-CPMs 100 (see e.g., FIG. 7).

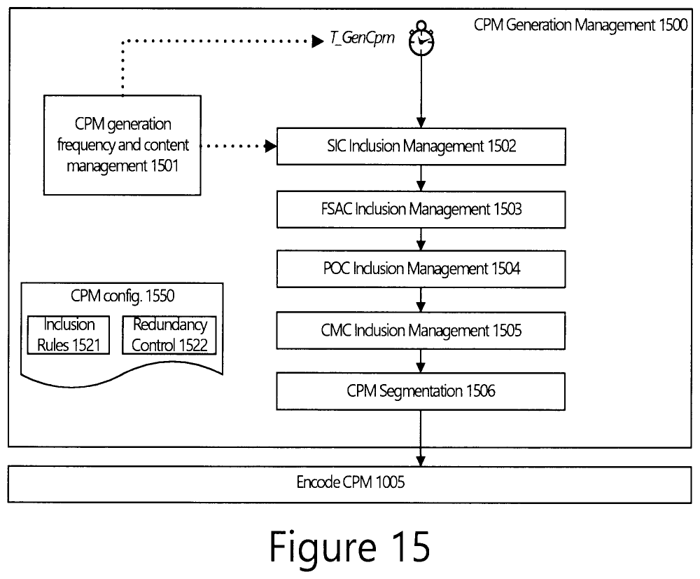

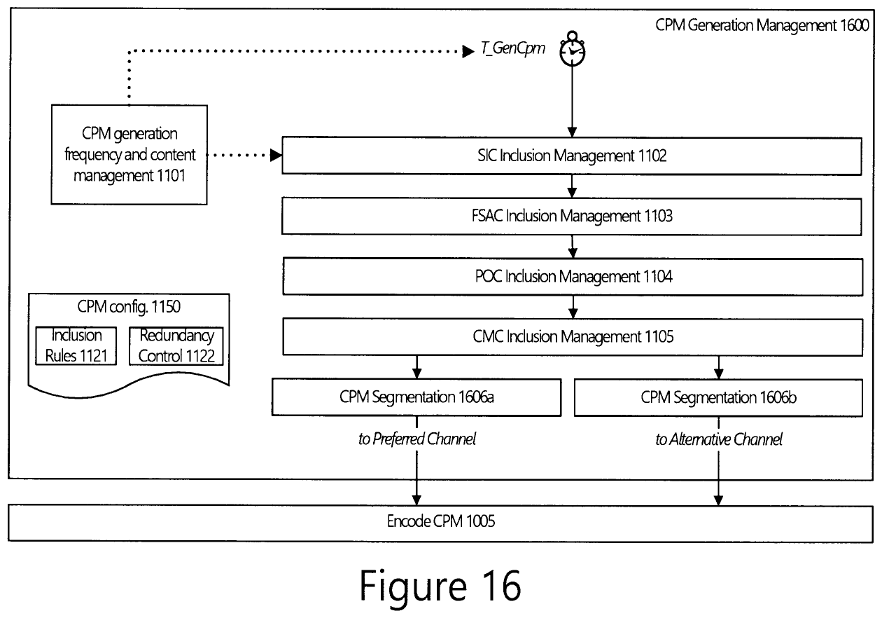

With respect to CPM generation frequency management (see e.g., FIGS. 15-16, discussed infra), T_CM_CPM is selected to satisfy the minimum time elapsed between the start of consecutive CPM generation events specified in [TS103324]. That is, T_CM_CPM is equal to or larger than T_GenCpm. Additionally or alternatively, T_GenCpm is limited to T_GenCpmMin≤T_GenCpm≤T_GenCpmMax. Here, T_GenCpmMin is the minimum (threshold) time elapsed between the start of consecutive CPM generation events, and T_GenCpmMax is the maximum (threshold) time elapsed between the start of consecutive CPM generation events. In one example, T_GenCpmMin=100 ms and T_GenCpmMax=1000 ms (or 1 second (s)). T_IO_CPM is then configured as an integer multiple (e.g., 2 to N times) of T_CM_CPM. If detected objects are more dynamic and safety critical (e.g., VRUs, such as pedestrians, cyclists, animals, and so forth), T_IO_CPM is configured to have a shorter duration (e.g., 2 to N times of T_CM_CPM). Otherwise, T_IO_CPM can be configured to have a longer duration (e.g., N+1 to N2 times of T_CM_CPM).

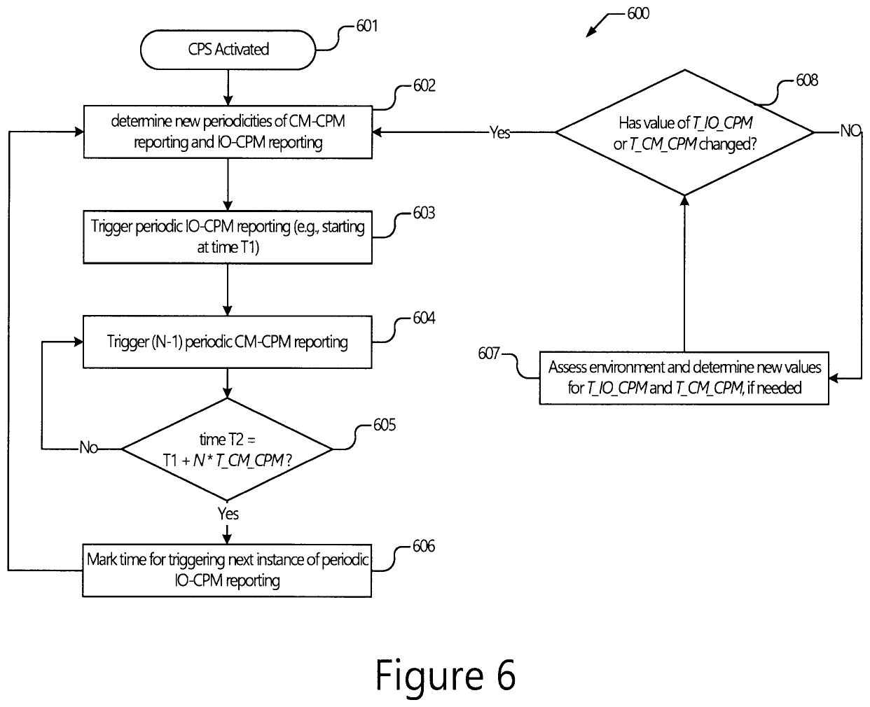

FIG. 6 shows an example process 600 for alternating CPM reporting mechanisms, namely for alternating between CM-CPM reporting and IO-CPM reporting. Process 600 may be performed by a CPM generation management function (“CPM-GM”), such as the CPM generation management function 1500 or 1600 of FIGS. 15 and 16 (or components therein). Process 600 begins at operation 601 where the CPS is activated. At operation 602, the CPM-GM determines new periodicities of CM-CPM reporting and IO-CPM reporting, which may be as expressed as follows:

T_{IO}=N*T_{CM} where N≥2

T_{GenCpmMin}≤T_{CM}≤T_{GenCpmMax}

In the above expression, “T_{IO}” is the T_IO_CPM; “T_{CM}” is the T_CM_CPM; “T_{GenCpmMin}” is the T_GenCpmMin, and “T_{GenCpmMax}” is the T_GenCpmMax. In one example, T_GenCpmMin is 100 ms and T_GenCpmMax is 1 s. At operation 603, the CPM-GM (or CPM generation frequency and content management function 1501 of FIGS. 15 and 16) triggers periodic IO-CPM reporting (e.g., starting at time T1). At operation 604, the CPM-GM (or function 1501) triggers (N−1) periodic CM-CPM reporting. For example, the CPM-GM can trigger a CM-CPM generation event at time T1+T_CM_CPM, at time T1+2*T_CM_CPM, and so forth to time T1+(N−1)*T_CM_CPM.

At operation 605, the CPM-GM (or CPM generation frequency function 1501) waits until time T2 equals T1+N*T_CM_CPM If time T2 does not equal T1+N*T_CM_CPM, then the CPM-GM (or function 1501) loops back to trigger another CM-CPM reporting/generation event. If time T2 does equal T1+N*T_CM_CPM, then the CPM-GM (or function 1501) marks a time for triggering a next instance of periodic IO-CPM reporting at operation 606 and then loops back to determine the CM-CPM reporting and IO-CPM reporting periodicities at operation 602.

Meanwhile, at operation 607, the CPM-GM (or function 1501) assesses an environment (e.g., detected dynamic and safety critical objects, and the like), and determines new values of reporting periodicities (e.g., new values for T_IO_CPM and T_CM_CPM), if necessary. Operation 607 may be performed before, during or after any of operations 602-606. Then the CPM-GM (or function 1501) proceeds to operation 608 to determine whether the value of T_IO_CPM or T_CM_CPM has changed. If the value for either period has not changed, then the CPM-GM (or function 1501) loops back to perform operation 607. If the value for either period has changed, then the CPM-GM (or function 1501) proceeds to perform operation 602.

In some implementations, POC inclusion management (e.g., POC inclusion management function 1504 of FIG. 15) is used to reduce CPM size. Since information about the perceived objects is also present in CMCs (e.g., transmitted during CM-CPM reporting), the perceived object inclusion criteria from [TS103324] can be relaxed for perceived objects to be selected for transmission from the object list for the current IO-CPM generation event.

In some implementations, the time-based perceived object inclusion criteria can be relaxed. For example, the time-based inclusion criterion from [TS103324] is: an IO with sufficient object existence confidence shall be selected for transmission from the object list as a result of the current CPM generation event if the time elapsed since the last time the object was included in a CPM 100 exceeds T_GenCpmMax. Currently, the T_GenCpmMax is set at 100 ms. The time-based inclusion criteria can be relaxed as follows: the time elapsed since the last time the object was included in either an IO-CPM 100 or a CM-CPM 100 has exceeded T_GenCpmMax; and/or the time elapsed since the last time the object was included in an IO-CPM 100 exceeds N_{IO} times T_GenCpmMax, where N_{IO}=1, 2, 3, . . . , M (where M is a number).

Additionally or alternatively, the speed-based perceived object inclusion criteria can also be relaxed. For example, the speed-based inclusion criterion from [TS103324] is: an IO with sufficient object existence confidence shall be selected for transmission from the object list as a result of the current CPM generation event if the difference between the current estimated ground speed of the reference point of the object and the estimated absolute speed of the reference point of this object lastly included in a CPM exceeds minGroundSpeedChangeThreshold. Currently, the minGroundSpeedChangeThreshold is set at 0.5 meters per second (m/s). The speed-based inclusion criteria can be relaxed as follows: the difference between the current estimated ground speed of the reference point of the IO and the estimated absolute speed of the reference point of this IO lastly included in an IO-CPM 100 exceeds a minGroundSpeedChange Threshold of x m/s. Here, the ground speed change threshold of x m/s allows for a greater threshold than the existing threshold of 0.5 m/s (e.g., x can be 0.5, 0.75, 1.0, . . . , and/or any other number).

Additionally or alternatively, the orientation-based perceived object inclusion criteria can also be relaxed. For example, the orientation-based inclusion criterion from [TS103324] is: an IO with sufficient object existence confidence shall be selected for transmission from the object list as a result of the current CPM generation event if the orientation of the object's estimated ground velocity, at its reference point, has changed by at least minGroundVelocityChange Threshold (or minGroundVelocityOrientationChangeThreshold) since the last inclusion of the object in a CPM. Currently, the minGroundVelocityChangeThreshold and/or minGroundVelocityOrientationChangeThreshold is set at 4 degrees. The orientation-based inclusion criterion can be relaxed as follows: the difference between the orientation of the vector of the current estimated ground velocity of the reference point of the IO and the estimated orientation of the vector of the ground velocity of the reference point of this IO lastly included in an IO-CPM 100 exceeds a minGroundVelocityChangeThreshold of y degrees. The velocity orientation change threshold of y degrees allows for a greater threshold than the existing threshold of 4 degrees (e.g., y can be 4, 5, 6, 7, 8, . . . , and/or any other number).

Additionally or alternatively, the distance-based perceived object inclusion criteria can also be relaxed/updated or remain the same. For example, the distance-based inclusion criterion from [TS103324] is: an object with sufficient object existence confidence shall be selected for transmission from the object list as a result of the current CPM generation event if the Euclidian distance between the current estimated position of the reference point of the object and the estimated position of the reference point of this object lastly included in a CPM 100 exceeds minPositionChangeThreshold. Currently, the minPositionChangeThreshold is set at 4 meters (m). In some implementations, the distance-based inclusion criterion can be updated/changed as follows: an IO with sufficient object existence confidence shall be selected for transmission from the object list as a result of the current CPM generation event if the Euclidian distance between the current estimated position of the reference point of the IO and the estimated position of the reference point of this IO lastly included in an IO-CPM 100 exceeds minPositionChange Threshold of dm. The distance threshold of dm allows for a smaller threshold than the existing threshold of 4 m (e.g., d≤4 and/or d can be set to be any other number).

Some implementations include FSAC inclusion management to reduce CPM size. In these implementations, the FSAC inclusion (e.g., FSAC inclusion management function 1503 of FIG. 15) can be skipped since the CMC already carries the free space information. Additionally or alternatively, the FSAC can be included with reduced frequency (e.g., included in every 2^{nd}, 3^{rd}, 4^{th}, and so forth, CPM generation instance of IO-CPM reporting).

Some implementations include additional data fields, flags, or data elements, which can be used to associate contents in IO-CPMs 100 and CM-CPMs 100 transmitted using the different CPM reporting mechanisms. In some implementations, each CPM 100 can have an ID or sequence number (SN). For examples, a new data element (DE) called ‘CPM-ID-SN’ can be added in the CpmManagementContainer. Additionally or alternatively, the data element ‘GenerationDeltaTime’ present in the ‘CollectivePerceptionMessage’ container can also be used as the ‘CPM-ID-SN’ to uniquely identify a CPM 100 from a disseminating (Tx) ITS-S.

Additionally or alternatively, a new DE called ‘Reference-to-Last-IO-CPM’ in the CMC of a CM-CPM 100 can be used to specify a reference to a previously transmitted IO-CPM 100. In some examples, the ‘Reference-to-Last-IO-CPM’ DE carries the ‘CPM-ID-SN’ of the last transmitted IO-CPM 100. Additionally or alternatively, a new DE called ‘Reference-to-Last-CM-CPM’ can be added in the POC and/or FSAC of an IO-CPM 100 to reference a previously transmitted CM-CPM 100. In some examples, the ‘Reference-to-Last-CM-CPM’ carries the ‘CPM-ID-SN’ of the last transmitted CM-CPM 100.

Some implementations include differential CM-CPM reporting for further reduction in the message size. Here, CM-CPMs 100 carry significant redundancy as CM content may not change between consecutive CM-CPM 100 transmissions. Differential (or incremental) CM-CPMs 100 (“D-CM-CPMs”) can be transmitted in such scenarios.

In some implementations, a new DE called ‘Reference-to-Last-CM-CPM’ can be added in the CMC of the D-CM-CPM to reference a previously transmitted full CM-CPM 100. In some examples, the ‘Reference-to-Last-CM-CPM’ carries the ‘CPM-ID-SN’ of the last transmitted full CM-CPM 100. Additionally or alternatively, the D-CM-CPM 100 carries a cost value and confidence level of perception of cells for which a cost value and/or confidence value has/have been changed more than a specified threshold number of times or by a threshold amount (e.g., D-Threshold-CostValue for cost value changes and D-Threshold-ConfidenceLevel for confidence level changes) compared to the referenced last full CM-CPM 100. For other cells, cost is skipped to reduce message size. In these implementations, the Rx ITS-S combines the last full CM-CPM 100 and current D-CM-CPM 100 to get the updated CM-CPM content.

1.2.2. Event-Triggered CPM Reporting with Periodic CPM Reporting

FIG. 7 shows an example timing diagram 700 for alternating periodic CPM reporting with an event triggered (ET) IO-CPM reporting mechanism (“ET-IO-CPM reporting”). In some implementations, occasional ET-IO-CPM reporting can be used in addition to periodic CPM reporting to share details of object detection with neighboring ITS-Ss. This may be used for predetermined or configured object types that are considered critical, and as such, the ET-IO-CPM reporting can immediately share details of such perceived objects with Rx ITS-Ss. In some scenario, more dynamic and safety critical new objects may be detected where object attributes (e.g., type, dimension, kinematic attributes, and/or the like) are important to share. In such a case, IO-CPM reporting may be more effective compared to CM-based CPM reporting. If a next instance of periodic IO-CPM generation event is not soon after detection and can potentially result in late reporting of such objects (e.g., for longer T_IO_CPM configuration), an occasional ET-IO-CPM 100 can be generated and transmitted immediately.

For example, in FIG. 7, each CM-CPM 100 is generated and transmitted after each T_CM_CPM period and individual IO-CPMs are generated and transmitted after each T_IO_CPM period. At some point after a CM-CPM generation event, a VRU 1216, 1210v is detected, but the next IO-CPM generation event is more than a predefined or configured amount of time (e.g., 500 ms) after the detection. Here, the detection of the VRU 1216, 1210v triggers an ET-IO-CPM generation event, which causes an ET-IO-CPM 100 to be generated and transmitted at some time less than the predefined or configured threshold reporting time (e.g., less than 500 ms) from the time of the VRU 1216, 1210v detection.

Detection of such dynamic and/or safety critical objects may also result in reconfiguration of CPM reporting periodicities (T_IO_CPM and T_CM_CPM). For example, shorter periodicities may be configured after a safety critical object is detected. Meanwhile, an ET-IO-CPM 100 can be generated and transmitted immediately, for example, before the shortened periodicities (T_IO_CPM and T_CM_CPM) are applied or otherwise come into effect.

The new periodicities (T_IO_CPM and T_CM_CPM) of IO-CPM reporting and CM-CPM reporting can come in effect at the next instance of IO-CPM reporting. In some cases, new periodicities can be effective from next CPM instance (either IO-CPM reporting or CM-CPM reporting, whichever comes first)—especially if new periodicities are required as soon as possible.

A new data element (DE) called ‘ET-IO-CPM’ can be added in the CpmManagementContainer to indicate that the CPM 100 is generated as event-triggered IO-CPM 100. Additionally, the ‘ET-IO-CPM’ DE can be an optional DE, which is present only if the CPM 100 is generated as an event-triggered IO-CPM 100, wherein the absence of the ‘ET-IO-CPM’ DE indicates that the CPM 100 is a periodic CPM 100.

1.2.3. POC and CMC Coexistence

In some implementations, periodic CPM generation and transmission by an ITS-S is used, where the CPM 100 contains at least one CMC to report some or all perceived objects inside the ITS-S's sensor FoV, and at least one POC to report a relatively small set of data related to selected dynamic and safety critical POs for accurate individual reporting of these selected POs. In these implementations, the FSAC inclusion is skipped as the CMC carries most of the information present in the FSAC.

1.2.4. CM-CPM Reporting Accompanied by Occasional POC with Small Set of Dynamic Objects

Since CM-CPM reporting is message size efficient, the CPM 100 transmission can be based on the periodic CM-CPM reporting. However, there may be detection of dynamic POs whose kinematic attributes and/or other information may be beneficial or otherwise desirable to neighboring ITS-Ss. In such scenarios, a POC with a relatively small set of POs and/or related data (e.g., for which sharing kinematic attributes and other info seem essential or desirable) can occasionally be added in the periodic CM-CPM 100. In some implementations, the POC, FSAC, and/or CMC are optional containers in such CPMs 100 (see e.g., [TS103324], and ['031]).

Occasional ET-IO-CPM reporting (in addition to IO-CPM reporting) generates and transmits an occasional ET-IO-CPM 100 to share details of detected safety critical POs immediately with Rx ITS-Ss. In some scenarios, more dynamic and safety critical POs may be detected where object attributes (e.g., type, dimension, kinematic attributes, and/or the like) are important or desirable to share. In such cases, the occasional ET-IO-CPM reporting may be more effective compared to CM-CPM reporting.

1.3. Sharing Three-Dimensional Information about POS

As discussed in ['031] and ['723] and discussed previously, the CMC carries a costmap 300 (or an LCMC carries an aggregated costmap layer 410, 510 with zero or more additional costmap layers) to share information about POs and structures. For each cell in the rectangular costmap grid, a cost DE carries a cost value or probability that specific types of objects (e.g., obstacles, structures, VRUs, and/or the like) are present in the cell along with an associated confidence level related to the perception (e.g., a perception confidence). However, the costmaps discussed previously are generally 2D structures, and therefore, Z-direction occupancy data for POs are not included in the CMC.

In some implementations, the Z-direction occupancy information of one or more POs and/or structures is included/provided in a CMC. In these implementations, a new field (DF) PerGridCellHeightValue is added to the cost information per cell to provide a height (e.g., Z-direction) value occupied by PO or structure (e.g., tunnel, parking clearance, bridge, overpass, flyover, tree branches, and/or the like). Additionally or alternatively, multiple formats/configurations can be used to specify height information in the CM (or CMC) in overhead/message-size efficient way. In one example, a first format/configuration (e.g., PerGridCellZDirectionHeightConfig1) can be used to report an object/structure occupying space from ground level to a first height h1, a second format/configuration (e.g., PerGridCellZDirectionHeightConfig2) can be used to report an object/structure occupying a second height h2 and above, and a third format/configuration (e.g., PerGridCellZDirectionHeightConfig3) can be used to report an object/structure occupying a height h3 to height h4 (e.g., h4>h3).

In the PerGridCellZDirectionHeightConfig1, the starting height is not specified because the starting height is the xy-plane of an ITS-S reference point (e.g., road and/or sidewalk level), and may be known at Rx ITS-Ss. Here, only the ending height of the object/structure is specified in the CMC to reduce message-size overhead. For example, the PerGridCellZDirectionHeightConfig1 can be used to specify a height for a PO detected on a road, sidewalk, and/or the like.

In the PerGridCellZDirectionHeightConfig2, the ending height of the object/structure is very high or not relevant, and therefore, the ending height does not need to be specified. Here, only the starting height of the object/structure is specified to reduce message-size overhead. For example, the PerGridCellZDirectionHeightConfig2 can be used to specify the height of a structure, such as a tunnel, parking entrance clearance, bridge, overpass, flyover, and/or the like.

In the PerGridCellZDirectionHeightConfig3, both the starting and ending heights of the object/structure are specified. For example, the PerGridCellZDirectionHeightConfig3 may be used to specify the height(s) of structures/objects like a bridge, overpass, flyover, tree branch hanging over a road, and/or the like. The PerGridCellZDirectionHeightConfig3 allows negative and positive height(s) to specify starting and/or ending heights below or above the ITS-S reference point.

In case there are POs of multiple heights in a cell (or multiple POs of different heights), a minimum starting height among the set of POs can constitute the starting height, while a maximum starting height among the set of POs can constitute the ending height. In case of multiple POs in a cell with large height differences, then smaller cell sizes may be selected to report costmap grid so that more granular PO height information can be shared. Additionally or alternatively, a new field (DF) ObjectStructureType is added to the cost information per cell to specify whether cell is occupied by object, structure, both, or none along with the height (Z-direction) value occupied by PO or structure.

1.4. Mechanisms to Determine Separate Confidence Level Per Cell

In some implementations, separate confidence levels may be determined for individual costmap cells. This may be used for scenarios where PO(s) occupy more than one cell. The onboard sensors on the ITS-S or connected off-board sensors accessible by the ITS-S perceive semantic information in their respective FoVs. Some sensor types create 2D perception information (e.g., visible light cameras, IR cameras, and/or the like) while other sensor types create 3D perception information (e.g., radar, LiDAR, and/or the like). AI/ML algorithms are used to classify, estimate, and/or extract the semantic information from the sensor data/measurements. The AI/ML model has a classification accuracy for objects with different sizes and environment conditions (e.g., different lighting conditions, rainy conditions, foggy conditions, snow conditions, and/or the like). The dimension of a bounding box, and location of the objects with their corresponding accuracy values are also estimated. In addition, there will be an overall system reliability measure for the sensor system on or accessible by the ITS-S. The overall object confidence value is calculated by weighted averaging of all the accuracy values above. The weights are adjusted based on the implementation preference.

The age of the object, which is the time difference between the time that a sensor measurement was taken and the time of a current processing instant, would also affect the accuracy of the detected object. The accuracy of the detected object will be higher the closer in time to the instant when the sensor measurement was taken, and lower at later time (e.g., at the lowest at the maximum allowable CPM inclusion time (e.g., 1 second)).

The accuracy value depends on the age of the object will also be considered in a weighted averaging. In addition, these individual accuracy values or weighted average values can be used in an exponential moving average filter with a specified value as the forgetting factor to make the overall confidence value more accurate.

If several objects are in a cell of a costmap, the confidence level of the cell will be the largest confidence value among those object confidence values. If an object spans in multiple cells, each cell may take the object confidence value in determining the cell confidence value.

When receiving multiple CMs from different sources for overlapping grid areas, the confidence value of an overlapping cell will be the largest confidence value of the received cell confidence values. Additionally or alternatively, the cost measurement times of these received CMs may also be used in determining the confidence value of the cell. For example, largest confidence value among the confidence values of most recently (e.g., within a predefined time range such as Del-T (ΔT) (e.g., (T_{current}−DelT (ΔT)) to T_{current}) measured CMs (among received CMs) can be the confidence value of an overlapping cell.

1.5. CPM Generation Aspects

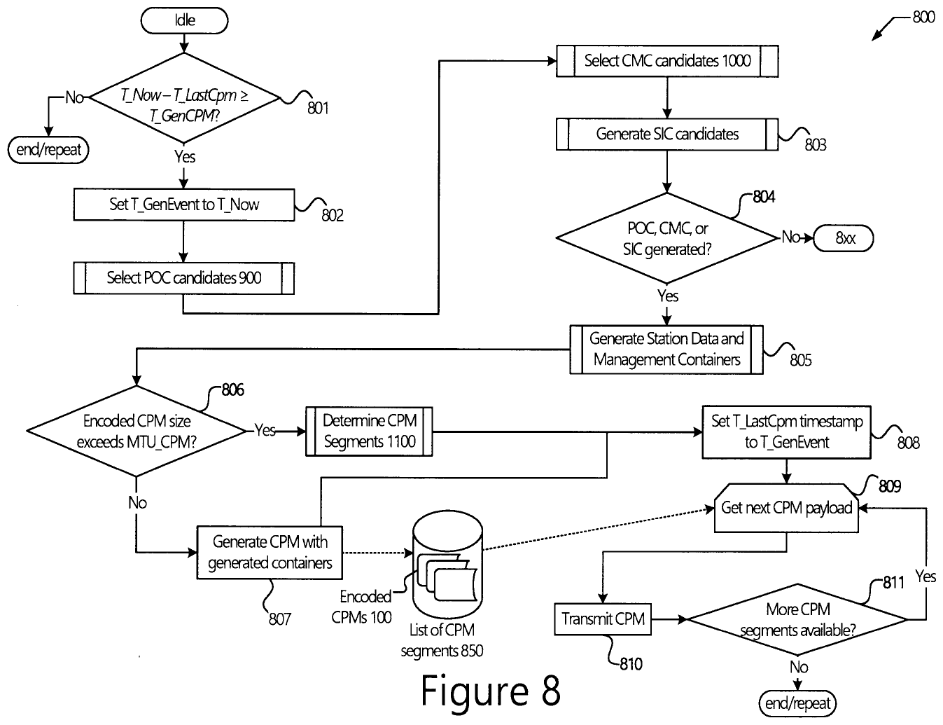

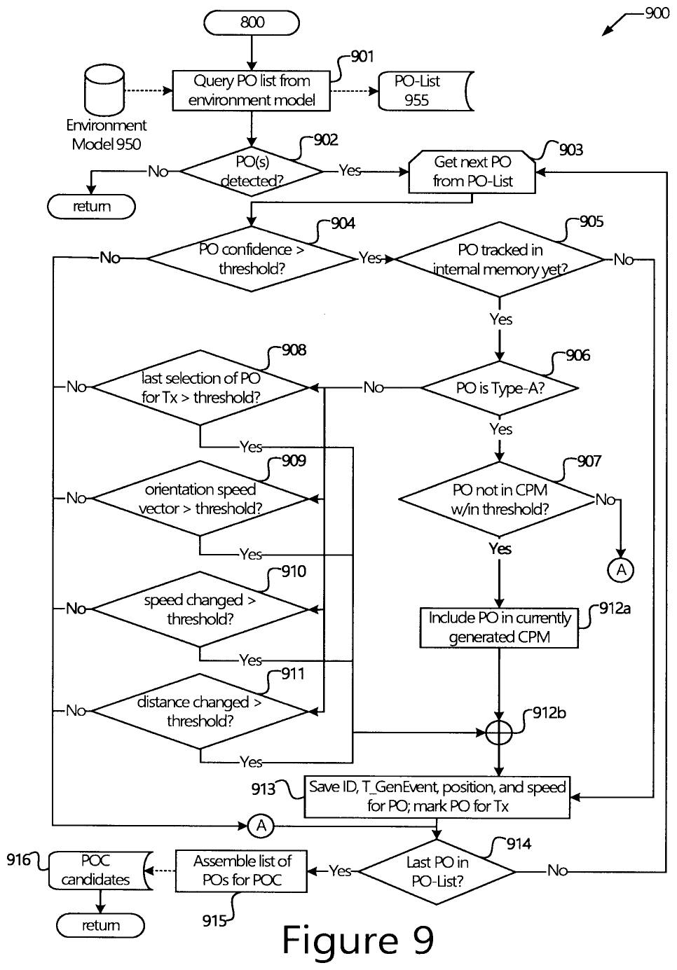

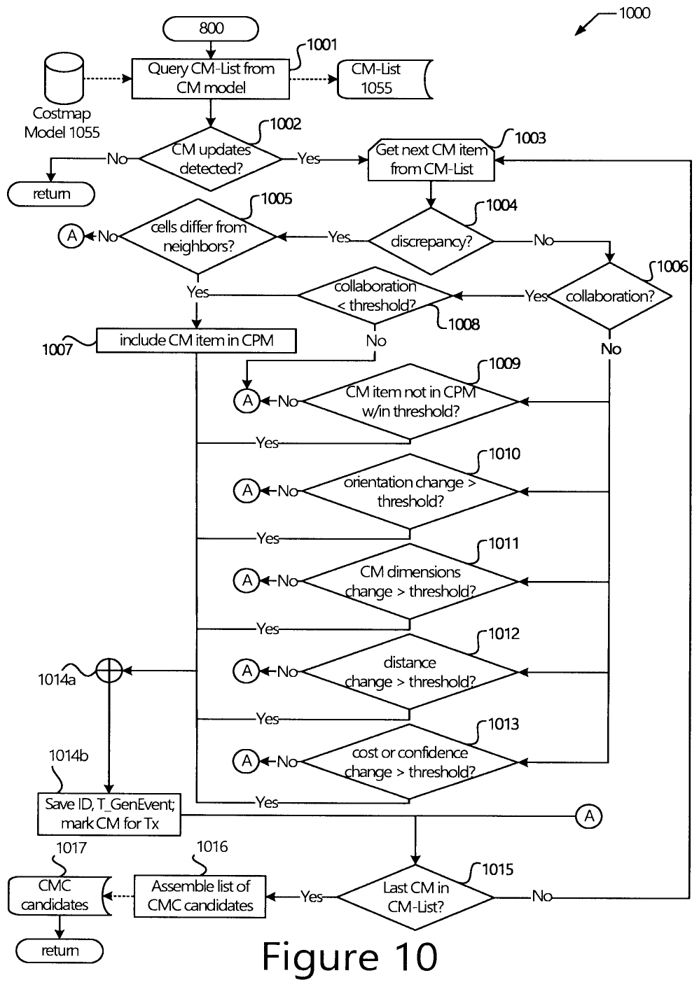

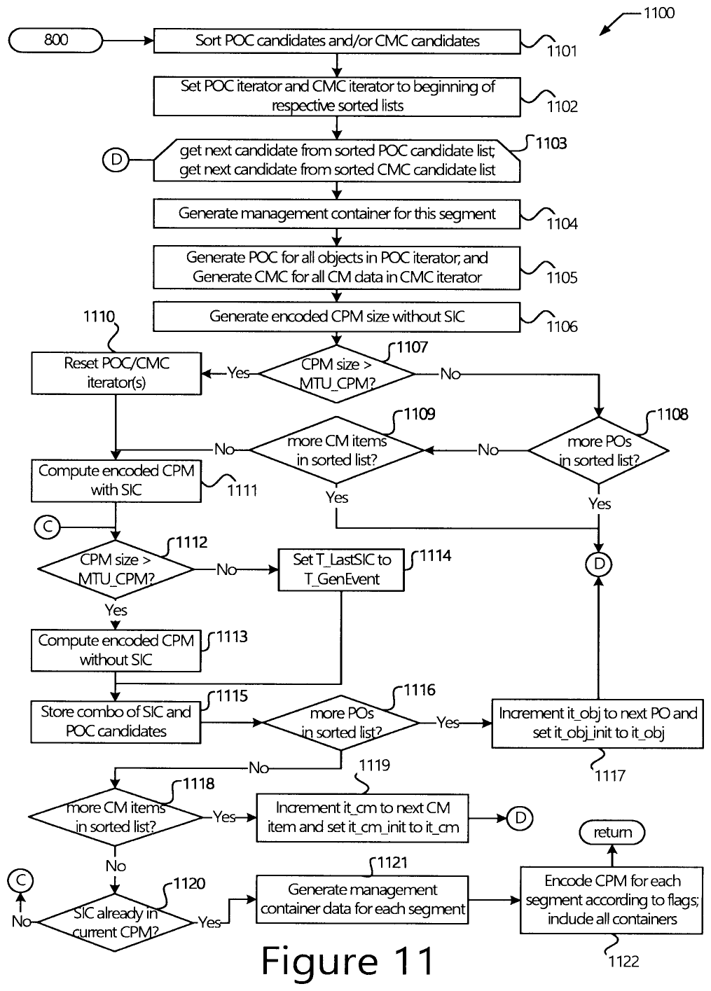

FIGS. 8-11 provide an exemplary implementation for the CPM generation rules discussed herein, including a CPM generation process 800 of FIG. 8, a POC candidate selection process 900 of FIG. 9), a CMC candidate selection process 1000 of FIG. 10, and a CPM segmentation process 1100 of FIG. 11 which takes place when the size of the CPM 100 exceeds a predefined or configurable threshold. The processes 800-1100 may be performed by the CPS 1321, 1421, and/or a CPM-GM (e.g., CPM generation management function 1500 or 1600 of FIGS. 15 and 16) within the CPS 1321, 1421.

FIG. 8 shows an example process 800 for generating CPMs 100. The process 800 depicted in FIG. 8 is executed no faster than every T_GenCpm, which may be adapted by the DCC algorithm to prevent channel overuse, as outlined in [TS103324]. If neither a POC nor an SIC is/are generated, then no CPM 100 is generated in the current cycle. In the case that a CPM 100 is generated, a station data container and a management container are also included. The CPM generation process 800 of FIG. 8 also includes (sub-)processes for generating and/or populating the SIC, the station data container, and the management container, and these sub processes are described in [TS103324]. A segmentation check algorithm is also performed to determine if message segmentation is required.

Process 800 begins by the CPM-GM determining whether the difference between the current time (T_Now) and a last time a CPM 100 was generated (T_LastCpm) is greater than or equal to a CPM generation event periodicity (T_GenCpm) (801), and if not, the process 800 ends or repeats. Otherwise, the CPM-GM sets the generation event time (T_GenEvent) to T_Now (802), and then performs a POC candidate selection process 900 (see e.g., FIG. 9). After the POC candidate selection process 900, the CPM-GM performs a CMC candidate selection process 1000 (see e.g., FIG. 10), and then performs an SIC candidate generation process (803; see e.g., [TS103324]). Note that the SIC is included in a CPM 100 independent of inclusion of the POC and the CMC. In case no object is detected with sufficient confidence and/or no costmap (CM) data (e.g., one or more CM layers) need to be transmitted, the ITS-S may still need to generate CPMs 100 periodically to report that it is equipped with local perception sensors, but is currently not perceiving any objects within its perception FoV/range and/or it has no costmap data to be shared.

After the SIC candidate generation/selection process, the CPM-GM determines whether any POC data, CMC data, or SIC data is/were generated (804), and if not, the process 800 ends or repeats. Otherwise, the CPM-GM determines performs an station data container and management container generation process (805; see e.g., [TS103324]). The process 800 then assembles a CPM 100 with all generated containers up to this point, potentially including the SIC, POC, and/or CMC (805, 807).

After generating the station data container and management container, the CPM-GM determines whether the size of the encoded CPM would exceed an MTU_CPM (806). If the encoded CPM does/would not exceed the MTU_CPM (806), the CPM-GM generates the CPM 100 with the generated containers (807). The encoded CPM are then stored in a list or database of CPM segments 850) and the CPM-GM proceeds to set the T_LastCpm timestamp to the T_GenEvent (808). If the encoded CPM does/would exceed the MTU_CPM (806), the CPM-GM performs the CPM segmentation process 1100 (see e.g., FIG. 11) and then proceeds to set the T_LastCpm timestamp to the T_GenEvent (808). In case the resulting message size after including all POC candidates and CMC candidates exceeds the MTU_CPM (806) for the given access layer technology, the message segmentation process should 1100 occurs. Note that the segmented CPMs 100 have same timestamp (e.g., generationDeltaTime) (808). Next, the CPM-GM gets a next CPM payload (e.g., from the CPM list/database 850) (809), and then transmits the CPM 100 (809). If there are more CPM segments available (811), then the CPM-GM gets a next CPM payload/segment (809); otherwise, process 800 ends or repeats as necessary.

FIG. 9 shows a (sub-)process 900 to identify and populate POC candidates for a CPM 100 to be transmitted. A POC candidate is, for example, a perceived object (PO) that is a candidate for inclusion in the POC for a current CPM 100 being generated. The process 900 implements some or all (e.g., the first four) POC triggering conditions (e.g., POC inclusion rules 1521) discussed herein. Process 900 begins from process 800 where the CPM-GM queries a PO list 955 from an environment model 950 (e.g., stored in a suitable database or other suitable data structure) (901). Note that each PO in the PO list 955 is characterized by a set of state variables including, for example, its position, speed, orientation, and/or other state variables. The data structure representing a PO is implementation-specific. Each PO also has a time of measurement to be able to derive the point in time at which the particular PO has been perceived relative to the generationDeltaTime timestamp in the CPM 100. Some or all of the POs in the PO list 955 can be selected as POC candidates.

Next, the CPM-GM determines whether any POs were detected (902), and if not, the process 900 returns back to process 800 (or ends or repeats as necessary). If a PO has been detected (902), the CPM-GM gets a next PO from the PO list 955 (903). Then, the CPM-GM determines if the PO confidence value/level is greater than a PO confidence threshold (ObjConfidenceThreshold) (904), and if not, the CPM-GM determines whether the PO is the last PO in the PO list 955 (914). If the PO confidence value/level is greater than the PO confidence threshold (ObjConfidenceThreshold) (904), then the CPM-GM determines if the PO tracked is in internal memory yet (905), and if not, the CPM-GM proceeds to save the PO's ID, T_GenEvent, position, and speed (e.g., in the internal memory), and marks the PO for transmission (913). If the PO tracked is in internal memory (905), then the CPM-GM determines whether the PO is a type-A PO (e.g., Type-A objects are objects of class vruSubclass with a profile pedestrian, bicyclistAndlightVruVehicle or animal or class groupSubclass or otherSubclass) (906). If the PO is not a type-A PO (e.g., the PO is a type-B PO, which are objects of any other class, such as class vehicleSubclass or vruSubclass with a profile motorcyclist), then the CPM-GM determines whether any of the POC inclusion rules have been fulfilled or not (908-911).

If the PO is a type-A PO (906), then the CPM-GM determines whether the PO was not included in a previous CPM 100 within a threshold amount of time, such as within X ms where X is a number (907). In one example

$$X = \frac{T\_GenCpmMax}{2} .$$

If the PO was not included in the previous CPM 100 within the threshold amount of time, then the PO is included in the currently generated CPM 100 (912a-912b); otherwise, the CPM-GM proceeds to determine whether the PO is the last PO in the PO list 955 (914).

If the PO is a type-B PO (906), then the CPM-GM checks whether (in any order): the time elapsed since the last time the PO was included in a CPM 100 is equal or larger than a threshold amount of time (e.g., where the threshold amount of time is T_GenCpmMax) (908); the orientation of the PO's estimated ground velocity, at its reference point, has changed by at least a threshold amount (e.g., minGroundVelocityOrientationChangeThreshold) since the last inclusion of the PO in a CPM 100 (909); the difference between the current estimated ground speed of the reference point of the PO and the estimated absolute speed of the reference point of this PO lastly included in a CPM 100 exceeds a threshold (e.g., minGroundSpeedChangeThreshold) (910); and the Euclidian distance between the current estimated position of the reference point of the PO and the estimated position of the reference point of this PO lastly included in a CPM 100 exceeds a threshold (e.g., minPositionChangeThreshold) (911). For each of the inclusion rules, if the inclusion rule is not satisfied (908-911), then the CPM-GM proceeds to determine whether the PO is the last PO in the PO list 955 (914); and if the inclusion rule is satisfied (908-911), then the CPM-GM proceeds to combine the relevant PO data for inclusion in the CPM 100 (912b), and saves the PO's ID, T_GenEvent, position, and speed (e.g., in the internal memory) and marks the PO for transmission (913). Next, the CPM-GM determines whether the PO is the last PO in the PO list 955 (914), and if not, the CPM-GM proceeds to get the next PO from the PO list 955 (903). If the PO is the last PO in the PO list 955 (914), then the CPM-GM assembles a list of POs for the POC based on the marked POs (915), which is then provided as a set (or list) of POC candidates (916), and then the process 900 returns to process 800.

FIG. 10 shows a (sub-)process 1000 to identify and populate the CMC with CMC candidates for a CPM 100 to be transmitted. A CMC candidate is, for example, a costmap (CM) item or a CM layer that is a candidate for inclusion in the CMC for a current CPM 100 being generated. The process 1000 implements the CMC triggering conditions (e.g., CMC inclusion rules 1521) discussed herein. Process 1000 begins from process 800 where the CPM-GM queries a CM list 1055 from a CM model 1050 (e.g., stored in a suitable database or other suitable data structure) (1001). The CM model 1050 may correspond to the costmaps discussed previously w.r.t FIGS. 3-5. Each CM item in the CM list 1055 may be a data element or information about an individual CM cell (e.g., cell ID or location within the CM, a cost value for the cell, a confidence level for the cost value, and/or any other relevant data), or each CM item may be an individual CM layer (see e.g., FIGS. 4-5). Each CM item in the CM list 1055 represents a dynamic environment perceived by the ITS-S as a CM and is characterized by a set of state variables including, for example, a CM type (e.g., type of CM layer, type of CM item, CM protocol used to generate the CM, and/or the like), overall rectangular reported grid area, size or dimensions of the CM grid, size or dimensions of each cell in the grid, and/or other state variables. The data structure representing a CM (or an individual CM layer) is implementation-specific. Each CM item also has a time of recent update to be able to derive the point in time at which the particular CM, CM item, and/or CM layer has been perceived relative to the generationDeltaTime timestamp in the CPM 100. Some or all of the CM items in the CM list 1055 can be selected as CMC candidates.

Next, the CPM-GM determines whether any CM (or CM layer) updates were detected (1002), and if not, the process 1000 returns back to process 800 (or ends or repeats as necessary). If a CM update has been detected (1002), the CPM-GM gets a next CM item from the CM list 1055 (1003). Then, the CPM-GM determines if the CM item has a discrepancy (or whether the CM layer is the discrepancy handling layer 405) (1004).

If the CM item has a discrepancy (or the CM layer is the discrepancy handling layer 405) (1004), then CPM-GM determines whether an amount of cells in the CM have cost values that differ from those provided by neighboring ITS-Ss (1005). For example, the CPM-GM can determine whether more than a threshold percent (%) of cells in the CM 300 or the aggregated layer 410 differ from the values for those cells in CMs provided by neighboring ITS-Ss. If fewer than the threshold amount (or percentage) of cells in the CM differ from neighbors' CMs (1005), then the CPM-GM determines whether the CM item is the last CM item in the CM list 1055 (1015); otherwise, the CPM-GM includes the CM item (or discrepancy layer 405) in the CPM 100 (1007, 1014a, 1014b).

If the CM item has no discrepancy (or the CM layer is not the discrepancy handling layer 405) (1004), then the CPM-GM determines whether a collaboration request should be issued (or whether the CM layer is the collaboration request layer 406) (1006). If a collaboration request should not be issued (or the CM layer is not the collaboration request layer 406) (1006), then the CPM-GM determines whether any of the CMC inclusion rules have been fulfilled or not (1009-1013). If the collaboration request should be issued (or the CM layer is the collaboration request layer 406) (1006), then the CPM-GM determines whether the CPM-GM could not determine values of more than a threshold amount (or percentage) of cells in the CM 300 or the aggregated layer 410 with confidence higher than another threshold (1008). If the CPM-GM could not determine values of more than a threshold amount (or percentage) of cells in the CM 300 or the aggregated layer 410 with confidence higher than the other threshold (1008), then the CPM-GM determines whether the CM item is the last CM item in the CM list 1055 (1015); otherwise, the CPM-GM includes the CM item (or collaboration request layer 406) in the CPM 100 (1007, 1014a, 1014b).

If the collaboration request should not be issued (or the CM layer is not the collaboration request layer 406) (1006), then the CPM-GM determines whether any of the CMC inclusion rules have been fulfilled or not (1009-1013). For the CMC inclusion rules, the CPM-GM checks whether (in any order): the time elapsed since the last time the CM item was included in a CPM 100 is equal or larger than a threshold amount of time (e.g., where the threshold amount of time is T_GenCpmMax) (1009); the difference between the current orientation (e.g., semiMajorRangeOrientation) of the CM item and the semiMajorRangeOrientation of the reported CM item has changed by at least a threshold amount (e.g., minSemiMajorRangeOfCostMapGridAreaOrientationChangeThreshold) since the last inclusion of the CM item in a CPM 100 (1010); the difference between the current dimensions (e.g., length and/or width) of the CM item to be reported and the dimensions (e.g., length and/or width) of the previously reported CM item lastly included in a CPM 100 exceeds a threshold (e.g., minLengthOrWidthChangeThreshold) (1011); the Euclidian distance between the current estimated position of the reference point (e.g., NodeCenterPoint) of the CM item and the estimated position of the reference point of this CM item lastly included in a CPM 100 exceeds a threshold (e.g., minNodeCenterPointOfCostMapGridAreaPositionChangeThreshold) (1012); and/or the cost values and/or confidence levels changes for more than a threshold number or a threshold percentage of the total number of cells in the CM (e.g., minPercentageOfCellsWithCostOrConfidenceChangeThreshold) compared to the cost values and/or confidence levels lastly included in a CPM 100 (1013). For each of the CMC inclusion rules, if the inclusion rule is not satisfied (1009-1013), then the CPM-GM proceeds to determine whether the CM item is the last CM item in the CM list 1055 (1015); and if the inclusion rule is satisfied (1009-1013), then the CPM-GM proceeds to combine the relevant CM data for inclusion in the CPM 100 (1014a), and saves the CM item ID and T_GenEvent (e.g., in the internal memory) and marks the CM item (or CM layer) for transmission (1014b).

Next, the CPM-GM whether the CM item is the last CM item in the CM list 1055 (1015), and if not, the CPM-GM proceeds to get the next CM item from the CM list 1055 (1003). If the CM item is the last CM item in the CM list 1055 (1015), then the CPM-GM assembles a list of CM items for the CMC based on the marked CM items (1016), which is then provided as a set (or list) of CMC candidate (1017), and then the process 1000 returns to process 800.

FIG. 11 shows a (sub-)process 1100 to determine CPM segments. In case the CPM 100 needs to be segmented as a result of exceeding the allowed size of MTU_CPM (806), POC candidates and CMC candidates are added to the CPM segment until either all POs and/or CM items are included, or the CPM size exceeds the MTU_CPM. The PO and/or CM item selection processes thereby take the previously generated station data and management container into account, when computing the resulting message size. Once the POC candidates and/or CMC candidates for the current segment are identified, it is checked whether the SIC can also be added without violating the message size constraint of MTU_CPM. Otherwise, this process is repeated and more CPM segments are generated until all the POC candidates and/or CMC candidates and the SIC is in included in a CPM segment.

Process 1100 begins from process 800 where the CPM-GM sorts the POC candidates and/or CMC candidates (1101). In one example, the CPM-GM sorts POs (or POC candidates) in the POC candidate list 916 in descending order w.r.t to the product of PO confidence and PO speed. This may ensure that highly dynamic POs are transmitted as soon as possible. Additionally or alternatively, the CPM-GM sorts CM items/layers (or CMC candidates) in the CMC candidate list 1017 in a descending order. For example, the CM layers can be sorted as follows: aggregate layer 410, perceived obstacles layer 402, objects layer 502, inflation layer 403, collective perception layer 404, discrepancy handling layer 405, and collaboration request layer 406). In another example, the CPM-GM sorts CM items w.r.t to a produce of cell confidence level and cost value. After sorting of the candidates, the CPM-GM sets POC and CMC iterators (1102). For example, the CPM-GM sets an iterator it_cm_init to beginning of the sorted list of CM items, and sets an iterator it_obj_init to beginning of the sorted list of POs.

Next, the CPM-GM gets the next PO from the PO list 955 (or sorted POC candidate list 916) and/or gets next CM item/layer from the CM list 1055 (or the sorted CMC candidate list 1017) (1103). In some examples, the CPM-GM increments the iterator it_obj starting at it_obj_init and/or increments the iterator it_cm starting at it_cm_init (1103). Next, the CPM-GM generates the management container for the current CPM segment (1104). The management container is present for preliminary message size estimation (e.g., using the formerly generated management container with additional message segmentation information).

Next, the CPM-GM generates a POC for all POs from it_obj_init up to the current iterator it_obj and/or generates a CMC for all CM items from it_obj_init up to the current iterator it_obj (1105). Then, the CPM-GM generates an encoded message (e.g., ASN.1 UPER encoded message) size without an SIC (1106) and then determines if the encoded message size (without SIC) is above the MTU_CPM (1107). If the CPM size is above the MTU_CPM (1107), then the CPM-GM resets the POC iterator it_obj and/or the CMC iterator it_cm to its previous value (e.g., decrement by 1) (1110). If the CPM size is not above the MTU_CPM (1107), then the CPM-GM determines whether there are any more POs (or POC candidates) in the sorted POC candidate list 916 (1108). If there are any more POs (or POC candidates) in the sorted POC candidate list 916 (1108), then CPM-GM gets the next PO (or POC candidate) from the sorted POC candidate list 916 (1103). If there are no more POs (or POC candidates) in the sorted POC candidate list 916 (1108), then the CPM-GM determines whether there are any more CM items (or CMC candidates) in the sorted CMC candidate list 1017 (1109). If there are any more CM items (or CMC candidates) in the sorted CMC candidate list 1017 (1109), then CPM-GM gets the next CM item (or CMC candidate) from the sorted CMC candidate list 1017 (1103). If there are no more CM items (or CMC candidates) in the sorted CMC candidate list 1017 (1109), then the CPM-GM computes an encoded CPM with the SIC (1111) and determines whether the CPM size (with SIC) exceeds the MTU_CPM (1112). If the CPM size (with SIC) does not exceed the MTU_CPM (1112), then the CPM-GM sets the T_LastSIC to T_GenEvent (1114) and then stores the combination of the SIC and the selected POC candidate (1115). If the CPM size (with SIC) does exceed the MTU_CPM (1112), then the CPM-GM computes the encoded CPM without SIC (1113) and then stores the combination of the SIC and the selected POC candidate (1115).

After storing the combination of the SIC and POC candidate (1115), the CPM-GM determines whether there are any more POs (or POC candidates) in the sorted POC candidate list 916 (1116). If there are more POs (or POC candidates) in the sorted POC candidate list 916 (1116), then the CPM-GM increments the POC iterator it_obj to next PO and sets the it_obj_init to it_obj (1117), and then gets the next PO (or POC candidate) from the sorted POC candidate list 916 (1103). If there are no more POs (or POC candidates) in the sorted POC candidate list 916 (1116), then the CPM-GM determines whether there are any more CM items (or CMC candidates) in the sorted CMC candidate list 1017 (1118). If there are more CM items (or CMC candidates) in the sorted CMC candidate list 1017 (1118), then the CPM-GM increments the CMC iterator it_cm to the next CM item and sets the it_cm_init to it_cm (1119), and then gets the next CM item (or CMC candidate) from the sorted CMC candidate list 1017 (1103).

If there are no more CM items (or CMC candidates) in the sorted CMC candidate list 1017 (1118), then the CPM-GM determines whether the SIC is already in the current CPM 100 (1120). If the SIC is already in the current CPM 100 (1120), then the CPM-GM proceeds to determine whether the CPM size (with SIC) exceeds the MTU_CPM (1112). If the SIC is not already in the current CPM 100 (1120), then the CPM-GM generates a management container for each segment (1121), encodes the CPM 100 for each segment according to flags, and including all required containers (1122), and then the process 1100 returns to process 800. Once the CPM 100 (or CPM segments) are generated, it is returned to CPM generation process 800, which then updates the timestamp corresponding to the current generation event and passes the message(s) to the lower layer for transmission.

### 2. Intelligent Transport System (ITS) Configurations and Arrangements

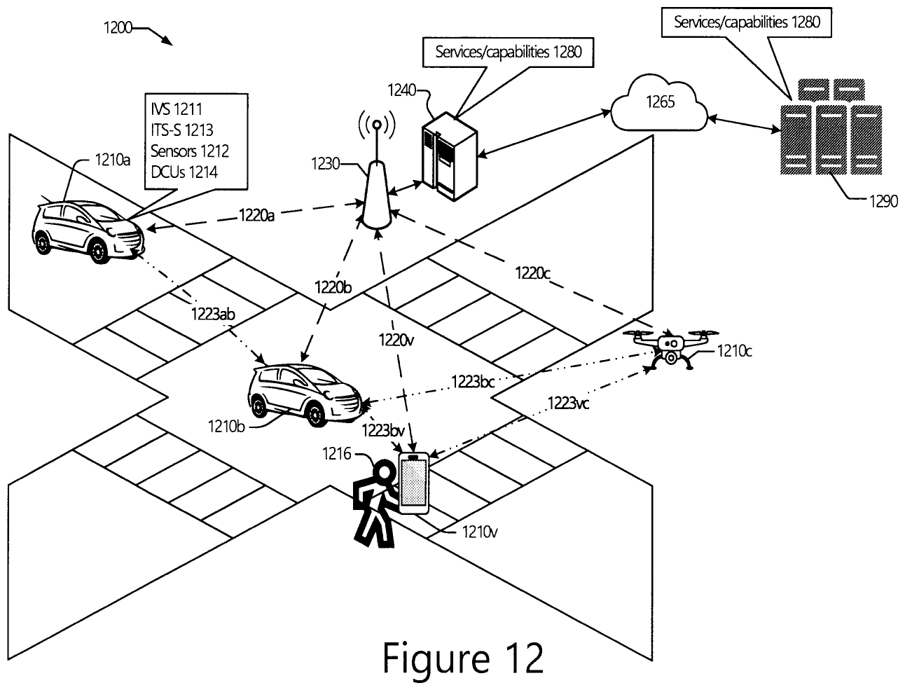

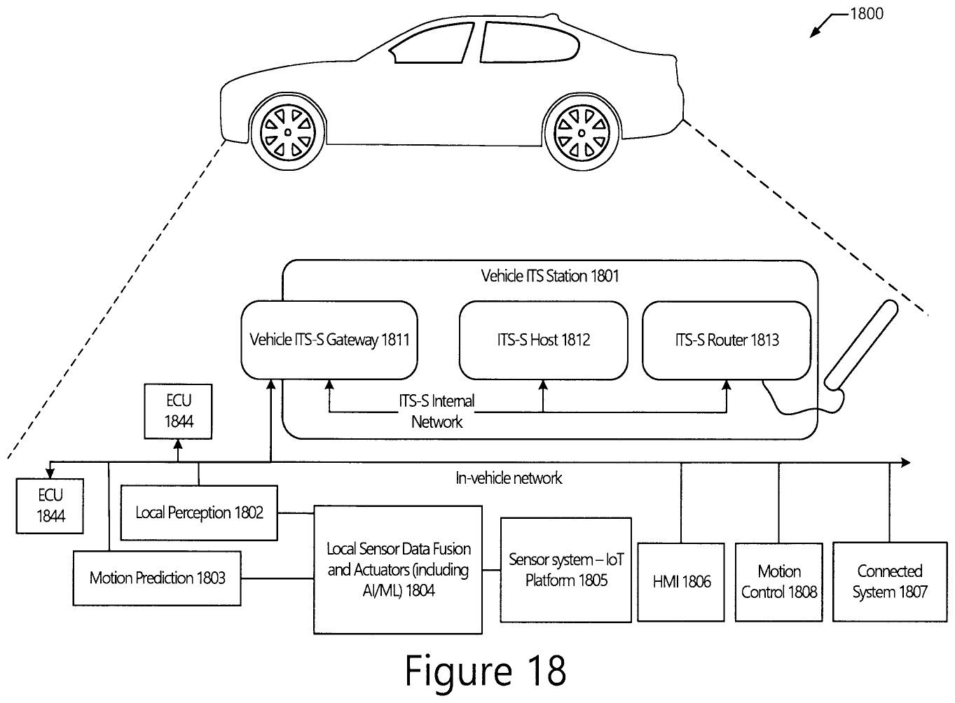

FIG. 12 illustrates an overview of an vehicular network environment 1200, which includes vehicles 1210a, 1210b, and 1210c (collectively referred to as “vehicle 1210” or “vehicles 1210”), vulnerable road user (VRU) 1216, a network access node (NAN) 1230, edge compute node 1240, and a service provider platform (SPP) 1290 (also referred to as “cloud computing service 1290”, “cloud 1290”, “servers 1290”, or the like). Vehicles 1210a and 1210b are illustrated as motorized vehicles, each of which are equipped with an engine, transmission, axles, wheels, as well as control systems used for driving, parking, passenger comfort and/or safety, and/or the like. The terms “motor”, “motorized”, and/or the like as used herein refer to devices that convert one form of energy into mechanical energy, and include internal combustion engines (ICE), compression combustion engines (CCE), electric motors, and hybrids (e.g., including an ICE/CCE and electric motor(s)), which may utilize any suitable form of fuel. Vehicle 1210c is illustrated as a remote controlled or autonomous flying quadcopter, which can include various components such as, for example, a fuselage or frame, one or more rotors (e.g., either fixed-pitch rotors, variable-pitch rotors, coaxial rotors, and/or the like), one or more motors, a power source (e.g., batteries, hydrogen fuel cells, solar cells, hybrid gas-electric generators, and the like), one or more sensors, and/or other like components (not shown), as well as control systems for operating the vehicle 1210c (e.g., flight controller (FC), flight controller board (FCB), UAV systems controllers, and the like), controlling the on-board sensors, and/or for other purposes. The vehicles 1210a, a10b may represent motor vehicles of varying makes, models, trim, and/or the like, and/or any other type of vehicles, and vehicle 1210c may represent any type of flying drone and/or unmanned aerial vehicle (UAV). Additionally, the vehicles 1210 may correspond to the vehicle computing system 1800 of FIG. 18.

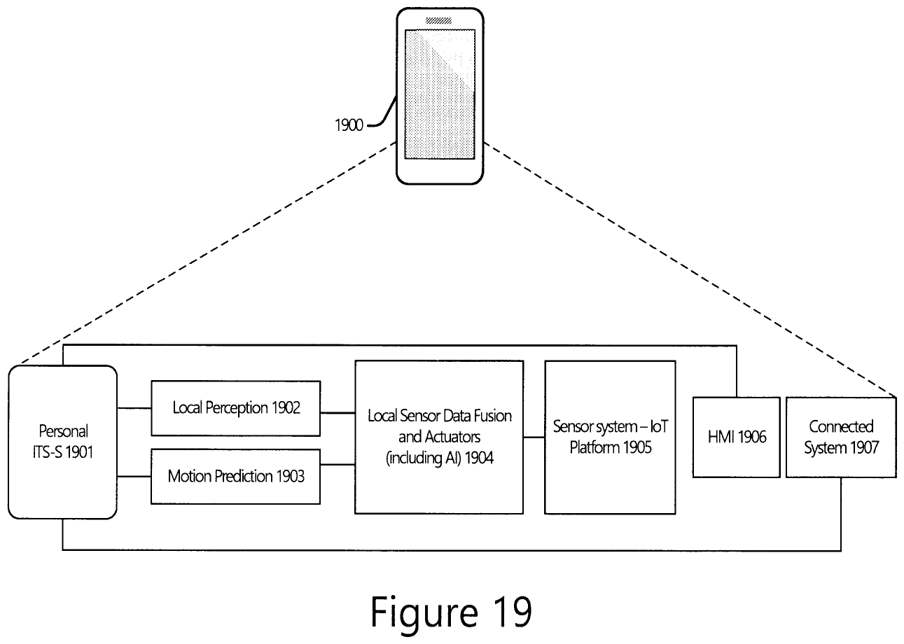

Environment 1200 also includes VRU 1216, which includes a VRU device 1210v (also referred to as “VRU equipment 1210v”, “VRU system 1210v”, or simply “VRU 1210v”). The VRU 1216 is a non-motorized road user, such as a pedestrian, light vehicle carrying persons (e.g., wheelchair users, skateboards, e-scooters, Segways, and/or the like), motorcyclist (e.g., motorbikes, powered two wheelers, mopeds, and/or the like), and/or animals posing safety risk to other road users (e.g., pets, livestock, wild animals, and/or the like). The VRU 1210v includes an ITS-S that is the same or similar as the ITS-S 1213 discussed previously, and/or related hardware components, other in-station services, and sensor sub-systems. The VRU 1210v could be a pedestrian-type VRU device 1210v (e.g., a personal computing system 1900 of FIG. 19, such as a smartphone, tablet, wearable device, and the like), a vehicle-type VRU device 1210v (e.g., a device embedded in or coupled with a bicycle, motorcycle, or the like, or a pedestrian-type VRU device 1210v in or on a bicycle, motorcycle, or the like), or an IoT device (e.g., traffic control devices) used by a VRU 1210v integrating ITS-S technology. Various details regarding VRUs and VAMs are discussed in ETSI TR 103 300-1 v2.1.1 (2019-09) (“[TR103300-1]”), ETSI TS 103 300-2 V0.3.0 (2019-12) (“[TS103300-2]”), and ETSI TS 103 300-3 V0.1.11 (2020-05) (“[TS103300-3]”). For purposes of the present disclosure, the term “VRU 1210v” may to refer to both the VRU 1216 and its VRU device 1210v unless the context dictates otherwise. The various vehicles 1210 referenced throughout the present disclosure, may be referred to as vehicle UEs (vUEs) 1210, vehicle stations 1210, vehicle ITS stations (V-ITS-S) 1210, computer-assisted or autonomous driving (CA/AD) vehicles 1210, drones 1210, robots 1210, and/or the like. Additionally, the term “user equipment 1210”, “UE 1210”, “ITS-S 1210”, “station 1210”, or “user 1210” (either in singular or plural form) may to collectively refer to the vehicle 1210a, vehicle 1210b, vehicle 1210c, and VRU 1210v, unless the context dictates otherwise.

For illustrative purposes, the following description is provided for deployment scenarios including vehicles 1210 in a 2D freeway/highway/roadway environment wherein the vehicles 1210 are automobiles. However, other types of vehicles are also applicable, such as trucks, busses, motorboats, motorcycles, electric personal transporters, and/or any other motorized devices capable of transporting people or goods. In another example, the vehicles 1210 may be robots operating in an industrial environment or the like. 3D deployment scenarios are also applicable where some or all of the vehicles 1210 are implemented as flying objects, such as aircraft, drones, UAVs, and/or to any other like motorized devices. Additionally, for illustrative purposes, the following description is provided where each vehicle 1210 includes in-vehicle systems (IVS) 1211. However, it should be noted that the UEs 1210 could include additional or alternative types of computing devices/systems, such as, for example, smartphones, tablets, wearables, PDAs, pagers, wireless handsets, smart appliances, single-board computers (SBCs) (e.g., Raspberry Pi®, Arduino®, Intel® Edison®, and/or the like), plug computers, laptops, desktop computers, workstations, robots, drones, in-vehicle infotainment system, in-car entertainment system, instrument cluster, head-up display (HUD) device, onboard diagnostic device, on-board unit, dashtop mobile equipment, mobile data terminal, electronic engine management system, electronic/engine control unit, electronic/engine control module, embedded system, microcontroller, control module, and/or any other suitable device or system that may be operable to perform the functionality discussed herein, including any of the computing devices discussed herein.

Each vehicle 1210 includes an in-vehicle system (IVS) 1211, one or more sensors 1212, ITS-S 1213, and one or more driving control units (DCUs) 1214 (also referred to as “electronic control units 1214”, “engine control units 1214”, or “ECUs 1214”). For the sake of clarity, not all vehicles 1210 are labeled as including these elements in FIG. 12. Additionally, the VRU 1210v may include the same or similar components and/or subsystems as discussed herein w.r.t any of the vehicles 1210, such as the sensors 1212 and ITS-S 1213. The IVS 1200 includes a number of vehicle computing hardware subsystems and/or applications including, for example, instrument cluster subsystems, a head-up display (HUD) subsystem, infotainment/media subsystems, a vehicle status subsystem, a navigation subsystem (NAV), artificial intelligence and/or machine learning (AI/ML) subsystems, and/or other subsystems. The NAV provides navigation guidance or control, depending on whether vehicle 1210 is a computer-assisted vehicle, or an autonomous driving vehicle. The NAV may include or access computer vision functionality of the and/or the AI/ML subsystem to recognize stationary or moving objects based on sensor data collected by sensors 1212, and may be capable of controlling DCUs 1214 based on the recognized objects.

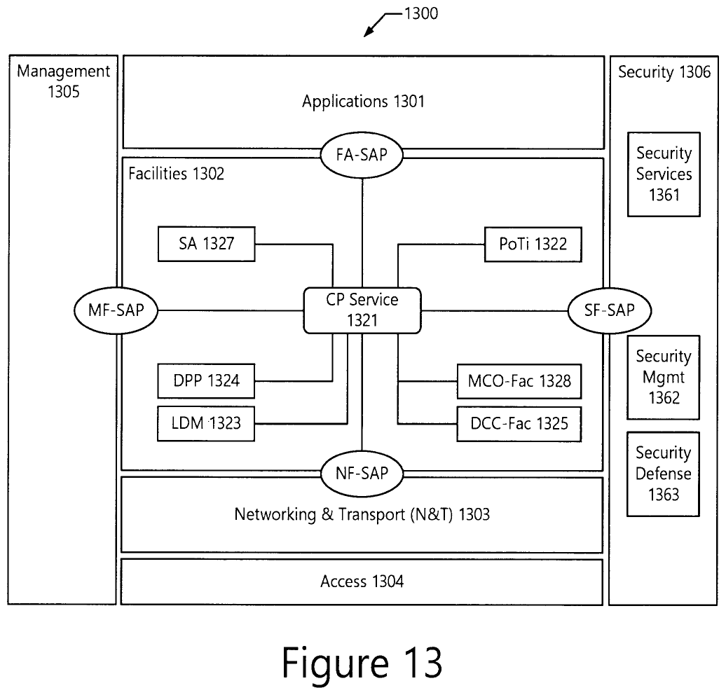

The UEs 1210 also include an ITS-S 1213 that employs one or more Radio Access Technologies (RATs) to allows the UEs 1210 to communicate directly with one another and/or with infrastructure equipment (e.g., network access node (NAN) 1230). In some examples, the ITS-S 1213 corresponds to the ITS-S 1300 of FIG. 13. The one or more RATs may refer to cellular V2X (C-V2X) RATs (e.g., V2X technologies based on 3GPP LTE, 5G/NR, and beyond), a WLAN V2X (W-V2X) RAT (e.g., V2X technologies based on DSRC in the USA and/or ITS-G5 in the EU), and/or some other RAT, such as any of those discussed herein.

For example, the ITS-S 1213 utilizes respective connections (also referred to as “channels” or “links”) 1220a, 1220b, 1220c, 1220v to communicate data (e.g., transmit and receive) data with the NAN 1230. The connections 1220a, 1220b, 1220c, 1220v are illustrated as an air interface to enable communicative coupling consistent with one or more communications protocols, such as any of those discussed herein. The ITS-Ss 1213 can directly exchange data with one another via respective direct links 1223ab, 1223bc, 1223vc, each of which may be based on 3GPP or C-V2X RATs (e.g., LTE/NR Proximity Services (ProSe) link, PC5 links, sidelink channels, and the like), IEEE or W-V2X RATs (e.g., WiFi-direct, [IEEE80211p], IEEE 802.11bd, [IEEE802154], ITS-G5, DSRC, WAVE, and/or the like), or some other RAT (e.g., Bluetooth®, and/or the like). The ITS-Ss 1213 exchange ITS protocol data units (PDUs) (e.g., CAMs, CPMs 100, DENMs, misbehavior reports, and/or the like) and/or other messages with one another over respective links 1223 and/or with the NAN 1230 over respective links 1220.

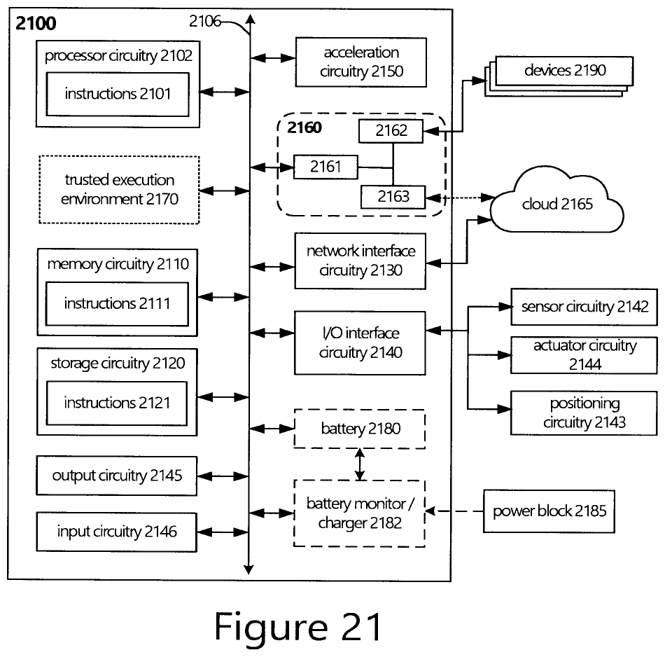

The ITS-S 1213 are also capable of collecting or otherwise obtaining radio information, and providing the radio information to the NAN 1230, the edge compute node 1240, and/or the cloud system 1290. The radio information may be in the form of one or more measurement reports, and/or may include, for example, signal strength measurements, signal quality measurements, and/or the like. Each measurement report is tagged with a timestamp and the location of the measurement (e.g., the current location of the ITS-S 1213 or UE 1210). The radio information may be used for various purposes including, for example, cell selection, handover, network attachment, testing, and/or other purposes. As examples, the measurements collected by the UEs 1210 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/NO), energy per chip to interference power density ratio (Ec/IO), energy per chip to noise power density ratio (Ec/NO), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP or RAN node reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v16.2.0 (2021-03-31) (“[TS36214]”), 3GPP TS 38.215 v16.4.0 (2021-01-08) (“[TS38215]”), 3GPP TS 38.314 v16.4.0 (2021-09-30) (“[TS38314]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), and/or the like. Additionally or alternatively, any of the aforementioned measurements (or combination of measurements) may be collected by the NAN 1230 and provided to the edge compute node(s) 1240 and/or cloud compute node(s) 1290. The measurements/metrics can also be those defined by other suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., [MEC]), IEEE/WiFi (e.g., [IEEE80211], [WiMAX], [IEEE16090], and/or the like), and/or any other like standards such as those discussed elsewhere herein. Some or all of the UEs 1210 can include positioning circuitry (e.g., positioning circuitry 2143 of FIG. 21) to (coarsely) determine their respective geolocations and communicate their current position with one another and/or with the NAN 1230 in a secure and reliable manner. This allows the UEs 1210 to synchronize with one another and/or with the NAN 1230.

The DCUs 1214 include hardware elements that control various (sub)systems of the vehicles 1210, such as the operation of the engine(s)/motor(s), transmission, steering, braking, rotors, propellers, servos, and/or the like. DCUs 1214 are embedded systems or other like computer devices that control a corresponding system of a vehicle 1210. The DCUs 1214 may each have the same or similar components as compute node 2100 of FIG. 21 discussed infra, or may be some other suitable microcontroller or other like processor device, memory device(s), communications interfaces, and the like. Additionally or alternatively, one or more DCUs 1214 may be the same or similar as the actuators 2144 of FIG. 21. Furthermore, individual DCUs 1214 are capable of communicating with one or more sensors 1212 and one or more actuators 2144 within the UE 1210.

The sensors 1212 are hardware elements configurable or operable to detect an environment surrounding the vehicles 1210 and/or changes in the environment. The sensors 1212 are configurable or operable to provide various sensor data to the DCUs 1214 and/or one or more AI agents to enable the DCUs 1214 and/or one or more AI agents to control respective control systems of the vehicles 1210. In particular, the IVS 1211 may include or implement a facilities layer and operate one or more facilities within the facilities layer. The sensors 1212 include(s) devices, modules, and/or subsystems whose purpose is to detect events or changes in its environment and send the information (sensor data) about the detected events to some other a device, module, subsystem, and/or the like. Some or all of the sensors 1212 may be the same or similar as the sensor circuitry 2142 of FIG. 21.

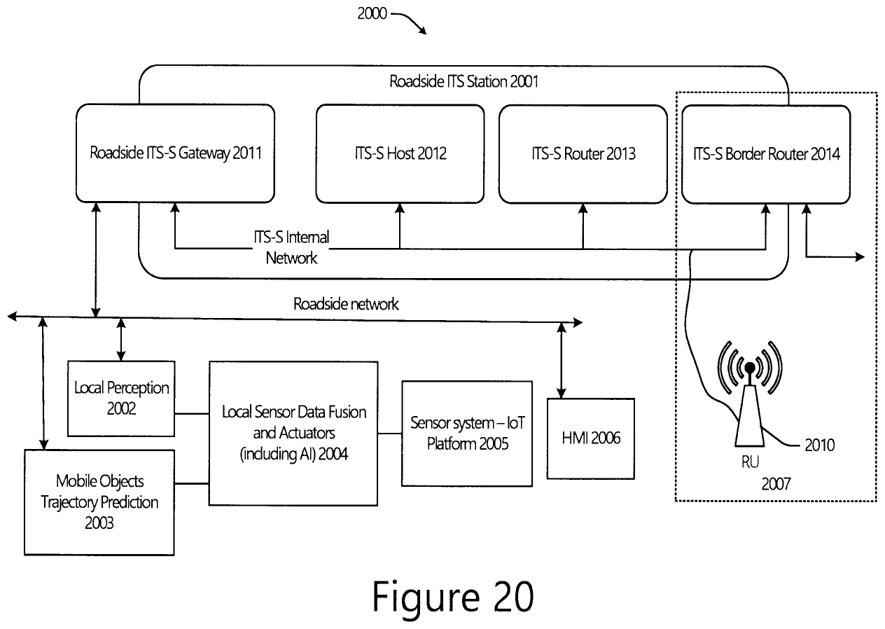

The NAN 1230 is a network element that is part of an access network that provides network connectivity to the UEs 1210 via respective interfaces/links 1220. In V2X scenarios, the NAN 1230 may be or act as an road side unit (RSU) or roadside (R-ITS-S), which refers to any transportation infrastructure entity used for V2X communications. In these scenarios, the NAN 1230 includes an ITS-S that is the same or similar as ITS-S 1213 and/or may be the same or similar as the roadside infrastructure system 2000 of FIG. 20.

The access network may be Radio Access Networks (RANs) such as an NG-RAN or a 5G RAN for a RAN that operates in a 5G/NR cellular network, an E-UTRAN for a RAN that operates in an LTE or 4G cellular network, a legacy RAN such as a UTRAN or GERAN for GSM or CDMA cellular networks, an Access Service Network for WiMAX implementations, and/or the like. All or parts of the RAN may be implemented as one or more RAN functions (RANFs) or other software entities running on server(s) as part of a virtual network, which may be referred to as a cloud RAN (CRAN), Cognitive Radio (CR), a virtual RAN (vRAN), RAN intelligent controller (RIC), and/or the like. The RAN may implement a split architecture wherein one or more communication protocol layers are operated by the RANF or controller and other communication protocol entities are operated by individual NANs 1230. In either implementation, the NAN 1230 can include ground stations (e.g., terrestrial access points) and/or satellite stations to provide network connectivity or coverage within a geographic area (e.g., a cell). The NAN 1230 may be implemented as one or more dedicated physical devices such as a macrocell base stations and/or a low power base station for providing femtocells, picocells, or other like cells having smaller coverage areas, smaller user capacity, or higher bandwidth compared to macrocells.

As alluded to previously, the RATs employed by the NAN 1230 and the UEs 1210 may include any number of V2X RATs may be used for V2X communication, which allow the UEs 1210 to communicate directly with one another, and/or communicate with infrastructure equipment (e.g., NAN 1230). As examples, the V2X RATs can include a WLAN V2X (W-V2X) RAT based on IEEE V2X technologies and a cellular V2X (C-V2X) RAT based on 3GPP technologies.

The C-V2X RAT may be based on any suitable 3GPP standard including any of those mentioned herein. The W-V2X RATs include, for example, IEEE Guide for Wireless Access in Vehicular Environments (WAVE) Architecture, IEEE Std 1609.0-2019, pp. 1-106 (10 Apr. 2019) (“[IEEE16090]”), V2X Communications Message Set Dictionary, SAE Std J2735_202211 (14 Nov. 2022) (“[J2735]”), Intelligent Transport Systems in the 5 GHz frequency band (ITS-G5), the [IEEE80211p] (which is the layer 1 (L1) and layer 2 (L2) part of WAVE, DSRC, and ITS-G5), and sometimes IEEE Standard for Air Interface for Broadband Wireless Access Systems, IEEE Std 802.16-2017, pp. 1-2⁷²⁶ (2 Mar. 2018) (sometimes referred to as “Worldwide Interoperability for Microwave Access” or “WiMAX”) (“[WiMAX]”). The term “DSRC” refers to vehicular communications in the 5.9 GHz frequency band that is generally used in the United States, while “ITS-G5” refers to vehicular communications in the 5.9 GHz frequency band in Europe. Since any number of different RATs are applicable (including [IEEE8021 1p]-based RATs) that may be used in any geographic or political region, the terms “DSRC” (used, among other regions, in the U.S.) and “ITS-G5” (used, among other regions, in Europe) may be used interchangeably throughout this disclosure. The access layer for the ITS-G5 interface is outlined in ETSI EN 302 663 V1.3.1 (2020-01) (“[EN302663]”) and describes the access layer of the ITS-S reference architecture 1300. The ITS-G5 access layer comprises [IEEE80211] (which now incorporates [IEEE80211p]) and/or IEEE/ISO/IEC 8802-2-1998 protocols, as well as features for Decentralized Congestion Control (DCC) methods discussed in ETSI TS 102 687 V1.2.1 (2018-04) (“[TS102687]”). The access layer for 3GPP C-V2X based interface(s) is outlined in, inter alia, ETSI EN 303 613 V1.1.1 (2020-01), 3GPP TS 23.285 v17.0.0 (2022-03-29) (“[TS23285]”); and 3GPP 5G/NR-V2X is outlined in, inter alia, 3GPP TR 23.786 v16.1.0 (2019-06) and 3GPP TS 23.287 v17.2.0 (2021-12-23) (“[TS23287]”).

The NAN 1230 or an edge compute node 1240 may provide one or more services/capabilities 1280. In an example implementation, RSU 1230 is a computing device coupled with radio frequency circuitry located on a roadside that provides connectivity support to passing UEs 1210. The RSU 1230 may also include internal data storage circuitry to store intersection map geometry, traffic statistics, media, as well as apps/software to sense and control ongoing vehicular and pedestrian traffic. The RSU 1230 provides various services/capabilities 1280 such as, for example, very low latency communications required for high speed events, such as crash avoidance, traffic warnings, and the like. Additionally or alternatively, the RSU 1230 may provide other services/capabilities 1280 such as, for example, cellular/WLAN communications services. In some implementations, the components of the RSU 1230 may be packaged in a weatherproof enclosure suitable for outdoor installation, and may include a network interface controller to provide a wired connection (e.g., Ethernet or the like) to a traffic signal controller and/or a backhaul network. Further, RSU 1230 may include wired or wireless interfaces to communicate with other RSUs 1230 (not shown by FIG. 12).

The network 1265 may represent a network such as the Internet, a wireless local area network (WLAN), or a wireless wide area network (WWAN) including proprietary and/or enterprise networks for a company or organization, a cellular core network, a backbone network, an edge computing network, a cloud computing service, a data network, an enterprise network, and/or combinations thereof. As examples, the network 1265 and/or access technologies may include cellular technology (e.g., 3GPP LTE, NR/5G, MuLTEfire, WiMAX, and so forth), WLAN (e.g., WiFi and the like), and/or any other suitable technology such as those discussed herein.

The service provider platform 1290 may represent one or more app servers, a cloud computing service that provides cloud computing services, and/or some other remote infrastructure. The service provider platform 1290 may include any one of a number of services and capabilities 1280 such as, for example, ITS-related apps and services, driving assistance (e.g., mapping/navigation), content (e.g., multi-media infotainment) streaming services, social media services, and/or any other services.

An edge compute node 1240 (or a collection of edge compute nodes 1240 as part of an edge network or “edge cloud”) is colocated with the NAN 1230. The edge compute node 1240 may provide any number of services/capabilities 1280 to UEs 1210, which may be the same or different than the services/capabilities 1280 provided by the service provider platform 1290. For example, the services/capabilities 1280 provided by edge compute node 1240 can include a distributed computing environment for hosting applications and services, and/or providing storage and processing resources so that data and/or content can be processed in close proximity to subscribers (e.g., UEs 1210). The edge compute node 1240 also supports multitenancy run-time and hosting environment(s) for applications, including virtual appliance apps that may be delivered as packaged virtual machine (VM) images, middleware and infrastructure services, cloud-computing capabilities, IT services, content delivery services including content caching, mobile big data analytics, and computational offloading, among others. Computational offloading involves offloading computational tasks, workloads, apps, and/or services to the edge compute node 1240 from the UEs 1210, core network, cloud service, and/or server(s) 1290, or vice versa. For example, a device app or client app operating in a ITS-S 1210 may offload app tasks or workloads to one or more edge servers 1240. In another example, an edge server 1240 may offload app tasks or workloads to one or more UEs 1210 (e.g., for distributed ML computation or the like).

The edge compute node 1240 includes or is part of an edge computing network (or edge cloud) that employs one or more edge computing technologies (ECTs). In one example implementation, the ECT is and/or operates according to the MEC framework, as discussed in ETSI GR MEC 001 v3.1.1 (2022-01), ETSI GS MEC 003 v3.1.1 (2022-03), ETSI GS MEC 009 v3.1.1 (2021-06), ETSI GS MEC 010-1 v1.1.1 (2017-10), ETSI GS MEC 010-2 v2.2.1 (2022-02), ETSI GS MEC 011 v2.2.1 (2020-12), ETSI GS MEC 012 V2.2.1 (2022-02), ETSI GS MEC 013 V2.2.1 (2022-01), ETSI GS MEC 014 v2.1.1 (2021-03), ETSI GS MEC 015 v2.1.1 (2020-06), ETSI GS MEC 016 v2.2.1 (2020-04), ETSI GS MEC 021 v2.2.1 (2022-02), ETSI GR MEC 024 v2.1.1 (2019-11), ETSI GS MEC 028 V2.2.1 (2021-07), ETSI GS MEC 029 v2.2.1 (2022-01), ETSI MEC GS 030 v2.1.1 (2020-04), and ETSI GR MEC 031 v2.1.1 (2020-10) (collectively referred to herein as “[MEC]”), the contents of each of which are hereby incorporated by reference in their entireties.

In another example implementation, the ECT is and/or operates according to the Open RAN alliance (“O-RAN”) framework, as described in O-RAN Architecture Description v07.00, O-RAN ALLIANCE WG1 (October 2022); O-RAN Working Group 2 AI/ML workflow description and requirements v01.03 O-RAN ALLIANCE WG2 (October 2021); O-RAN Working Group 2Non-RT RIC: Functional Architecture v01.01, 0-RAN ALLIANCE WG2 (June 2021); O-RAN Working Group 3 Near-Real-time RAN Intelligent Controller Architecture & E2 General Aspects and Principles v02.02 (July 2022); O-RAN Working Group 3 Near-Real-time Intelligent Controller E2 Service Model (E2SM) v02.01 (March 2022); and/or any other O-RAN standard/specification (collectively referred to as “[O-RAN]”) the contents of each of which are hereby incorporated by reference in their entireties.

In another example implementation, the ECT is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v1.2.0 (2020-12-07) (“[TS23558]”), 3GPP TS 23.501 v17.6.0 (2022-09-22) (“[TS23501]”), 3GPP TS 23.548 v17.4.0 (2022-09-22) (“[TS23548]”), and U.S. application Ser. No. 17/484,719 filed on 24 Sep. 2021 (“['719]”) (collectively referred to as “[SA6Edge]”), the contents of each of which are hereby incorporated by reference in their entireties.

In another example implementation, the ECT is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/(“[ISEO]”), the contents of which is hereby incorporated by reference in its entirety.

In another example implementation, the ECT operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF RFC 9188 (February 2022) (collectively referred to as “[MAMS]”), the contents of each of which are hereby incorporated by reference in their entireties.

Any of the aforementioned example implementations, and/or in any other example implementation discussed herein, may also include one or more virtualization technologies, such as those discussed in ETSI GR NFV 001 V1.3.1 (2021-03); ETSI GS NFV 002 V1.2.1 (2014-12); ETSI GRNFV 003 V1.6.1 (2021-03); ETSI GS NFV 006 V2.1.1 (2021-01); ETSI GS NFV-INF 001 V1.1.1 (2015-01); ETSI GS NFV-INF 003 V1.1.1 (2014-12); ETSI GS NFV-INF 004 V1.1.1 (2015-01); ETSI GS NFV-MAN 001 v1.1.1 (2014-12); Israel et al., OSM Release FIVE Technical Overview, ETSI OPEN SOURCE MANO, OSM White Paper, 1st ed. (January 2019); E2E Network Slicing Architecture, GSMA, Official Doc. NG.127, v1.0 (3 Jun. 2021); Open Network Automation Platform (ONAP) documentation, Release Istanbul, v9.0.1 (17 Feb. 2022); 3GPP Service Based Management Architecture (SBMA) as discussed in 3GPP TS 28.533 v17.1.0 (2021-12-23) (“[TS28533]”); the contents of each of which are hereby incorporated by reference in their entireties.

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge networks/ECTs described herein. Further, the techniques disclosed herein may relate to other IoT ECTs, edge networks, and/or and configurations, and other intermediate processing entities and architectures may also be applicable to the present disclosure. For example, many ECTs and/or edge networking technologies may be applicable to the present disclosure in various combinations and layouts of devices located at the edge of a network. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

### 3. ITS-Station Configurations and Arrangements

FIG. 13 shows an ITS-S reference architecture 1300. Some or all of the components depicted by FIG. 13 follows the ITSC protocol, which is based on the principles of the OSI model for layered communication protocols extended for ITS apps. The ITSC 1300 includes an access layer 1304 that corresponds with the OSI layers 1 and 2, a networking & transport (N&T) layer 1303 that corresponds with OSI layers 3 and 4, the facilities layer which corresponds with OSI layers 5, 6, and at least some functionality of OSI layer 7, and an apps layer 1301 that corresponds with some or all of OSI layer 7. Each of these layers are interconnected via respective observable interfaces, service access points (SAPs), APIs, and/or other like connectors or interfaces (see e.g., ETSI EN 302 665 v1.1.1 (2010-09) and ETSI TS 103 898 (“[TS103898]”)). The interconnections in this example include the MF-SAP, FA-SAP, NF-SAP, and SF-SAP.

The applications layer 1301 provides ITS services, and ITS apps are defined within the app layer 1301. An ITS app is an app layer entity that implements logic for fulfilling one or more ITS use cases. An ITS app makes use of the underlying facilities and communication capacities provided by the ITS-S. Each app can be assigned to one of the three identified app classes: (active) road safety, (cooperative) traffic efficiency, cooperative local services, global internet services, and other apps (see e.g., [EN302663]), ETSI TR 102 638 V1.1.1 (2009-06) (“[TR102638]”); and ETSI TS 102 940 v1.3.1 (2018-04), ETSI TS 102 940 v2.1.1 (2021-07) (collectively “[TS102940]”)). Examples of ITS apps may include driving assistance for cooperative awareness (CA), driving assistance for road hazard warnings (RHW), Automatic Emergency Braking (AEB), Forward Collision Warning (FCW), cooperative adaptive cruise control (CACC), control loss warning (CLW), queue warning, Automated Parking System (APS), pre-crash sensing warning, cooperative Speed Management (CSM) (e.g., curve speed warning and the like), mapping and/or navigation apps (e.g., turn-by-turn navigation and cooperative navigation), cooperative navigation (e.g. platooning and the like), location based services (LBS), community services, ITS-S lifecycle management services, transport related electronic financial transactions, and the like. A V-ITS-S 1210 provides ITS apps to vehicle drivers and/or passengers, and may require an interface for accessing in-vehicle data from the in-vehicle network or in-vehicle system. For deployment and performances needs, specific instances of a V-ITS-S 1210 may contain groupings of Apps and/or Facilities.

The facilities layer 1302 comprises middleware, software connectors, software glue, or the like, comprising multiple facility layer functions (or simply a “facilities”). In particular, the facilities layer contains functionality from the OSI app layer, the OSI presentation layer (e.g., ASN.1 encoding and decoding, and encryption) and the OSI session layer (e.g., inter-host communication). A facility is a component that provides functions, information, and/or services to the apps in the app layer and exchanges data with lower layers for communicating that data with other ITS-Ss. C-ITS facility services can be used by ITS Apps. Examples of these facility services include: Cooperative Awareness (CA) provided by cooperative awareness basic service (CABS) facility (see e.g., [EN302637-2]) to create and maintain awareness of ITS-Ss and to support cooperative performance of vehicles using the road network; Decentralized Environmental Notification (DEN) provided by the DEN basic service (DENBS) facility to alert road users of a detected event using ITS communication technologies; Cooperative Perception (CP) provided by a CP services (CPS) facility 1321 (see e.g., [TS103324]) complementing the CA service to specify how an ITS-S can inform other ITS-Ss about the position, dynamics and attributes of detected neighboring road users and other objects; Multimedia Content Dissemination (MCD) to control the dissemination of information using ITS communication technologies; VRU awareness provided by a VRU basic service (VBS) facility to create and maintain awareness of vulnerable road users participating in the VRU system; Interference Management Zone to support the dynamic band sharing in co-channel and adjacent channel scenarios between ITS stations and other services and apps; Diagnosis, Logging and Status for maintenance and information purposes; Positioning and Time management (PoTi) provided by a PoTi facility 1322 that provides time and position information to ITS apps and services; Decentralized Congestion Control (DCC) facility (DCC-Fac) 1325 contributing to the overall ITS-S congestion control functionalities using various methods at the facilities and apps layer for reducing at the number of generated messages based on the congestion level; Device Data Provider (DDP) 1324 for a V-ITS-S 1210 connected with the in-vehicle network and provides the vehicle state information; Local Dynamic Map (LDM) 1323, which is a local georeferenced database (see e.g., ETSI EN 302 895 v1.1.1 (2014-09) (“[TS302895]”) and [TR102863]); Service Announcement (SA) facility 1327; Signal Phase and Timing Service (SPATS); a Maneuver Coordination Services (MCS) entity; and/or a Multi-Channel Operations (MCO) facility (MCO-Fac) 1328. A list of the common facilities is given by ETSI TS 102 894-1 v1.1.1 (2013-08) (“[TS102894-1]”), which is hereby incorporated by reference in its entirety. The CPS 1321 may exchange information with additional facilities layer entities not shown by FIG. 13 for the purpose of generation, transmission, forwarding, and reception of CPMs 100.

FIG. 13 shows the CPS-specific functionality, including interfaces mapped to the ITS-S architecture 1300 along with the logical interfaces to other layers and entities within the facilities layer 1302. The CPS-specific functionality is centered around the CP Service (CPS) 1321 (also referred to as “CPS Basic Service 1321” or the like) located in the facilities layer. The CPS 1321 interfaces with other entities of the facilities layer 1302 and with ITS apps 1301 to collect relevant information for CPM generation and for forwarding received CPM 100 content for further processing. Collective Perception (CP) is the concept of sharing a perceived environment of an ITS—S based on perception sensors. In contrast to Cooperative Awareness (CA), an ITS-S broadcasts information about its current (e.g., driving) environment rather than about its current state. Hence, CP is the concept of actively exchanging locally perceived objects between different ITS-Ss by means of V2X communication technology (or V2X RAT). CP decreases the ambient uncertainty of ITS-Ss by contributing information to their mutual Field-of-Views. The CPM 100 enables ITS-Ss to share information about objects in the surrounding, which have been detected by sensors, cameras, or other information sources mounted or otherwise accessible to the Tx ITS-S. The CPS differs fundamentally from the CA basic service (see e.g., ETSI EN 302 637-2 V1.4.1 (2019-04) (“[EN302637-2]”)), as it does not focus on Tx data about the current state of the disseminating ITS-S but about its perceived environment. To avoid broadcasting CPMs 100 about the same object by multiple ITS-Ss, the CP service may filter detected objects to be included in CPMs 100 (see e.g., clause 6.1 of [TS103324]).

The CPS 1321 operates according to the CPM protocol, which is an ITS facilities layer protocol for the operation of the CPMs 100 transmission (Tx) and reception (Rx). The CPM 100 is a CP basic service PDU including CPM data and an ITS PDU header. The CPM data comprises a partial or complete CPM payload, and may include the various data containers and associated values/parameters as discussed herein. The CPS Basic Service 1321 consumes data from other services located in the facilities layer, and is linked with others app support facilities. The CPS Basic Service 1321 is responsible for Tx of CPMs 100.

The entities for the collection of data to generate a CPM 100 include the Device Data Provider (DDP) 1324, the PoTi 1322, and the LDM 1323. For subsystems of V-ITS-Ss 1210, the DDP 1324 is connected with the in-vehicle network and provides the vehicle state information. For subsystems of R-ITS-Ss 1230, the DDP 1324 is connected to sensors mounted on the roadside infrastructure such as poles, gantries, gates, signage, and the like.

The LDM 1323 is a database in the ITS-S, which in addition to on-board sensor data may be updated with received CAM and CPM data (see e.g., ETSI TR 102 863 v1.1.1 (2011-06)). ITS apps may retrieve information from the LDM 1323 for further processing. The CPS 1321 may also interface with the Service Announcement (SA) service 1327 to indicate an ITS-S's ability to generate CPMs 100 and to provide details about the communication technology (e.g., RAT) used. Message dissemination-specific information related to the current channel utilization are received by interfacing with the DCC-Fac entity 1325, which provides access network congestion information to the CPS 1321. Additionally or alternatively, message dissemination-specific information can be obtain by interfacing with a multi-channel operation facility (MCO_Fac) (see e.g., ETSI TR 103 439 V2.1.1 (2021-10)).

The PoTi 1322 manages the position and time information for use by ITS apps layer 1301, facility layer 1302, N&T layer 1303, management layer 1305, and security layer 1306. The position and time information may be the position and time at the ITS-S. For this purpose, the PoTi 1322 gets information from sub-system entities such as GNSS, sensors and other subsystem of the ITS-S. The PoTi 1322 ensures ITS time synchronicity between ITS-Ss in an ITS constellation, maintains the data quality (e.g., by monitoring time deviation), and manages updates of the position (e.g., kinematic and attitude state) and time. An ITS constellation is a group of ITS-S's that are exchanging ITS data among themselves. The PoTi entity 1322 may include augmentation services to improve the position and time accuracy, integrity, and reliability. Among these methods, communication technologies may be used to provide positioning assistance from mobile to mobile ITS-Ss and infrastructure to mobile ITS-Ss. Given the ITS app requirements in terms of position and time accuracy, PoTi 1322 may use augmentation services to improve the position and time accuracy. Various augmentation methods may be applied. PoTi 1322 may support these augmentation services by providing messages services broadcasting augmentation data. For instance, an R-ITS-S 1230 may broadcast correction information for GNSS to oncoming V-ITS-S 1210; ITS-Ss may exchange raw GPS data or may exchange terrestrial radio position and time relevant information. PoTi 1322 maintains and provides the position and time reference information according to the app and facility and other layer service requirements in the ITS-S. In the context of ITS, the “position” includes attitude and movement parameters including velocity, heading, horizontal speed and optionally others. The kinematic and attitude state of a rigid body contained in the ITS-S included position, velocity, acceleration, orientation, angular velocity, and possible other motion related information. The position information at a specific moment in time is referred to as the kinematic and attitude state including time, of the rigid body. In addition to the kinematic and attitude state, PoTi 1322 should also maintain information on the confidence of the kinematic and attitude state variables

The CPS 1321 interfaces through the Network—Transport/Facilities (NF)-Service Access Point (SAP) with the N&T layer 1303 for exchanging of CPMs 100 with other ITS-Ss. The CPS interfaces through the Security—Facilities (SF)-SAP with the Security entity to access security services for CPM 100 Tx and CPM 100 Rx. The CPS interfaces through the Management-Facilities (MF)-SAP with the Management entity and through the Facilities—Application (FA)-SAP with the app layer if received CPM data is provided directly to the apps. Each of the aforementioned interfaces/SAPs may provide the full duplex exchange of data with the facilities layer, and may implement suitable APIs to enable communication between the various entities/elements.

The CPS 1321 resides or operates in the facilities layer 1302, generates CPS rules, checks related services/messages to coordinate transmission of CPMs 100 with other ITS service messages generated by other facilities and/or other entities within the ITS-S, which are then passed to the N&T layer 1303 and access layers 1304 for transmission to other proximate ITS-Ss. The CPMs 100 are included in ITS packets, which are facilities layer PDUs that are passed to the access layer 1304 via the N&T layer 1303 or passed to the app layer 1301 for consumption by one or more ITS apps. In this way, the CPM format is agnostic to the underlying access layer 1304 and is designed to allow CPMs 100 to be shared regardless of the underlying access technology/RAT.

Each of the aforementioned interfaces/Service Access Points (SAPs) may provide the full duplex exchange of data with the facilities layer, and may implement suitable APIs to enable communication between the various entities/elements.

For a V-ITS-S 1210, the facilities layer 1302 is connected to an in-vehicle network via an in-vehicle data gateway as shown and described infra. The facilities and apps of a V-ITS-S 1210 receive required in-vehicle data from the data gateway in order to construct ITS messages (e.g., CSMs, VAMs, CAMs, DENMs, MCMs, and/or CPMs 100) and for app usage. FIG. 14 shows and describes the functionality for sending and receiving CPMs 100.

As alluded to previously, CP involves ITS-Ss sharing information about their current environments with one another. An ITS-S participating in CP broadcasts information about its current (e.g., driving) environment rather than about itself. For this purpose, CP involves different ITS-Ss actively exchanging locally perceived objects (e.g., other road participants and VRUs 1216, obstacles, and the like) detected by local perception sensors by means of one or more V2X RATs. In some implementations, CP includes a perception chain that can be the fusion of results of several perception functions at predefined times. These perception functions may include local perception and remote perception functions. The local perception is provided by the collection of information from the environment of the considered ITS element (e.g., VRU device, vehicle, infrastructure, and/or the like). This information collection is achieved using relevant sensors (optical camera, thermal camera, radar, LIDAR, and/or the like). The remote perception is provided by the provision of perception data via C-ITS (mainly V2X communication). CPS 1321 can be used to transfer a remote perception. Several perception sources may then be used to achieve the cooperative perception function. The consistency of these sources may be verified at predefined instants, and if not consistent, the CPS 1321 may select the best one according to the confidence level associated with each perception variable. The result of the CP should comply with the required level of accuracy as specified by PoTi. The associated confidence level may be necessary to build the CP resulting from the fusion in case of differences between the local perception and the remote perception. It may also be necessary for the exploitation by other functions (e.g., risk analysis) of the CP result. The perception functions from the device local sensors processing to the end result at the cooperative perception level may present a significant latency time of several hundred milliseconds. For the characterization of a VRU trajectory and its velocity evolution, there is a need for a certain number of the vehicle position measurements and velocity measurements thus increasing the overall latency time of the perception. Consequently, it is necessary to estimate the overall latency time of this function to take it into account when selecting a collision avoidance strategy.

Additionally or alternatively, existing infrastructure services, such as those described herein, can be used in the context of the CPS 1321. For example, the broadcast of the SPAT and SPAT relevance delimited area (MAP) is already standardized and used by vehicles at intersection level. In principle they protect VRUs 1216 crossing. However, signal violation warnings may exist and can be detected and signaled using DENM. This signal violation indication using DENMs is very relevant to VRU devices 1210v as indicating an increase of the collision risk with the vehicle which violates the signal. If it uses local captors or detects and analyses VAMs, the traffic light controller may delay the red phase change to green and allow the VRU 1216, 1210v to safely terminate its road crossing. The contextual speed limit using In-Vehicle Information (IVI) can be adapted when a large cluster of VRUs 1216 is detected (e.g., limiting the vehicles' speed to 30 km/hour). At such reduced speed a vehicle 1210 may act efficiently when perceiving the VRUs by means of its own local perception system.

Referring back to FIG. 13, the N&T layer 1303 provides functionality of the OSI network layer and the OSI transport layer and includes one or more networking protocols, one or more transport protocols, and network and transport layer management. Each of the networking protocols may be connected to a corresponding transport protocol. Additionally, sensor interfaces and communication interfaces may be part of the N&T layer 1303 and access layer 1304. Examples of the networking protocols include IPv4, IPv6, IPv6 networking with mobility support, IPv6 over GeoNetworking, CALM, CALM FAST, FNTP, and/or some other suitable network protocol such as those discussed herein. Examples of the transport protocols include BOSH, BTP, GRE, GeoNetworking protocol, MPTCP, MPUDP, QUIC, RSVP, SCTP, TCP, UDP, VPN, one or more dedicated ITSC transport protocols, and/or some other suitable transport protocol such as those discussed herein.

The access layer includes a physical layer (PHY) 1304 connecting physically to the communication medium, a data link layer (DLL), which may be sub-divided into a medium access control sub-layer (MAC) managing the access to the communication medium, and a logical link control sub-layer (LLC), management adaptation entity (MAE) to directly manage the PHY 1304 and DLL, and a security adaptation entity (SAE) to provide security services for the access layer 1304. The access layer 1304 may also include external communication interfaces (CIs) and internal CIs. The CIs are instantiations of a specific access layer technology or RAT and protocol such as 3GPP LTE, 3GPP 5G/NR, C-V2X (e.g., based on 3GPP LTE and/or 5G/NR), WiFi, W-V2X (e.g., including ITS-G5 and/or DSRC), DSL, Ethernet, Bluetooth, and/or any other RAT and/or communication protocols discussed herein, or combinations thereof. The CIs provide the functionality of one or more logical channels (LCHs), where the mapping of LCHs on to physical channels is specified by the standard of the particular access technology involved. As alluded to previously, the V2X RATs may include ITS-G5/DSRC and 3GPP C-V2X. Additionally or alternatively, other access layer technologies (V2X RATs) may be used in various other implementations.

The management entity 1305 is in charge of managing communications in the ITS-S including, for example, cross-interface management, Inter-unit management communications (IUMC), networking management, communications service management, ITS app management, station management, management of general congestion control, management of service advertisement, management of legacy system protection, managing access to a common Management Information Base (MIB), and so forth.

The security entity 1306 provides security services to the OSI communication protocol stack, to the security entity and to the management entity 1305. The security entity 1306 contains security functionality related to the ITSC communication protocol stack, the ITS station and ITS apps such as, for example, firewall and intrusion management; authentication, authorization and profile management; identity, crypto key and certificate management; a common security information base (SIB); hardware security modules (HSM); and so forth. The security entity 1306 can also be considered as a specific part of the management entity 1305.

In some implementations, the security entity 1306 includes a security services layer/entity 1361 (see e.g., [TS102940]). Examples of the security services provided by the security services entity in the security entity 1306 are discussed in Table 3 in [TS102940]. In FIG. 13, the security entity 1306 is shown as a vertical layer adjacent to each of the ITS. In some implementations, security services are provided by the security entity 1306 on a layer-by-layer basis so that the security layer 1306 can be considered to be subdivided into the four basic ITS processing layers (e.g., one for each of the apps, facilities, N&T, and access layers). Security services are provided on a layer-by-layer basis, in the manner that each of the security services operates within one or several ITS architectural layers, or within the security management layer/entity 1362. Besides these security processing services, which provide secure communications between ITS stations, the security entity 1306 in the ITS-S architecture 1300 can include two additional sub-parts: security management services layer/entity 1362 and security defense layer/entity 1363.

The security defense layer 1363 prevents direct attacks against critical system assets and data and increases the likelihood of the attacker being detected. The security defense layer 1363 can include mechanisms such as intrusion detection and prevention (IDS/IPS), firewall activities, and intrusion response mechanisms. The security defense layer 1363 can also include misbehavior detection (MD) functionality, which performs plausibility checks on the security elements, processing of incoming V2X messages including the various MD functionality discussed herein. The MD functionality performs misbehavior detection on CAMs, DENMs, CPMs, and/or other ITS-S/V2X messages.

The ITS-S reference architecture 1300 may be applicable to the elements of FIGS. 18 and 20. The ITS-S gateway 1811, 2011 (see e.g., FIGS. 18 and 20) interconnects, at the facilities layer, an OSI protocol stack at OSI layers 5 to 7. The OSI protocol stack is typically is connected to the system (e.g., vehicle system or roadside system) network, and the ITSC protocol stack is connected to the ITS station-internal network. The ITS-S gateway 1811, 2011 (see e.g., FIGS. 18 and 20) is capable of converting protocols. This allows an ITS-S to communicate with external elements of the system in which it is implemented. The ITS-S router 1811, 2011 provides the functionality the ITS-S reference architecture 1300 excluding the Apps and Facilities layers. The ITS-S router 1811, 2011 interconnects two different ITS protocol stacks at layer 3. The ITS-S router 1811, 2011 may be capable to convert protocols. One of these protocol stacks typically is connected to the ITS station-internal network. The ITS-S border router 2014 (see e.g., FIG. 20) provides the same functionality as the ITS-S router 1811, 2011, but includes a protocol stack related to an external network that may not follow the management and security principles of ITS (e.g., the mgmnt layer 1305 and security layer 1306 in FIG. 13).

Additionally, other entities that operate at the same level but are not included in the ITS-S include the relevant users at that level, the relevant HMI (e.g., audio devices, display/touchscreen devices, and/or the like); when the ITS-S is a vehicle, vehicle motion control for computer-assisted and/or automated vehicles (e.g., both HMI and vehicle motion control entities may be triggered by the ITS-S apps); a local device sensor system and IoT Platform that collects and shares IoT data; local device sensor fusion and actuator app(s), which may contain ML/AI and aggregates the data flow issued by the sensor system; local perception and trajectory prediction apps that consume the output of the fusion app and feed the ITS-S apps; and the relevant ITS-S. The sensor system can include one or more cameras, radars, LIDARs, and/or the like, in a V-ITS-S 1210 or R-ITS-S 1230. In the central station, the sensor system includes sensors that may be located on the side of the road, but directly report their data to the central station, without the involvement of a V-ITS-S 1210 or R-ITS-S 1230. In some cases, the sensor system may additionally include gyroscope(s), accelerometer(s), and the like (see e.g., sensor circuitry 2142 of FIG. 21). These elements are discussed in more detail infra w.r.t FIGS. 18, 19, and 20.

FIG. 14 shows an example CPS service functional architecture 1400 including various functional entities of the CPS 1421 and interfaces to other facilities and other ITS layers. The CPS 1421 may correspond to the CPS 1321 of FIG. 13. For sending and receiving CPMs 100, the CPS includes a CPM transmission management function (CPM TxM) 1403, CPM reception management function (CPM RxM) 1404, an encode CPM function (E-CPM) 1405, and a decode CPM function (D-CPM) 1406. The E-CPM 1405 constructs CPMs 100 as discussed herein and/or according to the format specified in Annex A of [TS103324].

The CPM RxM 1404 implements the protocol operation of the receiving (Rx) ITS-S 1300 such as, for example, triggering the decoding of CPMs 100 upon receiving incoming CPMs 100; provisioning of the received CPMs 100 to the LDM 1323 and/or ITS apps 1301 of the Rx ITS-S 1300; and/or checking the validity of the information of the received CPMs 100 (see e.g., ETSI TR 103 460 V2.1.1 (2020-10) (“[TR103460]”)). The D-CPM 1406 decodes received CPMs 100.

The E-CPM 1405 generates individual CPMs 100 for dissemination (e.g., transmission to other ITS-Ss). The E-CPM 1405 generates and/or encodes individual CPMs 100 to include the most recent abstract CP object information, sensor information, free space information, and/or perceived region data. The CPM TxM 1403 implements the protocol operation of the originating (Tx) ITS-S 1300 such as, for example, activation and termination of CPM Tx operation; determination of CPM 100 generation frequency; and triggering the generation of CPMs 100. In some implementations, the CPS 1421 activation may vary for different types of ITS-S (e.g., V-ITS-S 1210, 1801; R-ITS-S 1230, 2001; P-ITS-S 1210v, 1901; and central ITS-S 1240, 1290). As long as the CPS 1421 is active, CPM 100 generation is managed by the CPS 1421. For compliant V-ITS-Ss 1210, the CPS 1421 is activated with the ITS-S 1300 activation function, and the CPS 1421 is terminated when the ITS-S 1300 is deactivated. For compliant R-ITS-Ss 1230, the CPS 1421 may be activated and de-activated through remote configuration. The activation and deactivation of the CPS 1421 other than the V-ITS-Ss 1210 and R-ITS-Ss 1230 can be implementation specific.

Interfaces of the CPS 1421 include a management layer interface (IF.Mng), a security layer interface (IF.Sec), an N&T layer interface (IF.N&T), a facilities layer interface (IF.FAC), an MCO layer interface (IF.MCO, and an app layer/CPM interface (IF.CPM).

The IF.CPM is an interface between the CPS 1421 and the LDM 1323 and/or the ITS app layer 1301. The IF.CPM is provided by the CPS 1421 for the provision of received data.

The IF.FAC is an interface between the CPS 1421 and other facilities layer entities (e.g., data provisioning facilities). For the generation of CPMs 100, the CPS 1421 interacts with other facilities layer entities to obtain the required data. This set of other facilities is referred to as data provisioning facilities (e.g., the ITS-S's PoTi 1322, DDP 1324, and/or LDM 1323). Data is exchanged between the data provisioning facilities and the CPS 1421 via the IF.FAC.

If MCO is supported, the CPS 1421 exchanges information with the MCO_FAC 1328 via the IF.MCO (see e.g., ETSI TR 103 439 V2.1.1 (2021-10) and/or ETSI TS 103 141 (collectively “[etsiMCO]”)). This interface can be used to configure the default MCO settings for the generated CPMs and can also be used to configure the MCO parameters on a per message basis (see e.g., [etsiMCO]). If MCO_FAC is used, the CPS 1421 provides the CPM 100 embedded in a facility layer 1302 service data unit (FL-SDU) together with protocol control information (PCI) according to ETSI EN 302 636-5-1 V2.1.0 (2017-05) (“[EN302636-5-1]”) to the MCO_FAC. In addition, it can also provide MCO control information (MCI) following [etsiMCO] to configure the MCO parameters of the CPM 100 being provided.

At the receiving ITS-S, the MCO_FAC passes the received CPM to the CPS, if available.

The data set that is passed between CPS 1421 and the MCO_FAC 1328 for the originating and receiving ITS-S is as follows: according to Annex A of [TS103324] when the data set is a CPM 100; depending on the protocol stack applied in the N&T 1303 as specified in [TS103324], clause 5.3.5 when the data set is PCI; and MCO parameters configuration (may be needed if the default MCO parameters have not been configured or want to be overwritten for a specific CPM 100) when the data set is MCI.

If MCO is not supported, the CPS exchanges information with the N&T 1303 via the IF.N&T. The IF.N&T is an interface between the CPS 1421 and the N&T 1303 (see e.g., ETSI TS 102 723-11 V1.1.1 (2013-11)). At the originating ITS-S, the CPS 1421 provides the CPM 100 embedded in a FL-SDU together with protocol control information (PCI) according to [EN302636-5-1] to the ITS N&T 1303. At the receiving ITS-S, the N&T 1303 passes the received CPM 100 to the CPS 1421, if available. The data set that is passed between the CPS 1421 and the N&T 1303 for the originating and receiving ITS-Ss is as follows: according to Annex A of [TS103324] when the data set is a CPM 100; and depending on the protocol stack applied in the N&T 1303 as specified in [TS103324], clause 5.3.5 when the data set is PCI.

The interface between the CPS 1421 and the N&T 1303 relies on the services of the GeoNetworking/BTP stack as specified in [TS103324], clause 5.3.5.1 or on the IPv6 stack and the combined IPv6/GeoNetworking stack as specified in [TS103324], clause 5.3.5.2. If the GeoNetworking/BTP stack is used, the GN packet transport type single-hop broadcasting (SHB) is used. In this scenario, ITS-Ss located within direct communication range may receive the CPM 100. If GeoNetworking is used as the network layer protocol, then the PCI being passed from the CPS 1421 to the GeoNetworking/BTP stack (directly or indirectly through the MCO_FAC 1328 when MCO is supported) complies with [EN302636-5-1] and/or ETSI TS 103 836-4-1 (see e.g., [TS103324], clause 5.3.5).

The CPS 1421 may use the IPv6 stack or the combined IPv6/GeoNetworking stack for CPM dissemination as specified in ETSI TS 103 836-3. If IP based transport is used to transfer the facility layer CPM between interconnected actors, security constraints as outlined in [TS103324], clause 6.2 may not be applicable. In this case trust among the participating actors, e.g. using mutual authentication, and authenticity of information can be based on other standard IT security methods, such as IPSec, DTLS, TLS or other VPN solutions that provide an end-to-end secure communication path between known actors. Security methods, sharing methods and other transport related information, such as messaging queuing protocols, transport layer protocol, ports to use, and the like, can be agreed among interconnected actors. When the CPM dissemination makes use of the combined IPv6/GeoNetworking stack, the interface between the CPS 1421 and the combined IPv6/GeoNetworking stack may be the same or similar to the interface between the CPS 1421 and IPv6 stack.

The IF.Mng is an interface between the CPS 1421 and the ITS management entity 1305. The CPS of an originating ITS-S gets information for setting the T_GenCpm variable from the management entity defined in [TS103324], clause 6.1.2.2 via the IF.Mng. A list of primitives exchanged with the management layer are provided in ETSI TS 102 723-5.

The IF.Sec is an interface between the CPS 1421 and the ITS security entity 1306. The CPS 1421 may exchange primitives with the Security entity of the ITS-S(see e.g., FIG. 13) using the IF.Sec provided by the security entity 1306. In case the facility layer security is used, for ITS-Ss that use the trust model according to [TS102940] and ITS certificates according to ETSI TS 103 097 v2.1.1 (2021-10) (“[TS103097]”) and that are of type [Itss_WithPrivacy] as defined in [TS102940], the CPS 1421 interacts with the ID management functionality of the security entity 1306 to set the actual value of the ITS-S ID in the CPM 100. When the Security entity is triggering a pseudonym change, it shall change the value of the ITS-ID accordingly and shall not send CPMs 100 with the previous ID anymore.

Due to priority mechanisms such as DCC 1325 and/or 1328 at facilities 1302 or lower layers (e.g., N&T 1303, access layer 1304, and the like), the sending ITS-S may apply reordering of the messages contained in its buffer. Queued messages which are identified with the old ITS-ID are discarded as soon as a message with the new ITS-ID is sent. Whether or not messages previously queued prior to an ID change event get transmitted or not is implementation-specific. Additionally or alternatively, ITS-Ss of type [Itss_NoPrivacy] as defined in [TS102940] and ITS-Ss that do not use the trust model according to [TS102940] and ITS certificates according to [TS103097] do not need to implement functionality that changes ITS-S IDs (e.g., pseudonyms). In order to avoid similarities between successive CPMs 100, all detected objects is reported as newly detected objects in the CPM 100 following a pseudonym change. Additionally, the SensorInformationContainer may be omitted for a certain time around a pseudonym change.

FIGS. 15 and 16 depict CPM generation management functional architectures 1500 and 1600, respectively. In particular, FIG. 15 shows a CPM generation management architecture 1500 for single channel operation and FIG. 16 shows a CPM generation management architecture 1600 for MCO. In some examples, the CPM generation management functions 1500 and 1600 of FIGS. 15 and 16 may be part of the CPM TxM 1403 in the CPS 1421, or may be part of the E-CPM 1405 (not shown by FIGS. 15 and 16). In other examples, the CPM generation management functions 1500 and 1600 may be standalone functions in the CPS 1421 that is/are separate from the CPM TxM 1403, CPM RxM 1404, E-CPM 1405, and D-CPM 1406. Additionally, the CPM generation management functions 1500 and 1600 include various management functions 1501, 1502, 1503, 1504, 1505, 1506 arranged in the manner shown by FIGS. 15 and 16. However, the depicted arrangement is only one possible example implementation, and the arrangement or configuration of the management functions 1501, 1502, 1503, 1504, 1505, 1506 can be different than shown by FIGS. 15 and 16, and may vary depending on use case, implementation, and/or other conditions, criteria, and/or parameters. It should also be noted that, although the inclusion rules 1521 and redundancy control 1522 are shown as being part of the CPM configuration 1550, in other implementations, each inclusion management function 1502, 1503, 1504, 1505, 1506 can include their own inclusion rules 1521 and redundancy control 1522 elements/entities.

In both architectures 1500 and 1600, CPMs 100 are generated during periodic CPM generation events. A CPM generation frequency and content management function 1501 triggers a CPM generation event. For purposes of the present disclosure, the term “GenCpm” may refer to a CPM generation event, or the term “T_GenCpm” may refer to both the CPM generation event periodicity and/or the CPM generation event itself. Additionally or alternatively, or) according to a predetermined or configured CPM generation frequency. In one example, a CPM configuration 1550 specified the CPM generation frequency, as well as privacy policies/parameters, channel configuration data, and/or other parameters, conditions, or criteria for generating and/or transmitting CPMs 100. The time elapsed between the triggering of consecutive CPM generation events is equal to T_GenCpm. In some implementations, T_GenCpm is limited to T_GenCpmMin≤T_GenCpm≤T_GenCpmMax, wherein T_GenCpmMin is a minimum T_GenCpm threshold or limit (e.g., T_GenCpmMin=50 ms or 100 ms) and T_GenCpmMax is a maximum T_GenCpm threshold or limit (e.g., T_GenCpmMax=1000 ms). During each generation event GenCpm, the inclusion of the PerceivedObject, the SensorInformationContainer, and FreeSpaceAddendumContainer are determined as defined in [TS103324]. The generated CPMs 100 may be segmented or generated as CPM segments based on, for example, the data size and/or other parameters, conditions, or criteria. The inclusion management aspects in the following description apply to a single unsegmented CPM 100; however, these aspects can be straightforwardly applied to multiple CPMs 100 and/or segmented CPMs 100.

In some implementations, the T_GenCpm can be set based on feedback from lower layers (e.g., N&T 1303, access layer 1304, and the like). For example, if MCO is supported, T_GenCpm and the number of perceived objects included in each CPM 100 is managed to satisfy the limits provided by MCO_FAC 1328 (see e.g., [etsiMCO]) and/or following the process described in clause 6.1.2 of [TS103324].

In some implementations, the Tx ITS-S 1300 can indicate the planned message rate range using an intendedMessageRate value of type MessageRateConfig. In these implementations, the sender (e.g., Rx ITS-S 1300) estimates its expected minimum for the time between two CPM generation events (e.g., T_GenCpmEstMin) and the expected maximum for the time between two CPM generation events (e.g., T_GenCpmEstMax). To fulfil the limits set by relevant standards and/or relevant profiles, T_GenCpmEstMin≥T_GenCpmMin, and T_GenCpmEstMax≤T_GenCpmMax. Additionally or alternatively, the current and expected T_GenCpm fulfils T_GenCpmEstMin≤T_GenCpm≤T_GenCpmEstMax. The intendedMessageRate is then set as (minRate,maxRate), where minRate is the largest value with minRate≤1/T_GenCpmEstMax and maxRate is the smallest value with maxRate≥1/T_GenCpmEstMin.

An SIC inclusion management function 1502 causes a CPM 100 to include information about sensor information of the Tx ITS-S 1300 by adding the SensorInformationContainer to the CPM 100. The CPM 100 generated as part of a CPM generation event generally includes a SensorInformationContainer whenever the time elapsed since the last time a CPM 100 included a SensorInformationContainer is equal or greater than T_AddSensorInformation (e.g., T_AddSensorInformation=1000 ms). Here, T_AddSensorInformation is maximum (threshold) time elapsed between consecutive inclusion of SensorInformationContainer in the CPM 100. For privacy reasons, the SensorInformationContainer may be omitted for a time longer than T_AddSensorInformation if, for example, a pseudonym change is performed and/or the omission is not assessed as safety-critical by the Tx ITS-S 1300 given its perceived traffic environment. Additionally or alternatively, the inclusion rules 1521 and/or the redundancy control mechanisms 1522 may define or specify various parameters, conditions, and/or criteria for including the SIC in a CPM 100.

An FSAC inclusion management function 1503 causes the CPM 100 to include a free space addendum (FSA) by adding the FSAC. The operation of the FSAC inclusion management function 1503 is based on the profile configuration (e.g., CPM configuration 1550). For example, if the profile UseFreeSpaceInclusionRules is set to “false”, all or a subset of the known free spaces are included in the FSAC; otherwise, the following FSAC (or PRC) inclusion rules 1521 apply.

Confirmed free space may be indicated as part of the SensorInformationContainer in a CPM 100. The combination of the free space indication (e.g., FreeSpaceConfidence DE in the SensorInformationContainer) and described objects are combined to derive the free space by using tracing and shadowing approaches (see e.g., [TS103324]). The FSAC together with the corresponding FSA DFs may be added whenever a free space area as would be computed on the Rx ITS-S using the tracing approach does not reflect the detected free space of the ITS-S generating the CPM 100. Additionally or alternatively, if the CostmapContainer is included in the CPM 100, costmap grid/cell values are also considered to derive the free space as described in herein and/or in [TS103324].

In case of static information (e.g., permanently shadowed regions and/or the like), the FSAC is added whenever the SensorInformationContainer is added to the currently generated CPM 100. If a free space area falls inside a reported costmap grid/cell in an LCM and/or in the CostmapContainer, it is up to ITS-S implementation to include or not include a FreeSpaceAddendum DF to the FreeSpaceAddendumContainer for that free space area and/or based on the CPM reporting mechanisms discussed herein.

A CPM 100 generated as part of a CPM generation event may include additional information about monitored free space areas known to the Tx ITS-S by adding a FreeSpaceAddendum DF to the freeSpaceAddendumContainer. A particular FreeSpaceAddendum is added to the CPM 100 if the tracing approach to compute free space areas on an Rx ITS-S does not match the representation of the detected free space on the Tx ITS-S.

In case the particular FreeSpaceAddendum DF employs the AreaPolygon DF, a first or consecutive FreeSpaceAddendum DF is added to the current CPM 100 if the Euclidean relative distance of any OffsetPoint of the polygon relative to the corresponding OffsetPoint of this polygon lastly included in a CPM 100 exceeds a predefined or configured threshold, such as minOffsetPointPositionChangeThreshold and/or if the number of OffsetPoints to describe the polygon changes. The minOffsetPointPositionChangeThreshold is a minimum (e.g., threshold) change in Euclidean relative distance of any OffsetPoint of the polygon describing polygon free space area and the corresponding OffsetPoint of this polygon lastly included in a CPM 100 in order to add a FreeSpaceAddendum DF in the current CPM 100 corresponding to this polygon free space area. This restricts inclusion of FreeSpaceAddendum DF in CPM for a free space area too frequently. In some examples, the minOffsetPointPositionChangeThreshold=4m.

In case the particular FreeSpaceAddendum DF employs the AreaCircular DF, AreaEllipse DF or AreaRectangle DF, a first or consecutive FreeSpaceAddendum DF is added to the current CPM 100 if the difference between the current Euclidian distance of the NodeCenterPoint of the described free space area and the Euclidian distance of the NodeCenterPoint of the same described free space area and lastly included in a CPM 100 exceeds a predefined or configured threshold, such as minNodeCenterPointPositionChangeThreshold. The minNodeCenterPointPositionChangeThreshold is a minimum change in Euclidian distance of the NodeCenterPoint of the described circular or ellipse free space area and the Euclidian distance of the NodeCenterPoint of the same described free space area lastly included in a CPM 100 in order to add aFreeSpaceAddendum DF in the current CPM 100 corresponding to this circular or ellipse free space area. This restricts inclusion of FreeSpaceAddendum DF in CPM 100 for a free space area too frequently. In some examples, the minNodeCenterPointPositionChangeThreshold=4m.

Additionally or alternatively, a first or consecutive FreeSpaceAddendum DF is added to the current CPM 100 if the difference between the current Radius or SemiRangeLength of the described free space area and the Radius or SemiRangeLength of the same described free space area lastly included in a CPM 100 exceeds a predefined or configured threshold, such as minRadiusOrSemiRangeLengthChangeThreshold. The minRadiusOrSemiRangeLengthChangeThreshold is a minimum change in Radius or SemiRangeLength of the described free space area and the Radius or SemiRangeLength of the same described free space area lastly included in a CPM 100 in order to add a FreeSpaceAddendum DF in the current CPM 100 corresponding to this free space area. This restricts inclusion of FreeSpaceAddendum DF in CPMs 100 for a free space area too frequently. In some examples, the minRadiusOrSemiRangeLengthChangeThreshold is 4m.

Additionally or alternatively, a first or consecutive FreeSpaceAddendum DF is added to the current CPM 100 if the difference between the current semiMajorRangeOrientation of the described free space area and the semiMajorRangeOrientation of the same described free space area lastly included in a CPM 100 exceeds a predefined or configured threshold, such as minSemiMajorRangeOrientationChangeThreshold. The semiMajorRangeOrientation is a minimum change in the current semiMajorRangeOrientation of the described free space area and the semiMajorRangeOrientation of the same described free space area lastly included in a CPM 100 in order to add a FreeSpaceAddendum DF in the current CPM 100 corresponding to this free space area. This restricts inclusion of FreeSpaceAddendum DF in CPMs 100 for a free space area too frequently. In some examples, the minSemiMajorRangeOrientationChangeThreshold=4 degrees.

In some implementations, the FSAC inclusion management function 1503 can be referred to as (or replaced with) a perceived region container (PRC) inclusion management function (also referred to as “PRC inclusion management function 1503” or the like) to include a PRC in addition to, or instead of, the FSAC. The operation of the PRC inclusion management function 1503 is based on the profile configuration (e.g., CPM configuration 1550). For example, if the profile UsePerceivedRegionInclusionRules is set to “false”, all or a subset of the known perceived regions may be included into the PerceivedRegionContainer; otherwise, the following inclusion rules 1521 apply: In case of static information with respect to the Tx ITS-S, such as a permanently shadowed region, the corresponding PerceivedRegion DFs is added to the PerceivedRegionContainer whenever the SensorInformationContainer is added to the currently generated CPM 100. A PerceivedRegion DF is added to the CPM 100 if its free space confidence does not match the free space confidence obtained by the simple tracing approach (see e.g., [TS103324]) in this perceived region on a Rx ITS-S, using the SensorInformation and PerceivedRegion DFs already included in the CPM 100. Additionally, the various aspects of the FSAC inclusion management function 1503 discussed previously are also applicable to the PRC inclusion management function 1503 (e.g., where objects and/or data structures including the term “Free Space Addendum” can be replaced with the term “Perceived Region”).

A POC inclusion management function 1504 causes a CPM 100 to include information about perceived objects currently known to the Tx ITS-S 1300 by adding the PerceivedObject DF to the perceivedObjectContainer. The operation of the POC inclusion management function 1504 is based on the profile configuration (e.g., CPM configuration 1550). For example, if the profile UseObjectInclusionRules is set to “false”, all or a subset of the known objects is included in the POC; otherwise, some or all of the following POC inclusion rules 1521 apply.

The POC inclusion rules 1521 are different for different types of objects. In some examples, two types of objects are defined including type-A objects and type-B objects. Type-A objects are objects of class vruSubclass with a profile pedestrian, bicyclistAndlightVruVehicle or animal or class groupSubclass or otherSubclass. Type-B objects are objects of any other class (e.g., objects of class vehicleSubclass, or vruSubclass with a profile motorcyclist).

An object with sufficient object existence confidence is selected for transmission from the object list as a result of the current CPM generation event if the object complies with any of the following conditions: If the assigned object class of highest object existence confidence is of Type-B and (a) the object has first been detected by the perception system after the last CPM generation event; (b) the Euclidian distance between the current estimated position of the reference point of the object and the estimated position of the reference point of this object lastly included in a CPM 100 meets or exceeds minReferencePointPositionChangeThreshold; (c) the difference between the current estimated ground speed of the reference point of the object and the estimated absolute speed of the reference point of this object lastly included in a CPM 100 exceeds minGroundSpeedChangeThreshold (e.g., 0.5 ms); (d) the orientation of the estimated object's ground velocity, at its reference point, has changed by at least a minGroundVelocityOrientationChangeThreshold (e.g., 4 degrees) since the last inclusion of the object in a CPM 100; and/or (e) the time elapsed since the last time the object was included in a CPM 100 exceeds T_GenCpmMax. If the assigned object class of highest object existence confidence is of Type-A and (a) the object has first been detected by the perception system after the last CPM generation event; and/or (b) if the object list contains at least one object of Type-A which has not been included in a CPM 100 within a predefined or configurable amount of time (e.g., in the past 500 ms), all objects of Type-A should be included in the currently generated CPM 100. Any of the aforementioned thresholds may be predefined or configured.

The minReferencePointPositionChangeThreshold is a minimum (e.g., threshold amount) of change in Euclidian absolute distance between the current estimated position of the reference point of the object and the estimated position of the reference point of this object lastly included in a CPM 100 in order to select the object for transmission in the current CPM 100. In some implementations, minReferencePointPositionChangeThreshold=4 meters (m). In other implementations, the minReferencePointPositionChangeThreshold can be altered or changed as described previously. The minGroundSpeedChangeThreshold is a minimum (e.g., threshold amount of) change in ground speed of the reference point of the object and the estimated absolute speed of the reference point of this object lastly included in a CPM 100 in order to select the object for transmission in the current CPM 100. In some implementations, minGroundSpeedChangeThreshold=0.5 m/s. In other implementations, the minGroundSpeedChangeThreshold can be altered or changed as described previously. The minGroundVelocityOrientationChangeThreshold is a minimum (e.g., threshold amount of) change in the orientation of the vector of the current estimated ground velocity of the reference point of the object and the estimated orientation of the vector of the ground velocity of the reference point of this object lastly included in a CPM 100 in order to select the object for transmission in the current CPM 100. In some implementations, minGroundVelocityOrientationChangeThreshold=4 degrees. In other implementations, the minGroundVelocityOrientationChangeThreshold can be altered or changed as described previously.

The aforementioned thresholds are used to restrict the same or similar perceived objects from being included in CPMs 100 too frequently.

To reduce the number of generated CPMs 100, at each CPM generation event, Type-B objects that are to be included in a CPM 100 in the next generation event (e.g., after T_GenCpm) may be included in the currently generated CPM 100. For this purpose, objects that are not selected for transmission in the currently generated CPM 100 may be predicted to, or otherwise included in, the next CPM generation event (e.g., after T_GenCpm), for example, assuming a constant velocity model. Following this prediction, all objects that would then need to be included in a CPM 100 in the next generation event may also be selected for inclusion in the currently generated CPM 100.

In various implementations, the CM-CPM and/or the alternative reporting mechanisms discussed herein can also be used to reduce the number of generated CPMs 100. Additionally or alternatively, to further optimize the size of CPMs 100 (e.g., reduce the size of such CPMs 100) and/or the number of CPM 100 segments, a CPM 100 can be generated as part of a CPM generation event that includes a costmap (or one or more layers of the LCM discussed previously) by adding a CostmapContainer. Inclusion of a PerceivedObjectContainer, CostmapContainer, or both can be up to the ITS-S implementation and/or based on the CPM reporting mechanisms discussed herein.

If MCO_FAC 1328 is supported, T_GenCpm and the message size can be adjusted by the CPS 1321 to satisfy the limits provided by MCO_FAC 1328 in [etsiMCO]. To this end, the perceived objects that have been selected for transmission in the currently generated CPM 100 and have the highest redundancy score can be omitted. The redundancy score may be calculated according to redundancy control rules 1522 and/or according to Annex D of [TS103324]. Additionally or alternatively, if MCO is supported, when objects are omitted from the currently generated CPM 100 due to redundancy-related issues, one or more additional CPMs 100 can be generated and transmitted in alternative channels taking into account the limits provided by MCO_FAC 1328.

A costmap container (CMC) inclusion management function 1505 (also referred to as an “CMC inclusion management function 1505”) causes a CPM 100 to include information about costmaps currently known to a Tx ITS-S 1300 by adding the CostmapContainer DF to the perceivedObjectContainer. The operation of the CMC inclusion management function 1505 is based on the profile configuration (e.g., CPM configuration 1550). For example, if the profile UseCostmapInclusionRules is set to “false”, all or a subset of the known objects is included in the POC; otherwise, some or all of the following inclusion rules 1521 apply.

A CPM 100 is generated as part of a generation event and it may include the updated costmap 300 available at the Tx ITS-S 1300 by adding a costmap 300 in the CostmapContainer in a CPM 100. The costmap 300 is selected for transmission as a result of the current CPM generation event under one or more of the following conditions.

A first condition includes a costmap 300 being added to the current CPM 100 if grid cell cost values and/or grid cell confidence levels of one or more cells changes for more than a minPercentageOfCellsWithCostOrConfidenceChangeThreshold of total cells in the ReportedCostMapGridArea compared to the grid cell cost values and/or grid cell confidence levels reported in a previous CPM 100 (e.g., reported lastly in a CPM 100 and/or directly preceded the current CPM 100). The minPercentageOfCellsWithCostOrConfidenceChangeThreshold is a minimum (e.g., threshold) fraction (or percentage) of total cells in the ReportedCostMapGridArea for which cost values or confidence levels or both change(s) in the costmap compared to the cost values or confidence levels in the costmap reported lastly in a CPM 100 in order to include CostmapContainer with costmap in the current CPM 100. This restricts inclusion of the costmap in CPMs 100 too frequently. In some examples, the minPercentageOfCellsWithCostOrConfidenceChangeThreshold is 10% to 30%. Additionally or alternatively, a minPercentageOfCellsWithCostOrConfidenceDiscrepancyThreshold can be used instead of the minPercentageOfCellsWithCostOrConfidenceChangeThreshold. The minPercentageOfCellsWithCostOrConfidenceDiscrepancyThreshold is a fraction of total cells in the ReportedCostMapGridArea for which cell cost values, cell confidence levels, or both change compared to the cell cost values or cell confidence levels reported in a previous (last) CPM 100 in order to include CostmapContainer with costmap in the current CPM 100. This restricts inclusion of costmap in CPMs 100 too frequently. In some examples, the minPercentageOfCellsWithCostOrConfidenceDiscrepancyThreshold is 10% to 30%. Additionally or alternatively, a minConfidenceLevelThreshold can be used, where the minConfidenceLevelThreshold is a minimum (threshold) confidence level for a calculated cost value of a cell in a costmap to be considered acceptable.

A second condition includes a CostmapContainer DF with costmap 300 being added to the current CPM 100 if the difference between the current Euclidian distance of the NodeCenterPoint of the reported rectangular costmap grid area 310 and the Euclidian distance of the NodeCenterPoint of the reported rectangular costmap grid area 310 included in a previous CPM 100 (e.g., a reported CPM 100 that directly preceded the current CPM 100) exceeds a minNodeCenterPointOfCostMapGridAreaPositionChangeThreshold. The minNodeCenterPointOfCostMapGridAreaPositionChangeThreshold is a minimum (e.g., threshold) change in Euclidian distance of the NodeCenterPoint of the reported costmap grid area and the Euclidian distance of the NodeCenterPoint of the same reported costmap grid area lastly included in a CPM 100 in order to include CostmapContainer with costmap in the current CPM 100. This restricts inclusion of costmap in CPMs 100 too frequently. In some examples, the minNodeCenterPointOfCostMapGridAreaPositionChangeThreshold is 4m.

A third condition includes a CostmapContainer DF with costmap 300 being added to the current CPM 100 if the difference between the current length and/or width of the rectangular costmap grid area 310 to be reported and the length and/or width of the reported rectangular costmap grid area 310 included in a previous CPM 100 (e.g., a reported CPM 100 that directly preceded the current CPM 100) exceeds minLengthOrWidthChangeThreshold. The minLengthOrWidthChangeThreshold is a minimum (e.g., threshold) change in length (or width) of the reported costmap grid area and the length (or width) of the reported costmap grid area lastly included in a CPM 100 in order to include CostmapContainer with Costmap in the current CPM 100. This restricts inclusion of costmap in CPMs 100 too frequently. In some examples, the minLengthOrWidthChangeThreshold is 2m.

A fourth condition includes a CostmapContainer DF with costmap 300 being added to the current CPM 100 if the difference between the current orientation (semiMajorRangeOrientation) of the reported rectangular costmap grid area 310 and the semiMajorRangeOrientation of the reported rectangular costmap grid area 310 included in a previous CPM 100 (e.g., a reported CPM 100 that directly preceded the current CPM 100) exceeds minSemiMajorRangeOfCostMapGridAreaOrientationChangeThreshold. The minSemiMajorRangeOfCostMapGridAreaOrientationChangeThreshold is a minimum (e.g., threshold) change in the current semiMajorRangeOrientation of the reported costmap grid area and the semiMajorRangeOrientation of the reported costmap grid area lastly included in a CPM 100 in order to include CostmapContainer with costmap in the current CPM 100. This restricts inclusion of costmap in CPMs 100 too frequently. In some examples, the minSemiMajorRangeOfCostMapGridAreaOrientationChangeThreshold is 4 degrees.

A fifth condition includes a costmap 300 being added to the current CPM 100 if the time elapsed since the last time the costmap 300 was included in a CPM 100 exceeds T_GenCpmMax.

A CPM segmentation function 1506 (or CPM segmentation functions 1606a, 1606b) performs message segmentation, if needed. The CPM segmentation function 1506 also provides the segmented CPM 100 (e.g., CPM 100 segments) to the E-CPM 1405, or passes the CPM 100 to the E-CPM 1405 if segmentation is not performed. The operation of the CPM segmentation function 1506 is based on the profile configuration (e.g., CPM configuration 1550). For example, the CPM configuration 1550 may specify a maximum transmission unit (MTU) for CPMs (“MTU_CPM”), and the CPM segmentation function 1506 segment a generated CPM 100 if its size is larger than the MTU_CPM.

The size of a generated CPM 100 should not exceed the MTU_CPM as supported via the NF-SAP of the CPS 1321. The definition or parameters of the MTU could be an internal constant or a dynamic value identified based on the capabilities provided by the lower layers (e.g., N&T 1303 and/or access layer 1304) In some examples, the MTU_CPM depends on the MTU of the access layer technology 1304 (“MTU_AL”) over which the CPM 100 is transported. If multiple channels are available (e.g., MCO is supported), some restrictions may apply to each channel individually.

In some example, the MTU_CPM is less than or equal to MTU_AL reduced by the header size of the facilities layer protocol (HD_CPM) and the header size of the N&T 1303 protocol (HD_NT) such that MTU_CPM≤MTU_AL−HD_CPM−HD_NT. Examples of MTU_AL are defined in [EN302663], ETSI TS 103 613 v1.1.1 (2018-11), and the like. The header of the networking and transport layer protocol consists of the BTP header and the GeoNetworking header. The size of BTP header is defined in [EN302636-5-1] and the size of GeoNetworking protocol header per intended packet transport type is defined in ETSI EN 302 636-4-1 v1.4.1 (2020-01) (“[EN302636-4-1]”).

Message segmentation occurs in case the size of the ASN.1 UPER encoded CPM 100 including all POC candidates and/or CMC candidates selected for transmission exceeds MTU_CPM. The order of including CMC candidates versus POC candidates may be left to ITS-S implementation. The selected POC candidates and/or CMC candidates is/are included in a CPM 100 segment in descending order of a per-object utility function defined as the sum of the following 30 parameters: p_{conf}, pₚₒₛ, p_{speed}, p_{head}, and pₜᵢₘₑ. p_{conf} is 0 if the object existence confidence is unknown, unavailable, or equal to the minimum object existence confidence; p_{conf} is 1 if it is 100%, linear interpolation between the minimum object confidence level and 100%. pₚₒₛ is 0 if the Euclidian distance between the current estimated position of the reference point of the object and the estimated position of the reference point of this object lastly included in a CPM 100 is 0 m; pₚₒₛ is 1 if it is equal or greater than 8 m, linear interpolation between 0 and 8 m. p_{speed} is 0 if the difference between the current estimated ground speed of the reference point of the object and the estimated absolute speed of the reference point of this object lastly included in a CPM 100 is 0 m/s; p_{speed} is 1 if it is equal or greater than 1 m/s, linear interpolation between 0 and 1 m/s. p_{head} is 0 if the difference between the orientation of the vector of the current estimated ground velocity of the reference point of the object and the estimated orientation of the vector of the ground velocity of the reference point of this object lastly included in a CPM 100 is 0 degrees; p_{head} is 1 if it is equal or greater than 8 degrees, linear interpolation between 0 and 8 degrees. pₜᵢₘₑ is 0 if time elapsed since the last time the object was included in a CPM 100 is less or equal than 0, 1 s; pₜᵢₘₑ is 1 if it is equal or greater than 1 s, linear interpolation between 0, 1 and 1 s.

A segment should be populated with selected objects as long as the resulting ASN.1 UPER encoded message size of the segment to be generated does not exceed MTU_CPM. Segments are generated in this fashion until all POC (or CMC) candidates are included in a CPM 100 segment. Each segment is made available to the corresponding entities of the protocol stack for transmission. This can be over the interface to the N&T 1303 or over the MCO_FAC interface if MCO is supported. Where MCO is supported, segmentation may occur on each channel selected for transmission when using MCO. Here, separate CPM segmentation functions 1606a, 1606b may be provided for individual channels (see e.g., FIG. 16).

In case the SIC or the FSAC (or PerceivedRegionContainer) also need to be transmitted, those containers should be added to the first CPM 100 segment transmitted on the default or preferred CPM channel (e.g., by being pass to CPM segmentation function 1606a). In some implementations, this procedure may result in the generation of a CPM 100 segment only including the SIC and the FSAC (or PerceivedRegionContainer). In cases where the SIC and/or FSAC (or PerceivedRegionContainer) do not fit in one segment, the same segmentation procedure may be used as described previously for POC and/or CMC candidates.

Message segmentation is indicated by populating the perceivedObjectContainerSegmentlnfo DF. In some implementations, all message segments indicate the same cpmReferenceTime (e.g., DE_TimestampIts as defined in [TS102894-2]). Message segments should be transmitted in the same order in which they have been generated. This is to ensure that segments containing objects of higher priority are not deferred in favor of segments containing objects of lower priority by lower layer mechanisms.

Additionally or alternatively, segmentation is dependent on access layer 1304 capabilities and/or protocols. In these implementations, the CPS 1321 identifies the requirements and/or parameters of the access layer technology 1304 and generates CPMs 100 accordingly. For example, the CPS 1321 may generate CPMs 100 based on the maximum or minimum sizes permitted by the access layer technology 1304. Additionally or alternatively, the access layer technology 1304 can indicate or otherwise provide the CPS 1321 with the MTU_AL and/or MTU_CPM based on various conditions, parameters, and/or criteria (e.g., channel conditions/measurements, and the like). Additionally or alternatively, the access layer 1304 may segment the CPMs 100 according specified conditions, parameters, and/or criteria.

Besides the CPM generation frequency, the time required for the CPM generation and the timeliness of the data taken for the message construction are decisive for the applicability of data in the receiving ITS-Ss. In order to ensure proper interpretation of received CPMs, each CPM 100 is time stamped. The time required for a CPM generation refers to the time difference between the time at which a CPM generation is triggered and the time at which the CPM 100 is delivered to the N&T layer 1303. In some implementations, the time required for a CPM generation is less than 50 ms.

In order to ensure proper interpretation of received CPMs 100, each CPM 100 is time stamped. The format and range of the timestamp may be the format defined in clause B.3 of [TS102894-2] and/or [EN302637-2]. In some implementations, the timestamp included in each CPM 100 is or includes a CPM reference time (see e.g., CPM 200 of FIG. 2).

The CPM reference time (cpmReferenceTime) contained in the CPM 100 serves as an epoch for all relative times contained in the CPM 100. In some implementations, the cpmReferenceTime disseminated by an ITS-S may correspond to a time at which a reference position of the originating ITS-S provided in the CpmManagementContainer DF was determined. When an originating ITS-S provides an estimated kinematic state as a reference position in the CpmManagementContainer, the cpmReferenceTime is the estimated time associated with the estimated kinematic state. In some implementations, the cpmReferenceTime disseminated by an ITS-S may correspond to a time at which a reference position of the originating ITS-S provided in the CpmManagementContainer DF was determined. Additionally or alternatively, the difference between CPM generation time and the cpmReference Time is less than 32,767 ms. Additionally or alternatively, the timestamp of the CPM 100 is the time at which the CPM 100 was finished being assembled in the CPM generation process, and as such, it cannot be a reference time for anything contained in the CPM 100 itself.

The security mechanisms for ITS consider the authentication of messages transferred between ITS-Ss with certificates. A certificate indicates its holder's permissions to send a certain set of messages and optional privileges for specific data elements within these messages. The format for the certificates is specified in [TS103097]. Within the certificate, the permissions and privileges are indicated by an identifier (e.g., an ITS-AID) and/or attributes of a given ITS-AID, allowing for definition of different levels of permissions/rights (e.g., the SSP). The ITS-Application Identifier (ITS-AID) as given in ETSI TR 102 965 v2.1.1 (2021-11) (“[TR102965]”) indicates the overall type of permissions being granted. For example, there is an ITS-AID that indicates that the sender is entitled to send CPMs 100. The service specific permissions (SSP) field indicates specific sets of permissions within the overall permissions indicated by the ITS-AID. For example, there may be an SSP value associated with the ITS-AID for a CPM 100 that indicates that the sender is entitled to send CPMs 100 for a specific role.

Considering the design of the CPS 1321 and the information (e.g., DFs and/or DEs that are processed, stored, and transferred between the ITS-Ss providing the CPS 1321), the following security objectives and security services can be implemented: For establishing CPM secure communications, the message signature service specified in [TS103097] is supported by ITS-S 1300 sending/receiving CPMs 100. Additionally, a CPM 100 is accepted by an Rx ITS-S 1300 if it is consistent with the ITS-AID and SSP of the signing certificate (e.g., an authorization ticket). Furthermore, a signed message uses the ITS-AID as specified in [TR102965].

Additionally or alternatively, the CPMs 100 are signed using private keys associated to authorization tickets that contain SSPs of type BitmapSsp as specified in [TS103097].The SSP has a maximum length as specified in [TS103097]. At reception of a CPM 100, the ITS-S 1300 checks whether the message content is consistent with the ITS-AID and SSP contained in the authorization ticket in its signature. If the consistency check fails, the message is discarded.

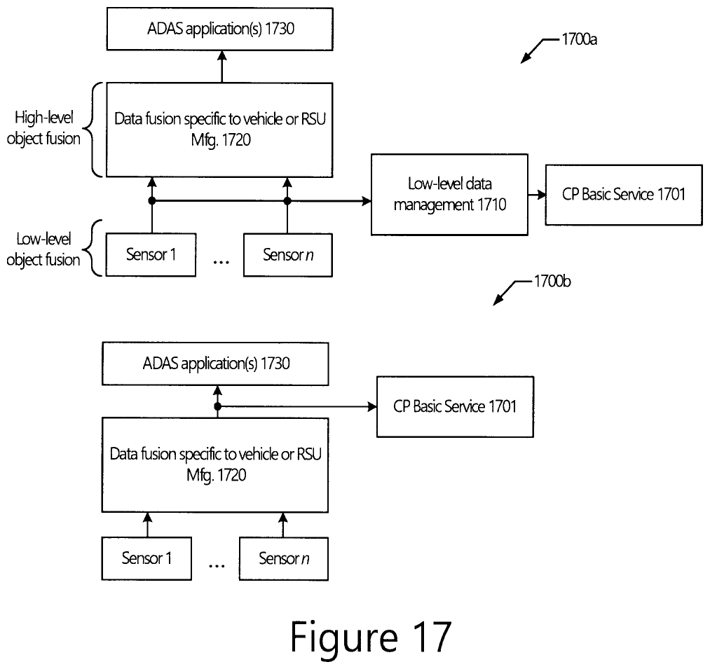

FIG. 17 shows an example of object data extraction levels of the CP basic service 1701, which may be the same or similar as the CPS 1421 of FIG. 14 and/or CPS 1321 of FIG. 13. Part 1700a depicts an implementation in which sensor data from sensors 1 to n (where n is a number) is processed as part of a low-level data management entity 1710. The CP basic service 1701 then selects object candidates to be transmitted as defined in clause 4.3 of ETSI TR 103 562 V2.1.1(2019-12) (“[TR103562]”) and/or according to section 6 of [TS103324]. Part 1700a is more likely to avoid filter cascades, as the task of high-level fusion will be performed by the receiving ITS-S. Part 1700b depicts an implementation in which the CP basic service 1701 selects objects to be transmitted as part of the CPM 100 according to section 6 of [TS103324] and/or according to clause 4.3 of [TR103562] from a high-level fused object list, thereby abstracting the original sensor measurement used in the fusion process. The CPM 100 provides data fields to indicate the source of the object. In parts 1700a and 1700b, the sensor data is also provided to a data fusion function 1720 for high-level object fusion, and the fused data is then provided to one or more ADAS applications 1730.

Raw sensor data refers to low-level data generated by a local perception sensor that is mounted to, or otherwise accessible by, a vehicle or an RSU. This data is specific to a sensor type (e.g., reflexions, time of flight, point clouds, camera image, and/or the like). In the context of environment perception, this data is usually analyzed and subjected to sensor-specific analysis processes to detect and compute a mathematical representation for a detected object from the raw sensor data. The IST-S sensor may provide raw sensor data as a result of their measurements, which is then used by a sensor specific low-level object fusion system (e.g., sensor hub, dedicated processor(s), and the like) to provide a list of objects as detected by the measurement of the sensor. The detection mechanisms and data processing capabilities are specific to each sensor and/or hardware configurations.

This means that the definition and mathematical representation of an object can vary. The mathematical representation of an object is called a state space representation. Depending on the sensor type, a state space representation may comprise multiple dimensions (e.g., relative distance components of the feature to the sensor, speed of the feature, geometric dimensions, and/or the like). A state space is generated for each detected object of a particular measurement. Depending on the sensor type, measurements are performed cyclically, periodically, and/or based on some defined trigger condition. After each measurement, the computed state space of each detected object is provided in an object list that is specific to the timestamp of the measurement.

The object (data) fusion system maintains one or more lists of objects that are currently perceived by the ITS-S. The object fusion mechanism performs prediction of each object to timestamps at which no measurement is available from sensors; associates objects from other potential sensors mounted to the station or received from other ITS-Ss with objects in the tracking list; and merges the prediction and an updated measurement for an object. At each point in time, the data fusion mechanism is able to provide an updated object list based on consecutive measurements from (possibly) multiple sensors containing the state spaces for all tracked objects. V2X information (e.g., CAMs, DENMs, CPMs 100, and/or the like) from other vehicles may additionally be fused with locally perceived information. Other approaches additionally provide alternative representations of the processed sensor data, such as an occupancy grid.

The data fusion mechanism also performs various housekeeping tasks such as, for example, adding state spaces to the list of objects currently perceived by an ITS-S in case a new object is detected by a sensor; updating objects that are already tracked by the data fusion system with new measurements that should be associated to an already tracked object; and removing objects from the list of tracked objects in case new measurements should not be associated to already tracked objects. Depending on the capabilities of the fusion system, objects can also be classified (e.g., some sensor systems may be able to classify a detected object as a particular road user, while others are merely able to provide a distance measurement to an object within the perception range). These tasks of object fusion may be performed either by an individual sensor, or by a high-level data fusion system or process.

FIG. 18 depicts an example vehicle computing system 1800. In this example, the vehicle computing system 1800 includes a V-ITS-S 1801 and Electronic Control Units (ECUs) 1844. The V-ITS-S 1801 includes a V-ITS-S gateway 1811, an ITS-S host 1812, and an ITS-S router 1813. The V-ITS-S gateway 1811 provides functionality to connect the components at the in-vehicle network (e.g., ECUs 1844) to the ITS station-internal network. The interface to the in-vehicle components (e.g., ECUs 1844) may be the same or similar as those discussed herein (see e.g., IX 2106 of FIG. 21) and/or may be a proprietary interface/interconnect. Access to components (e.g., ECUs 1844) may be implementation specific. The ECUs 1844 may be the same or similar to the driving control units (DCUs) 1214 discussed previously w.r.t FIG. 12. The ITS station connects to ITS ad hoc networks via the ITS-S router 1813.

FIG. 19 depicts an example personal computing system 1900. The personal ITS sub-system 1900 provides the app and communication functionality of ITSC in mobile devices, such as smartphones, tablet computers, wearable devices, PDAs, portable media players, laptops, and/or other mobile devices. The personal ITS sub-system 1900 contains a personal ITS station (P-ITS-S) 1901 and various other entities not included in the P-ITS-S 1901, which are discussed in more detail infra. The device used as a personal ITS station may also perform HMI functionality as part of another ITS sub-system, connecting to the other ITS sub-system via the ITS station-internal network (not shown). For purposes of the present disclosure, the personal ITS sub-system 1900 may be used as a VRU ITS-S 1210v.

FIG. 20 depicts an example roadside infrastructure system 2000. In this example, the roadside infrastructure system 2000 includes an R-ITS-S 2001, output device(s) 2005, sensor(s) 2008, and one or more radio units (RUs) 2010. The R-ITS-S 2001 includes a R-ITS-S gateway 2011, an ITS-S host 2012, an ITS-S router 2013, and an ITS-S border router 2014. The ITS station connects to ITS ad hoc networks and/or ITS access networks via the ITS-S router 2013. The R-ITS-S gateway 1811 provides functionality to connect the components of the roadside system(e.g., output devices 2005 and sensors 2008) at the roadside network to the ITS station-internal network. The interface to the in-vehicle components (e.g., ECUs 1844) may be the same or similar as those discussed herein (see e.g., IX 2106 of FIG. 21) and/or may be a proprietary interface/interconnect. Access to components (e.g., ECUs 1844) may be implementation specific. The sensor(s) 2008 may be inductive loops and/or sensors that are the same or similar to the sensors 1212 discussed infra w.r.t FIG. 12 and/or sensor circuitry 2142 discussed infra w.r.t FIG. 21.

The actuators 2013 are devices that are responsible for moving and controlling a mechanism or system. The actuators 2013 are used to change the operational state (e.g., on/off, zoom or focus, and/or the like), position, and/or orientation of the sensors 2008. The actuators 2013 are used to change the operational state of some other roadside equipment, such as gates, traffic lights, digital signage or variable message signs (VMS), and/or the like The actuators 2013 are configured to receive control signals from the R-ITS-S 2001 via the roadside network, and convert the signal energy (or some other energy) into an electrical and/or mechanical motion. The control signals may be relatively low energy electric voltage or current. The actuators 2013 comprise electromechanical relays and/or solid state relays, which are configured to switch electronic devices on/off and/or control motors, and/or may be that same or similar or actuators 2144 discussed infra w.r.t FIG. 21.

Each of FIGS. 18, 19, and 20 also show entities which operate at the same level but are not included in the ITS-S including the relevant HMI 1806, 1906, and 2006; vehicle motion control 1808 (only at the vehicle level); local device sensor system and IoT Platform 1805, 1905, and 2005; local device sensor fusion and actuator app 1804, 1904, and 2004; local perception and trajectory prediction apps 1802, 1902, and 2002; motion prediction 1803 and 1903, or mobile objects trajectory prediction 2003 (at the RSU level); and connected system 1807, 1907, and 2007.

The local device sensor system and IoT Platform 1805, 1905, and 2005 collects and shares IoT data. The sensor system and IoT Platform 1905 is at least composed of the PoTi management function present in each ITS-S of the system (see e.g., ETSI EN 302 890-2 (“[EN302890-2]”)). The PoTi entity provides the global time common to all system elements and the real time position of the mobile elements. Local sensors may also be embedded in other mobile elements as well as in the road infrastructure (e.g., camera in a smart traffic light, electronic signage, and/or the like). An IoT platform, which can be distributed over the system elements, may contribute to provide additional information related to the environment surrounding the device/system 1800, 1900, 2000. The sensor system can include one or more cameras, radars, LiDARs, and/or other sensors (see e.g., sensors 2142 of FIG. 21), in a V-ITS-S 1210 or R-ITS-S 1230. In personal computing system 1900 (or VRU 1210v), the sensor system 1905 may include gyroscope(s), accelerometer(s), and/or other sensors (see e.g., sensors 2142 of FIG. 21). In a central station (not shown), the sensor system includes sensors that may be located on the side of the road, but directly report their data to the central station, without the involvement of a V-ITS-S 1210, an R-ITS-S 1230, or VRU 1210v.

The (local) sensor data fusion function and/or actuator apps 1804, 1904, and 2004 provides the fusion of local perception data obtained from the VRU sensor system and/or different local sensors. This may include aggregating data flows issued by the sensor system and/or different local sensors. The local sensor fusion and actuator app(s) may contain machine learning (ML)/Artificial Intelligence (AI) algorithms and/or models. Sensor data fusion usually relies on the consistency of its inputs and then to their timestamping, which correspond to a common given time. Various ML/AI techniques can be used to carry out the sensor data fusion and/or may be used for other purposes, such as any of the AI/ML techniques and technologies discussed herein. Where the apps 1804, 1904, and 2004 are (or include) AI/ML functions, the apps 1804, 1904, and 2004 may include AI/ML models that have the ability to learn useful information from input data (e.g., context information, and/or the like) according to supervised learning, unsupervised learning, reinforcement learning (RL), and/or neural network(s) (NN). Separately trained AI/ML models can also be chained together in a AI/ML pipeline during inference or prediction generation.

The input data may include AI/ML training information and/or AI/ML model inference information. The training information includes the data of the ML model including the input (training) data plus labels for supervised training, hyperparameters, parameters, probability distribution data, and other information needed to train a particular AI/ML model. The model inference information is any information or data needed as input for the AI/ML model for inference generation (or making predictions). The data used by an AI/ML model for training and inference may largely overlap, however, these types of information refer to different concepts. The input data is called training data and has a known label or result.

Supervised learning is an ML task that aims to learn a mapping function from the input to the output, given a labeled data set. Examples of supervised learning include regression algorithms (e.g., Linear Regression, Logistic Regression,), and the like), instance-based algorithms (e.g., k-nearest neighbor, and the like), Decision Tree Algorithms (e.g., Classification And Regression Tree (CART), Iterative Dichotomiser 3 (ID3), C4.5, chi-square automatic interaction detection (CHAID), and/or the like), Fuzzy Decision Tree (FDT), and the like), Support Vector Machines (SVM), Bayesian Algorithms (e.g., Bayesian network (BN), a dynamic BN (DBN), Naive Bayes, and the like), and Ensemble Algorithms (e.g., Extreme Gradient Boosting, voting ensemble, bootstrap aggregating (“bagging”), Random Forest and the like). Supervised learning can be further grouped into Regression and Classification problems. Classification is about predicting a label whereas Regression is about predicting a quantity. For unsupervised learning, Input data is not labeled and does not have a known result. Unsupervised learning is an ML task that aims to learn a function to describe a hidden structure from unlabeled data. Some examples of unsupervised learning are K-means clustering and principal component analysis (PCA). Neural networks (NNs) are usually used for supervised learning, but can be used for unsupervised learning as well. Examples of NNs include deep NN (DNN), feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), and the like), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), and the like), Linear Dynamical System (LDS), Switching LDS (SLDS), Optical NNs (ONNs), an NN for reinforcement learning (RL) and/or deep RL (DRL), and/or the like. In RL, an agent aims to optimize a long-term objective by interacting with the environment based on a trial and error process. Examples of RL algorithms include Markov decision process, Markov chain, Q-learning, multi-armed bandit learning, and deep RL.

The (local) sensor data fusion function and/or actuator apps 1804, 1904, and 2004 can use any suitable data fusion or data integration technique(s) to generate fused data, union data, and/or composite information. For example, the data fusion technique may be a direct fusion technique or an indirect fusion technique. Direct fusion combines data acquired directly from multiple sensors or other data sources, which may be the same or similar (e.g., all devices or sensors perform the same type of measurement) or different (e.g., different device or sensor types, historical data, and/or the like). Indirect fusion utilizes historical data and/or known properties of the environment and/or human inputs to produce a refined data set. Additionally or alternatively, the data fusion technique can include one or more fusion algorithms, such as a smoothing algorithm (e.g., estimating a value using multiple measurements in real-time or not in real-time), a filtering algorithm (e.g., estimating an entity's state with current and past measurements in real-time), and/or a prediction state estimation algorithm (e.g., analyzing historical data (e.g., geolocation, speed, direction, and signal measurements) in real-time to predict a state (e.g., a future signal strength/quality at a particular geolocation coordinate)). Additionally or alternatively, data fusion functions can be used to estimate various device/system parameters that are not provided by that device/system. As examples, the data fusion algorithm(s) 1804, 1904, and 2004 may be or include one or more of a structured-based algorithm (e.g., tree-based (e.g., Minimum Spanning Tree (MST)), cluster-based, grid and/or centralized-based), a structure-free data fusion algorithm, a Kalman filter algorithm, a fuzzy-based data fusion algorithm, an Ant Colony Optimization (ACO) algorithm, a fault detection algorithm, a Dempster-Shafer (D-S) argumentation-based algorithm, a Gaussian Mixture Model algorithm, a triangulation based fusion algorithm, and/or any other like data fusion algorithm(s), or combinations thereof.

In one example, the ML/AI techniques are used for object tracking. The object tracking and/or computer vision techniques may include, for example, edge detection, corner detection, blob detection, a Kalman filter, Gaussian Mixture Model, Particle filter, Mean-shift based kernel tracking, an ML object detection technique (e.g., Viola-Jones object detection framework, scale-invariant feature transform (SIFT), histogram of oriented gradients (HOG), and/or the like), a deep learning object detection technique (e.g., fully convolutional neural network (FCNN), region proposal convolution neural network (R-CNN), single shot multibox detector, ‘you only look once’ (YOLO) algorithm, and/or the like), and/or the like.

In another example, the ML/AI techniques are used for motion detection based on the y sensor data obtained from the one or more sensors. Additionally or alternatively, the ML/AI techniques are used for object detection and/or classification. The object detection or recognition models may include an enrollment phase and an evaluation phase. During the enrollment phase, one or more features are extracted from the sensor data (e.g., image or video data). A feature is an individual measurable property or characteristic. In the context of object detection, an object feature may include an object size, color, shape, relationship to other objects, and/or any region or portion of an image, such as edges, ridges, corners, blobs, and/or some defined regions of interest (ROI), and/or the like. The features used may be implementation specific, and may be based on, for example, the objects to be detected and the model(s) to be developed and/or used. The evaluation phase involves identifying or classifying objects by comparing obtained image data with existing object models created during the enrollment phase. During the evaluation phase, features extracted from the image data are compared to the object identification models using a suitable pattern recognition technique. The object models may be qualitative or functional descriptions, geometric surface information, and/or abstract feature vectors, and may be stored in a suitable database that is organized using some type of indexing scheme to facilitate elimination of unlikely object candidates from consideration.

Any suitable data fusion or data integration technique(s) may be used to generate the composite information. For example, the data fusion technique may be a direct fusion technique or an indirect fusion technique. Direct fusion combines data acquired directly from multiple vUEs or sensors, which may be the same or similar (e.g., all vUEs or sensors perform the same type of measurement) or different (e.g., different vUE or sensor types, historical data, and/or the like). Indirect fusion utilizes historical data and/or known properties of the environment and/or human inputs to produce a refined data set. Additionally, the data fusion technique may include one or more fusion algorithms, such as a smoothing algorithm (e.g., estimating a value using multiple measurements in real-time or not in real-time), a filtering algorithm (e.g., estimating an entity's state with current and past measurements in real-time), and/or a prediction state estimation algorithm (e.g., analyzing historical data (e.g., geolocation, speed, direction, and signal measurements) in real-time to predict a state (e.g., a future signal strength/quality at a particular geolocation coordinate)). As examples, the data fusion algorithm may be or include a structured-based algorithm (e.g., tree-based (e.g., Minimum Spanning Tree (MST)), cluster-based, grid and/or centralized-based), a structure-free data fusion algorithm, a Kalman filter algorithm and/or Extended Kalman Filtering, a fuzzy-based data fusion algorithm, an Ant Colony Optimization (ACO) algorithm, a fault detection algorithm, a Dempster-Shafer (D-S) argumentation-based algorithm, a Gaussian Mixture Model algorithm, a triangulation based fusion algorithm, and/or any other like data fusion algorithm

A local perception function (which may or may not include trajectory prediction app(s)) 1802, 1902, and 2002 is provided by the local processing of information collected by local sensor(s) associated to the system element. The local perception (and trajectory prediction) function 1802, 1902, and 2002 consumes the output of the sensor data fusion app/function 1804, 1904, and 2004 and feeds ITS-S apps with the perception data (and/or trajectory predictions). The local perception (and trajectory prediction) function 1802, 1902, and 2002 detects and characterize objects (static and mobile) which are likely to cross the trajectory of the considered moving objects. The infrastructure, and particularly the road infrastructure 2000, may offer services relevant to the VRU support service. The infrastructure may have its own sensors detecting VRUs 1216/1210v evolutions and then computing a risk of collision if also detecting local vehicles' evolutions, either directly via its own sensors or remotely via a cooperative perception supporting services such as the CPS 1321 (see e.g., [TR103562]). Additionally, road marking (e.g., zebra areas or crosswalks) and vertical signs may be considered to increase the confidence level associated with the VRU detection and mobility since VRUs 1216/1210v usually have to respect these marking/signs.

The motion dynamic prediction function 1803 and 1903, and the mobile objects trajectory prediction 2003 (at the RSU level), are related to the behavior prediction of the considered moving objects. The motion dynamic prediction function 1803 and 1903 predict the trajectory of the vehicle 1210 and the VRU 1216, respectively. The motion dynamic prediction function 1803 may be part of the VRU Trajectory and Behavioral Modeling module and trajectory interception module of the V-ITS-S 1210. The motion dynamic prediction function 1903 may be part of the dead reckoning module and/or the movement detection module of the VRU ITS-S 1210v.

Alternatively, the motion dynamic prediction functions 1803 and 1903 may provide motion/movement predictions to the aforementioned modules. Additionally or alternatively, the mobile objects trajectory prediction 2003 predict respective trajectories of corresponding vehicles 1210 and VRUs 1216, which may be used to assist the vehicles 1210 and/or VRU ITS-S 1210v in performing dead reckoning and/or assist the V-ITS-S 1210 with VRU Trajectory and Behavioral Modeling entity. Motion dynamic prediction includes a moving object trajectory resulting from evolution of the successive mobile positions. A change of the moving object trajectory or of the moving object velocity (acceleration/deceleration) impacts the motion dynamic prediction. In most cases, when VRUs 1216/1210v are moving, they still have a large amount of possible motion dynamics in terms of possible trajectories and velocities. This means that motion dynamic prediction 1803, 1903, 2003 is used to identify which motion dynamic will be selected by the vehicles 1210 and/or VRU 1216 as quickly as possible, and if this selected motion dynamic is subject to a risk of collision with another VRU or a vehicle. The motion dynamic prediction functions 1803, 1903, 2003 analyze the evolution of mobile objects and the potential trajectories that may meet at a given time to determine a risk of collision between them. The motion dynamic prediction works on the output of cooperative perception considering the current trajectories of considered device (e.g., VRU device 1210v) for the computation of the path prediction; the current velocities and their past evolutions for the considered mobiles for the computation of the velocity evolution prediction; and the reliability level which can be associated to these variables. The output of this function is provided to a risk analysis function.

In many cases, working only on the output of the cooperative perception is not sufficient to make a reliable prediction because of the uncertainty which exists in terms of device/system trajectory selection and its velocity. However, complementary functions may assist in increasing consistently the reliability of the prediction. For example, the use of the device's navigation system, which provides assistance to the user to select the best trajectory for reaching its planned destination. With the development of Mobility as a Service (MaaS), multimodal itinerary computation may also indicate to the device or user dangerous areas and then assist to the motion dynamic prediction at the level of the multimodal itinerary provided by the system. In another example, the knowledge of the user habits and behaviors may be additionally or alternatively used to improve the consistency and the reliability of the motion predictions. Some users follow the same itineraries, using similar motion dynamics, for example when going to the main Point of Interest (POI), which is related to their main activities (e.g., going to school, going to work, doing some shopping, going to the nearest public transport station from their home, going to sport center, and/or the like). The device, system, or a remote service center may learn and memorize these habits. In another example, the indication by the user itself of its selected trajectory in particular when changing it (e.g., using a right turn or left turn signal similar to vehicles when indicating a change of direction).

The vehicle motion control 1808 may be included for computer-assisted and/or automated vehicles 1210. Both the HMI entity 1806 and vehicle motion control entity 1808 may be triggered by one or more ITS-S apps. The vehicle motion control entity 1808 may be a function under the responsibility of a human driver or of the vehicle if it is able to drive in automated mode.

The Human Machine Interface (HMI) 1806, 1906, and 2006, when present, enables the configuration of initial data (parameters) in the management entities (e.g., VRU profile management) and in other functions (e.g., VBS management). The HMI 1806, 1906, and 2006 enables communication of external events related to the VBS to the device owner (user), including the alerting about an immediate risk of collision (TTC<2 s) detected by at least one element of the system and signaling a risk of collision (e.g., TTC>2 seconds) being detected by at least one element of the system. For a VRU system 1210v (e.g., personal computing system 1900), similar to a vehicle driver, the HMI provides the information to the VRU 1216, considering its profile (e.g., for a blind person, the information is presented with a clear sound level using accessibility capabilities of the particular platform of the personal computing system 1900). In various implementations, the HMI 1806, 1906, and 2006 may be part of the alerting system.

The connected systems 1807, 1907, and 2007 refer to components/devices used to connect a system with one or more other systems. As examples, the connected systems 1807, 1907, and 2007 may include communication circuitry and/or radio units. The system 1800, 1900, 2000 may be a connected system made of various/different levels of equipment (e.g., up to 4 levels). The system 1800, 1900, 2000 may also be an information system which collects, in real time, information resulting from events, processes the collected information and stores them together with processed results. At each level of the system 1800, 1900, 2000, the information collection, processing and storage is related to the functional and data distribution scenario which is implemented.

FIG. 21 illustrates an example of components that may be present in an compute node 2100 for implementing the techniques (e.g., operations, processes, methods, and methodologies) described herein. This compute node 2100 provides a closer view of the respective components of node 2100 when implemented as or as part of a computing device or system. The compute node 2100 can include any combination of the hardware or logical components referenced herein, and may include or couple with any device usable with a communication network or a combination of such networks. In particular, any combination of the components depicted by FIG. 21 can be implemented as individual ICs, discrete electronic devices, or other modules, instruction sets, programmable logic or algorithms, hardware, hardware accelerators, software, firmware, or a combination thereof adapted in the compute node 2100, or as components otherwise incorporated within a chassis of a larger system. Additionally or alternatively, any combination of the components depicted by FIG. 21 can be implemented as a system-on-chip (SoC), a single-board computer (SBC), a system-in-package (SiP), a multi-chip package (MCP), and/or the like, in which a combination of the hardware elements are formed into a single IC or a single package. Furthermore, the compute node 2100 may be or include a client device, server, appliance, network infrastructure, machine, robot, drone, and/or any other type of computing devices such as any of those discussed herein. For example, the compute node 2100 may correspond to any of the UEs 1210, NAN 1230, edge compute node 1240, NFs in network 1265, and/or application functions (AFs)/servers 1290 of FIG. 12; ITS 1300 of FIG. 13; vehicle computing system 1800 of FIG. 18; personal computing system 1900 of FIG. 19; roadside infrastructure 2000 of FIG. 20; and/or any other computing device/system discussed herein.

The compute node 2100 includes one or more processors 2102 (also referred to as “processor circuitry 2102”). The processor circuitry 2102 includes circuitry capable of sequentially and/or automatically carrying out a sequence of arithmetic or logical operations, and recording, storing, and/or transferring digital data. Additionally or alternatively, the processor circuitry 2102 includes any device capable of executing or otherwise operating computer-executable instructions, such as program code, software modules, and/or functional processes. The processor circuitry 2102 includes various hardware elements or components such as, for example, a set of processor cores and one or more of on-chip or on-die memory or registers, cache and/or scratchpad memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. Some of these components, such as the on-chip or on-die memory or registers, cache and/or scratchpad memory, may be implemented using the same or similar devices as the memory circuitry 2110 discussed infra. The processor circuitry 2102 is also coupled with memory circuitry 2110 and storage circuitry 2120, and is configured to execute instructions stored in the memory/storage to enable various apps, OSs, or other software elements to run on the platform 2100. In particular, the processor circuitry 2102 is configured to operate app software (e.g., instructions 2101, 2111, 2121) to provide one or more services to a user of the compute node 2100 and/or user(s) of remote systems/devices.

As examples, the processor circuitry 2102 can be embodied as, or otherwise include one or multiple central processing units (CPUs), application processors, graphics processing units (GPUs), RISC processors, Acorn RISC Machine (ARM) processors, complex instruction set computer (CISC) processors, DSPs, FPGAs, programmable logic devices (PLDs), ASICs, baseband processors, radio-frequency integrated circuits (RFICs), microprocessors or controllers, multi-core processors, multithreaded processors, ultra-low voltage processors, embedded processors, a specialized x-processing units (xPUs) or a data processing unit (DPUs) (e.g., Infrastructure Processing Unit (IPU), network processing unit (NPU), and the like), and/or any other processing devices or elements, or any combination thereof. In some implementations, the processor circuitry 2102 is embodied as one or more special-purpose processor(s)/controller(s) configured (or configurable) to operate according to the various implementations and other aspects discussed herein. Additionally or alternatively, the processor circuitry 2102 includes one or more hardware accelerators (e.g., same or similar to acceleration circuitry 2150), which can include microprocessors, programmable processing devices (e.g., FPGAs, ASICs, PLDs, DSPs. and/or the like), and/or the like.

The system memory 2110 (also referred to as “memory circuitry 2110”) includes one or more hardware elements/devices for storing data and/or instructions 2111 (and/or instructions 2101, 2121). Any number of memory devices may be used to provide for a given amount of system memory 2110. As examples, the memory 2110 can be embodied as processor cache or scratchpad memory, volatile memory, non-volatile memory (NVM), and/or any other machine readable media for storing data. Examples of volatile memory include random access memory (RAM), static RAM (SRAM), dynamic RAM (DRAM), synchronous DRAM (SDRAM), thyristor RAM (T-RAM), content-addressable memory (CAM), and/or the like. Examples of NVM can include read-only memory (ROM) (e.g., including programmable ROM (PROM), erasable PROM (EPROM), electrically EPROM (EEPROM), flash memory (e.g., NAND flash memory, NOR flash memory, and the like), solid-state storage (SSS) or solid-state ROM, programmable metallization cell (PMC), and/or the like), non-volatile RAM (NVRAM), phase change memory (PCM) or phase change RAM (PRAM) (e.g., Intel® 3D XPoint™ memory, chalcogenide RAM (CRAM), Interfacial Phase-Change Memory (IPCM), and the like), memistor devices, resistive memory or resistive RAM (ReRAM) (e.g., memristor devices, metal oxide-based ReRAM, quantum dot resistive memory devices, and the like), conductive bridging RAM (or PMC), magnetoresistive RAM (MRAM), electrochemical RAM (ECRAM), ferroelectric RAM (FeRAM), anti-ferroelectric RAM (AFeRAM), ferroelectric field-effect transistor (FeFET) memory, and/or the like. Additionally or alternatively, the memory circuitry 2110 can include spintronic memory devices (e.g., domain wall memory (DWM), spin transfer torque (STT) memory (e.g., STT-RAM or STT-MRAM), magnetic tunneling junction memory devices, spin-orbit transfer memory devices, Spin-Hall memory devices, nanowire memory cells, and/or the like). In some implementations, the individual memory devices 2110 may be formed into any number of different package types, such as single die package (SDP), dual die package (DDP), quad die package (Q17P), memory modules (e.g., dual inline memory modules (DIMMs), microDIMMs, and/or MiniDIMMs), and/or the like. Additionally or alternatively, the memory circuitry 2110 is or includes block addressable memory device(s), such as those based on NAND or NOR flash memory technologies (e.g., single-level cell (“SLC”), multi-level cell (“MLC”), quad-level cell (“QLC”), tri-level cell (“TLC”), or some other NAND or NOR device). Additionally or alternatively, the memory circuitry 2110 can include resistor-based and/or transistor-less memory architectures. In some examples, the memory circuitry 2110 can refer to a die, chip, and/or a packaged memory product. In some implementations, the memory 2110 can be or include the on-die memory or registers associated with the processor circuitry 2102. Additionally or alternatively, the memory 2110 can include any of the devices/components discussed infra w.r.t the storage circuitry 2120.

The storage 2120 (also referred to as “storage circuitry 2120”) provides persistent storage of information, such as data, OSs, apps, instructions 2121, and/or other software elements. As examples, the storage 2120 may be embodied as a magnetic disk storage device, hard disk drive (HDD), microHDD, solid-state drive (SSD), optical storage device, flash memory devices, memory card (e.g., secure digital (SD) card, eXtreme Digital (XD) picture card, USB flash drives, SIM cards, and/or the like), and/or any combination thereof. The storage circuitry 2120 can also include specific storage units, such as storage devices and/or storage disks that include optical disks (e.g., DVDs, CDs/CD-ROM, Blu-ray disks, and the like), flash drives, floppy disks, hard drives, and/or any number of other hardware devices in which information is stored for any duration (e.g., for extended time periods, permanently, for brief instances, for temporarily buffering, and/or caching). Additionally or alternatively, the storage circuitry 2120 can include resistor-based and/or transistor-less memory architectures. Further, any number of technologies may be used for the storage 2120 in addition to, or instead of, the previously described technologies, such as, for example, resistance change memories, phase change memories, holographic memories, chemical memories, among many others. Additionally or alternatively, the storage circuitry 2120 can include any of the devices or components discussed previously w.r.t the memory 2110.

Computer program code for carrying out operations of the present disclosure (e.g., computational logic and/or instructions 2101, 2111, 2121) may be written in any combination of one or more programming languages, including object oriented programming languages, procedural programming languages, scripting languages, markup languages, and/or some other suitable programming languages including proprietary programming languages and/or development tools, or any other languages tools. The computer program/code 2101, 2111, 2121 for carrying out operations of the present disclosure may also be written in any combination of programming languages and/or machine language, such as any of those discussed herein. The program code may execute entirely on the system 2100, partly on the system 2100, as a stand-alone software package, partly on the system 2100 and partly on a remote computer or entirely on the remote computer or server. In the latter scenario, the remote computer may be connected to the system 2100 through any type of network, including a LAN or WAN, or the connection may be made to an external computer (e.g., through the Internet, enterprise network, and/or some other network). Additionally or alternatively, the computer program/code 2101, 2111, 2121 can include one or more operating systems (OS) and/or other software to control various aspects of the compute node 2100. The OS can include drivers to control particular devices that are embedded in the compute node 2100, attached to the compute node 2100, and/or otherwise communicatively coupled with the compute node 2100. Example OSs include consumer-based OS, real-time OS (RTOS), hypervisors, and/or the like.

The storage 2120 may include instructions 2121 in the form of software, firmware, or hardware commands to implement the techniques described herein. Although such instructions 2121 are shown as code blocks included in the memory 2110 and/or storage 2120, any of the code blocks may be replaced with hardwired circuits, for example, built into an ASIC, FPGA memory blocks/cells, and/or the like. In an example, the instructions 2101, 2111, 2121 provided via the memory 2110, the storage 2120, and/or the processor 2102 are embodied as a non-transitory or transitory machine-readable medium (also referred to as “computer readable medium” or “CRM”) including code (e.g., instructions 2101, 2111, 2121, accessible over the IX 2106, to direct the processor 2102 to perform various operations and/or tasks, such as a specific sequence or flow of actions as described herein and/or depicted in any of the accompanying drawings. The CRM may be embodied as any of the devices/technologies described for the memory 2110 and/or storage 2120.

The various components of the computing node 2100 communicate with one another over an interconnect (IX) 2106. The IX 2106 may include any number of IX (or similar) technologies including, for example, instruction set architecture (ISA), extended ISA (eISA), Inter-Integrated Circuit (I²C), serial peripheral interface (SPI), point-to-point interfaces, power management bus (PMBus), peripheral component interconnect (PCI), PCI express (PCIe), PCI extended (PCIx), Intel® Ultra Path Interconnect (UPI), Intel® Accelerator Link, Intel® QuickPath Interconnect (QPI), Intel® Omni-Path Architecture (OPA), Compute Express Link™ (CXL™) IX, RapidIO™ IX, Coherent Accelerator Processor Interface (CAPI), OpenCAPI, Advanced Microcontroller Bus Architecture (AMBA) IX, cache coherent interconnect for accelerators (CCIX), Gen-Z Consortium IXs, a HyperTransport IX, NVLink provided by NVIDIA®, ARM Advanced eXtensible Interface (AXI), a Time-Trigger Protocol (TTP) system, a FlexRay system, PROFIBUS, Ethernet, USB, On-Chip System Fabric (IOSF), Infinity Fabric (IF), and/or any number of other IX technologies. The IX 2106 may be a proprietary bus, for example, used in a SoC based system.

The communication circuitry 2160 comprises a set of hardware elements that enables the compute node 2100 to communicate over one or more networks (e.g., cloud 2165) and/or with other devices 2190. Communication circuitry 2160 includes various hardware elements, such as, for example, switches, filters, amplifiers, antenna elements, and the like to facilitate over-the-air (OTA) communications. Communication circuitry 2160 includes modem circuitry 2161 that interfaces with processor circuitry 2102 for generation and processing of baseband signals and for controlling operations of transceivers (TRx) 2162, 2163. The modem circuitry 2161 handles various radio control functions according to one or more communication protocols and/or RATs, such as any of those discussed herein. The modem circuitry 2161 includes baseband processors or control logic to process baseband signals received from a receive signal path of the TRxs 2162, 2163, and to generate baseband signals to be provided to the TRxs 2162, 2163 via a transmit signal path.

The TRxs 2162, 2163 include hardware elements for transmitting and receiving radio waves according to any number of frequencies and/or communication protocols, such as any of those discussed herein. The TRxs 2162, 2163 can include transmitters (Tx) and receivers (Rx) as separate or discrete electronic devices, or single electronic devices with Tx and Rx functionally.

In either implementation, the TRxs 2162, 2163 may be configured to communicate over different networks or otherwise be used for different purposes. In one example, the TRx 2162 is configured to communicate using a first RAT (e.g., W-V2X and/or [IEEE802] RATs, such as [IEEE80211], [IEEE802154], [WiMAX], IEEE 802.11bd, ETSI ITS-G5, and/or the like) and TRx 2163 is configured to communicate using a second RAT (e.g., 3GPP RATs such as 3GPP LTE or NR/5G including C-V2X). In another example, the TRxs 2162, 2163 may be configured to communicate over different frequencies or ranges, such as the TRx 2162 being configured to communicate over a relatively short distance (e.g., devices 2190 within about 10 meters using a local Bluetooth®, devices 2190 within about 50 meters using ZigBee®, and/or the like), and TRx 2162 being configured to communicate over a relatively long distance (e.g., using [IEEE802], [WiMAX], and/or 3GPP RATs). The same or different communications techniques may take place over a single TRx at different power levels or may take place over separate TRxs.

A network interface circuitry 2130 (also referred to as “network interface controller 2130” or “NIC 2130”) provides wired communication to nodes of the cloud 2165 and/or to connected devices 2190. The wired communications may be provided according to Ethernet (e.g., [IEEE802.3]) or may be based on other types of networks, such as Controller Area Network (CAN), Local Interconnect Network (LIN), DeviceNet, ControlNet, Data Highway+, or PROFINET, among many others. As examples, the NIC 2130 may be embodied as a SmartNIC and/or one or more intelligent fabric processors (IFPs). One or more additional NICs 2130 may be included to enable connecting to additional networks. For example, a first NIC 2130 can provide communications to the cloud 2165 over an Ethernet network (e.g., [IEEE802.3]), a second NIC 2130 can provide communications to connected devices 2190 over an optical network (e.g., optical transport network (OTN), Synchronous optical networking (SONET), and synchronous digital hierarchy (SDH)), and so forth.

Given the variety of types of applicable communications from the compute node 2100 to another component, device 2190, and/or network 2165, applicable communications circuitry used by the compute node 2100 may include or be embodied by any combination of components 2130, 2140, 2150, or 2160. Accordingly, applicable means for communicating (e.g., receiving, transmitting, broadcasting, and so forth) may be embodied by such circuitry.

The acceleration circuitry 2150 (also referred to as “accelerator circuitry 2150”) includes any suitable hardware device or collection of hardware elements that are designed to perform one or more specific functions more efficiently in comparison to general-purpose processing elements. The acceleration circuitry 2150 can include various hardware elements such as, for example, one or more GPUs, FPGAs, DSPs, SoCs (including programmable SoCs and multi-processor SoCs), ASICs (including programmable ASICs), PLDs (including complex PLDs (CPLDs) and high capacity PLDs (HCPLDs), xPUs (e.g., DPUs, IPUs, and NPUs) and/or other forms of specialized circuitry designed to accomplish specialized tasks. Additionally or alternatively, the acceleration circuitry 2150 may be embodied as, or include, one or more of artificial intelligence (AI) accelerators (e.g., vision processing unit (VPU), neural compute sticks, neuromorphic hardware, deep learning processors (DLPs) or deep learning accelerators, tensor processing units (TPUs), physical neural network hardware, and/or the like), cryptographic accelerators (or secure cryptoprocessors), network processors, I/O accelerator (e.g., DMA engines and the like), and/or any other specialized hardware device/component. The offloaded tasks performed by the acceleration circuitry 2150 can include, for example, AI/ML tasks (e.g., training, feature extraction, model execution for inference/prediction, classification, and so forth), visual data processing, graphics processing, digital and/or analog signal processing, network data processing, infrastructure function management, object detection, rule analysis, and/or the like.

The TEE 2170 operates as a protected area accessible to the processor circuitry 2102 and/or other components to enable secure access to data and secure execution of instructions. In some implementations, the TEE 2170 may be a physical hardware device that is separate from other components of the system 2100 such as a secure-embedded controller, a dedicated SoC, a trusted platform module (TPM), a tamper-resistant chipset or microcontroller with embedded processing devices and memory devices, and/or the like. Additionally or alternatively, the TEE 2170 is implemented as secure enclaves (or “enclaves”), which are isolated regions of code and/or data within the processor and/or memory/storage circuitry of the compute node 2100, where only code executed within a secure enclave may access data within the same secure enclave, and the secure enclave may only be accessible using the secure app (which may be implemented by an app processor or a tamper-resistant microcontroller). In some implementations, the memory circuitry 2104 and/or storage circuitry 2108 may be divided into one or more trusted memory regions for storing apps or software modules of the TEE 2170. Additionally or alternatively, the processor circuitry 2102, acceleration circuitry 2150, memory circuitry 2110, and/or storage circuitry 2120 may be divided into, or otherwise separated into virtualized environments using a suitable virtualization technology, such as, for example, virtual machines (VMs), virtualization containers, and/or the like. These virtualization technologies may be managed and/or controlled by a virtual machine monitor (VMM), hypervisor container engines, orchestrators, and the like. Such virtualization technologies provide execution environments in which one or more apps and/or other software, code, or scripts may execute while being isolated from one or more other apps, software, code, or scripts.

The input/output (I/O) interface circuitry 2140 (also referred to as “interface circuitry 2140”) is used to connect additional devices or subsystems. The interface circuitry 2140, is part of, or includes circuitry that enables the exchange of information between two or more components or devices such as, for example, between the compute node 2100 and various additional/external devices (e.g., sensor circuitry 2142, actuator circuitry 2144, and/or positioning circuitry 2143).

Access to various such devices/components may be implementation specific, and may vary from implementation to implementation. At least in some examples, the interface circuitry 2140 includes one or more hardware interfaces such as, for example, buses, input/output (I/O) interfaces, peripheral component interfaces, network interface cards, and/or the like. Additionally or alternatively, the interface circuitry 2140 includes a sensor hub or other like elements to obtain and process collected sensor data and/or actuator data before being passed to other components of the compute node 2100.

The sensor circuitry 2142 includes devices, modules, or subsystems whose purpose is to detect events or changes in its environment and send the information (sensor data) about the detected events to some other a device, module, subsystem, and the like. In some implementations, the sensor(s) 2142 are the same or similar as the sensors 1212 of FIG. 12. Individual sensors 2142 may be exteroceptive sensors (e.g., sensors that capture and/or measure environmental phenomena and/external states), proprioceptive sensors (e.g., sensors that capture and/or measure internal states of the compute node 2100 and/or individual components of the compute node 2100), and/or exproprioceptive sensors (e.g., sensors that capture, measure, or correlate internal states and external states). Examples of such sensors 2142 include inertia measurement units (IMU), microelectromechanical systems (MEMS) or nanoelectromechanical systems (NEMS), level sensors, flow sensors, temperature sensors (e.g., thermistors, including sensors for measuring the temperature of internal components and sensors for measuring temperature external to the compute node 2100), pressure sensors, barometric pressure sensors, gravimeters, altimeters, image capture devices (e.g., visible light cameras, thermographic camera and/or thermal imaging camera (TIC) systems, forward-looking infrared (FLIR) camera systems, radiometric thermal camera systems, active infrared (IR) camera systems, ultraviolet (UV) camera systems, and/or the like), light detection and ranging (LiDAR) sensors, proximity sensors (e.g., IR radiation detector and the like), depth sensors, ambient light sensors, optical light sensors, ultrasonic transceivers, microphones, inductive loops, and/or the like. The IMUs, MEMS, and/or NEMS can include, for example, one or more 3-axis accelerometers, one or more 3-axis gyroscopes, one or more magnetometers, one or more compasses, one or more barometers, and/or the like.

Additional or alternative examples of the sensor circuitry 2142 used for various aerial asset and/or vehicle control systems can include one or more of exhaust sensors including exhaust oxygen sensors to obtain oxygen data and manifold absolute pressure (MAP) sensors to obtain manifold pressure data; mass air flow (MAF) sensors to obtain intake air flow data; intake air temperature (IAT) sensors to obtain IAT data; ambient air temperature (AAT) sensors to obtain AAT data; ambient air pressure (AAP) sensors to obtain AAP data; catalytic converter sensors including catalytic converter temperature (CCT) to obtain CCT data and catalytic converter oxygen (CCO) sensors to obtain CCO data; vehicle speed sensors (VSS) to obtain VSS data; exhaust gas recirculation (EGR) sensors including EGR pressure sensors to obtain ERG pressure data and EGR position sensors to obtain position/orientation data of an EGR valve pintle; Throttle Position Sensor (TPS) to obtain throttle position/orientation/angle data; a crank/cam position sensors to obtain crank/cam/piston position/orientation/angle data; coolant temperature sensors; pedal position sensors; accelerometers; altimeters; magnetometers; level sensors; flow/fluid sensors, barometric pressure sensors, vibration sensors (e.g., shock & vibration sensors, motion vibration sensors, main and tail rotor vibration monitoring and balancing (RTB) sensor(s), gearbox and drive shafts vibration monitoring sensor(s), bearings vibration monitoring sensor(s), oil cooler shaft vibration monitoring sensor(s), engine vibration sensor(s) to monitor engine vibrations during steady-state and transient phases, and/or the like), force and/or load sensors, remote charge converters (RCC), rotor speed and position sensor(s), fiber optic gyro (FOG) inertial sensors, Attitude & Heading Reference Unit (AHRU), fibre Bragg grating (FBG) sensors and interrogators, tachometers, engine temperature gauges, pressure gauges, transformer sensors, airspeed-measurement meters, vertical speed indicators, and/or the like.

The actuators 2144 allow compute node 2100 to change its state, position, and/or orientation, or move or control a mechanism or system. The actuators 2144 comprise electrical and/or mechanical devices for moving or controlling a mechanism or system, and converts energy (e.g., electric current or moving air and/or liquid) into some kind of motion. Additionally or alternatively, the actuators 2144 can include electronic controllers linked or otherwise connected to one or more mechanical devices and/or other actuation devices. As examples, the actuators 2144 can be or include any number and combination of the following: soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, axles, thrusters, propellers, engines, motors, servos, clutches, rotors, and the like), projectile actuators/mechanisms (e.g., mechanisms that shoot or propel objects or elements), payload actuators, audible sound generators (e.g., speakers and the like), LEDs and/or visual warning devices, and/or other like electromechanical components. Additionally or alternatively, the actuators 2144 can include virtual instrumentation and/or virtualized actuator devices.

Additionally or alternatively, the interface circuitry 2140 and/or the actuators 2144 can include various individual controllers and/or controllers belonging to one or more components of the compute node 2100 such as, for example, host controllers, cooling element controllers, baseboard management controller (BMC), platform controller hub (PCH), uncore components (e.g., shared last level cache (LLC) cache, caching agent (Cbo), integrated memory controller (IMC), home agent (HA), power control unit (PCU), configuration agent (Ubox), integrated I/O controller (IIO), and interconnect (IX) link interfaces and/or controllers), and/or any other components such as any of those discussed herein. The compute node 2100 may be configured to operate one or more actuators 2144 based on one or more captured events, instructions, control signals, and/or configurations received from a service provider, client device, and/or other components of the compute node 2100. Additionally or alternatively, the actuators 2144 can include mechanisms that are used to change the operational state (e.g., on/off, zoom or focus, and/or the like), position, and/or orientation of one or more sensors 2142.

In some implementations, such as when the compute node 2100 is part of a vehicle system (e.g., V-ITS-S 1210 of FIG. 12), the actuators 2144 correspond to the driving control units (DCUs) 1214 discussed previously w.r.t FIG. 12. In some implementations, such as when the compute node 2100 is part of roadside equipment (e.g., R-ITS-S 1230 of FIG. 12), the actuators 2144 can be used to change the operational state of the roadside equipment or other roadside equipment, such as gates, traffic lights, digital signage or variable message signs (VMS), and/or the like. The actuators 2144 are configured to receive control signals from the R-ITS-S 1230 via a roadside network, and convert the signal energy (or some other energy) into an electrical and/or mechanical motion. The control signals may be relatively low energy electric voltage or current.

The positioning circuitry (pos) 2143 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), and the like), or the like. The positioning circuitry 2145 comprises various hardware elements (e.g., including hardware devices such as switches, filters, amplifiers, antenna elements, and the like to facilitate OTA communications) to communicate with components of a positioning network, such as navigation satellite constellation nodes. Additionally or alternatively, the positioning circuitry 2145 may include a Micro-Technology for Positioning, Navigation, and Timing (Micro-PNT) IC that uses a master timing clock to perform position tracking/estimation without GNSS assistance. The positioning circuitry 2145 may also be part of, or interact with, the communication circuitry 2160 to communicate with the nodes and components of the positioning network. The positioning circuitry 2145 may also provide position data and/or time data to the application circuitry (e.g., processor circuitry 2102), which may use the data to synchronize operations with various infrastructure (e.g., radio base stations), for turn-by-turn navigation, or the like. In some implementations, the positioning circuitry 2145 is, or includes an INS, which is a system or device that uses sensor circuitry 2142 (e.g., motion sensors such as accelerometers, rotation sensors such as gyroscopes, and altimeters, magnetic sensors, and/or the like to continuously calculate (e.g., using dead by dead reckoning, triangulation, or the like) a position, orientation, and/or velocity (including direction and speed of movement) of the platform 2100 without the need for external references.

In some examples, various I/O devices may be present within or connected to, the compute node 2100, which are referred to as input circuitry 2146 and output circuitry 2145. The input circuitry 2146 and output circuitry 2145 include one or more user interfaces designed to enable user interaction with the platform 2100 and/or peripheral component interfaces designed to enable peripheral component interaction with the platform 2100. The input circuitry 2146 and/or output circuitry 2145 may be, or may be part of a Human Machine Interface (HMI), such as HMI 1806, 1906, 2006. Input circuitry 2146 includes any physical or virtual means for accepting an input including buttons, switches, dials, sliders, keyboard, keypad, mouse, touchpad, touchscreen, microphone, scanner, headset, and/or the like. The output circuitry 2145 may be included to show information or otherwise convey information, such as sensor readings, actuator position(s), or other like information. Data and/or graphics may be displayed on one or more user interface components of the output circuitry 2145. Output circuitry 2145 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, and the like), with the output of characters, graphics, multimedia objects, and the like being generated or produced from the operation of the compute node 2100. The output circuitry 2145 may also include speakers or other audio emitting devices, printer(s), and/or the like. Additionally or alternatively, the sensor circuitry 2142 may be used as the input circuitry 2145 (e.g., an image capture device, motion capture device, or the like) and one or more actuators 2144 may be used as the output device circuitry 2145 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, and the like. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2180 can be used to power the compute node 2100, although, in examples in which the compute node 2100 is mounted in a fixed location, it may have a power supply coupled to an electrical grid, or the battery 2180 may be used as a backup power source. As examples, the battery 2180 can be a lithium ion battery or a metal-air battery (e.g., zinc-air battery, aluminum-air battery, lithium-air battery, and the like). Other battery technologies may be used in other implementations.

A battery monitor/charger 2182 may be included in the compute node 2100 to track the state of charge (SoCh) of the battery 2180, if included. The battery monitor/charger 2182 may be used to monitor other parameters of the battery 2180 to provide failure predictions, such as the state of health (SoH) and the state of function (SoF) of the battery 2180. The battery monitor/charger 2182 may include a battery monitoring IC. The battery monitor/charger 2182 may communicate the information on the battery 2180 to the processor 2102 over the IX 2106. The battery monitor/charger 2182 may also include an analog-to-digital (ADC) converter that enables the processor 2102 to directly monitor the voltage of the battery 2180 or the current flow from the battery 2180. The battery parameters may be used to determine actions that the compute node 2100 may perform, such as transmission frequency, mesh network operation, sensing frequency, and the like. A power block 2185, or other power supply coupled to a grid, may be coupled with the battery monitor/charger 2182 to charge the battery 2180. In some examples, the power block 2185 may be replaced with a wireless power receiver to obtain the power wirelessly, for example, through a loop antenna in the compute node 2100. A wireless battery charging circuit may be included in the battery monitor/charger 2182. The specific charging circuits may be selected based on the size of the battery 2180, and thus, the current required. The charging may be performed according to Airfuel Alliance standards, the Qi wireless charging standard, the Rezence charging standard, among others.

The example of FIG. 21 is intended to depict a high-level view of components of a varying device, subsystem, or arrangement of a computing node 2100. However, in other implementations, some of the components shown may be omitted, additional components may be present, and a different arrangement of the components shown may occur in other implementations. Further, these arrangements are usable in a variety of use cases and environments, including those discussed herein.

### 4. Example Implementations

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example [0321] includes a method of operating a collective perception service (CPS) facility in an Intelligent Transport System Station (ITS-S), the method comprising: generating a first collective perception message (CPM) during a first CPM generation period, wherein the first CPM includes at least one perceived object container (POC), and the at least one POC includes data related to an individual object perceived by the ITS-S; transmitting or broadcasting the first CPM during the first CPM generation period; generating a second CPM during a second CPM generation period, wherein the second CPM generation period is smaller than the first CPM generation period, the second CPM includes at least one costmap container (CMC), and the at least one CMC includes data related to a costmap generated by the ITS-S; and transmitting or broadcasting the second CPM during the second CPM generation period.

Example [0322] includes the method of example [0321] and/or some other example(s) herein, wherein the method includes: generating the first CPM in response to a first periodic CPM generation event being triggered; and generating the second CPM in response to a second periodic CPM generation event being triggered.

Example [0323] includes the of examples [0321]-[0322] and/or some other example(s) herein, wherein a size of the second CPM generation period is equal to or larger than a CPM generation event periodicity (T_GenCpm), wherein the T_GenCpm is a time elapsed between triggering of consecutive CPM generation events.

Example [0324] includes the of example [0323] and/or some other example(s) herein, wherein a size of the first CPM generation period is based on an object type of the individual object perceived by the ITS-S.

Example [0325] includes the of example [0324] and/or some other example(s) herein, wherein the size of the first CPM generation period is larger than the second CPM generation period when the individual object perceived by the ITS-S is a static object.

Example XX includes the of examples [0324]-[0325] and/or some other example(s) herein, wherein the size of the first CPM generation period is larger than the second CPM generation period when the individual object perceived by the ITS-S is a non-safety critical dynamic object.

Example [0327] includes the of examples [0324]-[0326] and/or some other example(s) herein, wherein the size of the first CPM generation period is smaller than the second CPM generation period when the individual object perceived by the ITS-S is a safety critical dynamic object.

Example [0328] includes the of examples [0321]-[0327] and/or some other example(s) herein, wherein the method includes: generating the first CPM when a time elapsed since a last time the individual object was included in a previous first CPM has exceeded a first time threshold; and generating the second CPM when a time elapsed since a last time the costmap was included in a previous second CPM has exceeded a second time threshold.

Example [0329] includes the of example 8 and/or some other example(s) herein, wherein the first time threshold is greater than or equal to the second time threshold.

Example [0330] includes the of examples [0321]-[0329] and/or some other example(s) herein, wherein the method includes: generating the first CPM when a difference between a current estimated ground speed of a reference point of the individual object and an estimated absolute speed of the reference point of the individual object included in a previous first CPM exceeds a minimum ground speed change threshold.

Example [0331] includes the of examples [0321]-[0330] and/or some other example(s) herein, wherein the method includes: generating the first CPM when an orientation of the individual object's estimated ground velocity orientation, at its reference point, has changed by at least a ground velocity orientation change threshold since a last time the individual object was included in a previous first CPM.

Example [0332] includes the of examples [0321]-[0331] and/or some other example(s) herein, wherein the method includes: generating the first CPM without a free space addendum container (FSAC).

Example [0333] includes the of examples [0321]-[0332] and/or some other example(s) herein, wherein the method includes: generating the first CPM to include the POC and an FSAC when a previous number of first CPMs did not include an FSAC.

Example [0334] includes the of examples [0321]-[0333] and/or some other example(s) herein, wherein the method includes: generating the first CPM to include the POC and an FSAC when a previous number of first CPMs did not include an FSAC.

Example [0335] includes the of example [0321]-[0334] and/or some other example(s) herein, wherein the first CPM includes a first management container, the second CPM includes a second management container, and each of the first management container and the second management container include a CPM identifier (ID).

Example [0336] includes the of example [0335] and/or some other example(s) herein, wherein the at least one CMC includes a reference-to-last-CPM container, and the reference-to-last-CPM container includes a CPM ID of a previously transmitted first CPM or a CPM ID of a previously transmitted second CPM.

Example [0337] includes the of examples [0335]-[0336] and/or some other example(s) herein, wherein the POC includes a reference-to-last-CPM container, and the reference-to-last-CPM container includes a CPM ID of a previously transmitted first CPM or a CPM ID of a previously transmitted second CPM

Example [0338] includes the method of examples [0321]-[0337] and/or some other example(s) herein, wherein the costmap includes a set of cells, each cell of the set of cells includes a cost value and an associated confidence level, wherein the cost value indicates a perceived cost of traveling through that cell.

Example [0339] includes the method of example [0338] and/or some other example(s) herein, wherein the data related to the costmap generated by the ITS-S includes one or more of dimensions of the costmap, a number of cells in the set of cells, dimensions of each cell in the set of cells, a cost value for each cell, and a confidence level for each cell.

Example [0340] includes the method of example [0339] and/or some other example(s) herein, wherein the data related to the costmap generated by the ITS-S includes height (Z-direction) information for each cell.

Example [0341] includes the method of examples [0338]-[0340] and/or some other example(s) herein, wherein the method includes: generating the second CPM when a threshold number of cells in the set of cells has changed cost values or changed confidence levels when compared to cost values or confidence levels included in a previously generated second CPM.

Example [0342] includes the method of examples [0338]-[0341] and/or some other example(s) herein, wherein the method includes: generating the second CPM when a distance of a center point of the costmap to be included in the second CPM and a center point of another costmap included in a previously generated second CPM exceeds a threshold distance.

Example [0343] includes the method of examples [0338]-[0342] and/or some other example(s) herein, wherein the method includes: generating the second CPM when a difference between one or more dimensions of the costmap and one or more other dimensions of another costmap included in a previously generated second CPM exceeds a threshold size.

Example [0344] includes the method of examples [0338]-[0343] and/or some other example(s) herein, wherein the method includes: generating the second CPM when a difference between an orientation of the costmap and another orientation of another costmap included in a previously generated second CPM exceeds a threshold orientation.

Example [0345] includes the method of examples [0338]-[0344] and/or some other example(s) herein, wherein the method includes: generating the second CPM when an amount of time elapsed since a last time another costmap was included in a previously generated second CPM exceeds CPM generation time threshold.

Example [0346] includes the method of examples [0321]-[0345] and/or some other example(s) herein, wherein the method includes: generating the second CPM as a differential CPM during the second CPM generation period, wherein the at least one CMC in the differential CPM includes cost values and associated confidence levels of corresponding cells for which the cost values have changed by more than a cost value threshold or for which the associated confidence levels have changed by more than a confidence level threshold.

Example [0347] includes the method of example [0346] and/or some other example(s) herein, wherein the differential CPM includes a data element to carry a reference to a previously transmitted second CPM, wherein the reference to the previously transmitted second CPM is a sequence number of the previously transmitted second CPM or an identifier included in the previously transmitted second CPM.

Example [0348] includes the method of examples [0321]-[0347] and/or some other example(s) herein, wherein the method includes: generating a third CPM in response to detection of a predefined event; and transmitting or broadcasting the third CPM in response to the detection.

Example [0349] includes the method of example [0348] and/or some other example(s) herein, wherein the method includes: reconfiguring the first CPM generation period or the second CPM generation period in response to the detection of the predefined event.

Example [0350] includes the method of examples [0348]-[0349] and/or some other example(s) herein, wherein the predefined event is detection of a safety critical dynamic object, and the third CPM includes at least one POC to include data related to the detected safety critical dynamic object.

Example [0351] includes the method of example [0350] and/or some other example(s) herein, wherein the third CPM includes at least one CMC to include additional data related to the costmap generated by the ITS-S.

Example [0352] includes the method of example [0348] and/or some other example(s) herein, wherein the third CPM includes a data element to carry an indication indicating that the third CPM is an event-triggered CPM.

Example [0353] includes the method of examples [0321]-[0352] and/or some other example(s) herein, wherein the method includes: generating the second CPM to include another POC to carry a set of data related to the individual object perceived by the ITS-S.

Example [0354] includes the method of examples [0321]-[0353] and/or some other example(s) herein, wherein the ITS-S is a vehicle ITS-S, a roadside ITS-S, or a vulnerable road user ITS-S.

Example [0355] includes one or more computer readable media comprising instructions, wherein execution of the instructions by processor circuitry is to cause the processor circuitry to perform the method of examples [0321]-[0354] and/or some other example(s) herein.

Example [0356] includes a computer program comprising the instructions of example [0355] and/or some other example(s) herein.

Example [0357] includes an Application Programming Interface defining functions, methods, variables, data structures, and/or protocols for the computer program of example [0356] and/or some other example(s) herein.

Example [0358] includes an apparatus comprising circuitry loaded with the instructions of example [0355] and/or some other example(s) herein.

Example [0359] includes an apparatus comprising circuitry operable to run the instructions of example [0355] and/or some other example(s) herein.

Example [0360] includes an integrated circuit comprising one or more of the processor circuitry and the one or more computer readable media of example [0355] and/or some other example(s) herein.

Example [0361] includes a computing system comprising the one or more computer readable media and the processor circuitry of example [0355] and/or some other example(s) herein.

Example [0362] includes an apparatus comprising means for executing the instructions of example [0355] and/or some other example(s) herein.

Example [0363] includes a signal generated as a result of executing the instructions of example [0355] and/or some other example(s) herein.

Example [0364] includes a data unit generated as a result of executing the instructions of example [0355] and/or some other example(s) herein.

Example [0365] includes the data unit of example [0364] and/or some other example(s) herein, wherein the data unit is a packet, frame, datagram, protocol data unit (PDU), service data unit (SDU), segment, message, data block, data chunk, cell, data field, data element, information element, type length value, set of bytes, set of bits, set of symbols, and/or database object.

Example [0366] includes a signal encoded with the data unit of examples [0364]-[0365] and/or some other example(s) herein.

Example [0367] includes an electromagnetic signal carrying the instructions of example [0355] and/or some other example(s) herein.

Example [0368] includes an apparatus comprising means for performing the method of examples [0321]-[0354] and/or some other example(s) herein.

### 5. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments. Furthermore, the terms “comprising,” “including,” “having,” and the like, as used w.r.t the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “.performer”, “agent”, “standby”, “consumer”, “peripheral”, “follower”, “server”, “child”, “helper”, “worker”, “node”, and/or the like.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, and so forth, or combinations thereof.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing.

The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The terms “ego” (as in, e.g., “ego device”) and “subject” (as in, e.g., “data subject”) at least in some examples refers to an entity, element, device, system, and the like, that is under consideration or being considered. The terms “neighbor” and “proximate” (as in, e.g., “proximate device”) at least in some examples refers to an entity, element, device, system, and the like, other than an ego device or subject device.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification.

The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database. The term “application identifier”, “application ID”, or “app ID” at least in some examples refers to an identifier that can be mapped to a specific application, application instance, or application instance. In the context of 3GPP 5G/NR, an “application identifier” at least in some examples refers to an identifier that can be mapped to a specific application traffic detection rule.

The term “circuitry” at least in some examples refers to a circuit, a system of multiple circuits, and/or a combination of hardware elements configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), system-on-chip (SoC), single-board computer (SBC), system-in-package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The terms “computer-readable medium”, “machine-readable medium”, “computer-readable storage medium”, and the like, at least in some examples refers to any tangible medium that is capable of storing, encoding, and/or carrying data structures, code, and/or instructions for execution by a processing device or other machine. Additionally or alternatively, the terms “computer-readable medium”, “machine-readable medium”, “computer-readable storage medium”, and the like, at least in some examples refers to any tangible medium that is capable of storing, encoding, and/or carrying data structures, code, and/or instructions that cause the processing device or machine to perform any one or more of the methodologies of the present disclosure. The terms “computer-readable medium”, “machine-readable medium”, “computer-readable storage medium”, and the like, at least in some examples refers include, but is/are not limited to, memory device(s), storage device(s) (including portable or fixed), and/or any other media capable of storing, containing, or carrying instructions or data.

The term “device” at least in some examples refers to a physical entity embedded inside, or attached to, another physical entity in its vicinity, with capabilities to convey digital information from or to that physical entity. The term “entity” at least in some examples refers to a distinct component of an architecture or device, or information transferred as a payload. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” may include any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices. The term “station” or “STA” at least in some examples refers to a logical entity that is a singly addressable instance of a medium access control (MAC) and physical layer (PHY) interface to the wireless medium (WM). The term “wireless medium” or WM” at least in some examples refers to the medium used to implement the transfer of protocol data units (PDUs) between peer physical layer (PHY) entities of a wireless local area network (LAN).

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like. The term “network controller” at least in some examples refers to a functional block that centralizes some or all of the control and management functionality of a network domain and may provide an abstract view of the network domain to other functional blocks via an interface.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware. The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN. The term “E-UTEAN NodeB”, “eNodeB”, or “eNB” at least in some examples refers to a RAN node providing E-UTRA user plane (PDCP/RLC/MAC/PHY) and control plane (RRC) protocol terminations towards a UE, and connected via an Si interface to the Evolved Packet Core (EPC). Two or more eNBs are interconnected with each other (and/or with one or more en-gNBs) by means of an X2 interface. The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface. The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface. The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g., 3GPP TS 37.340 v17.0.0 (2022-04-15) (“[TS37340]”)). Two or more en-gNBs are interconnected with each other (and/or with one or more eNBs) by means of an X2 interface. The term “Next Generation RAN node” or “NG-RAN node” at least in some examples refers to either a gNB or an ng-eNB. The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g., a gNB) that provides network access to UEs via a network of backhaul and access links. The term “Transmission Reception Point” or “TRxP” at least in some examples refers to an antenna array with one or more antenna elements available to a network located at a specific geographical location for a specific area. The term “access point” or “AP” at least in some examples refers to an entity that contains one station (STA) and provides access to the distribution services, via the wireless medium (WM) for associated STAs. An AP comprises a STA and a distribution system access function (DSAF).

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “protocol” at least in some examples refers to a predefined procedure or method of performing one or more operations. Additionally or alternatively, the term “protocol” at least in some examples refers to a common means for unrelated objects or nodes to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and may include identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT (MQ Telemetry Transport), Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), SBMV Protocol, Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (pTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet (e.g., IEEE Standard for Ethernet, IEEE Std 802.3-2018, pp. 1-5600 (31 Aug. 2018) (“[IEEE802.3]”), RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signaling Radio Bearers (SRBs) and Data Radio Bearers (DRBs); mobility functions/services; QoS management; and some sidelink specific services and functions over the Uu interface (see e.g., 3GPP TS 36.331 v17.2.0 (2022-10-04) (“[TS36331]”) and/or 3GPP TS 38.331 v17.2.0 (2022-10-02) (“[TS38331]”)).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324 v17.0.0 (2022-04-13)).

The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 v17.1.0 (2022-07-17) and/or 3GPP TS 38.323 v17.2.0 (2022-09-29)).

The term “radio link control layer”, “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 38.322 v17.1.0 (2022-07-17) and 3GPP TS 36.322 v17.0.0 (2022-04-15)).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., [IEEE802], 3GPP TS 38.321 v17.2.0 (2022-10-01) and 3GPP TS 36.321 v17.2.0 (2022-10-03)).

The term “physical layer”, “PHY layer”, or “PHY” at least in some examples refers to a protocol layer or sublayer that includes capabilities to transmit and receive modulated signals for communicating in a communications network (see e.g., [IEEE802], 3GPP TS 38.201 v17.0.0 (2022-01-05) and 3GPP TS 36.201 v17.0.0 (2022-03-31)).

The term “radio technology” at least in some examples refers to technology for wireless transmission and/or reception of electromagnetic radiation for information transfer. The term “radio access technology” or “RAT” at least in some examples refers to the technology used for the underlying physical connection to a radio based communication network. The term “RAT type” at least in some examples may identify a transmission technology and/or communication protocol used in an access network, for example, new radio (NR), Long Term Evolution (LTE), narrowband IoT (NB-IOT), untrusted non-3GPP, trusted non-3GPP, trusted Institute of Electrical and Electronics Engineers (IEEE) 802 (e.g., [IEEE80211]; see also IEEE Standard for Local and Metropolitan Area Networks: Overview and Architecture, IEEE Std 802-2014, pp. 1-7⁴ (30 Jun. 2014) (“[IEEE802]”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), and the like); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) (and variants thereof such as HSPA Plus (HSPA+), and the like), Long Term Evolution (LTE) (and variants thereof such as LTE-Advanced (LTE-A), Evolved UTRA (E-UTRA), LTE Extra, LTE-A Pro, LTE LAA, MuLTEfire, and the like), Fifth Generation (5G) or New Radio (NR), and the like; ETSI technologies such as High Performance Radio Metropolitan Area Network (HiperMAN) and the like; IEEE technologies such as [IEEE802] and/or WiFi (e.g., [IEEE80211] and variants thereof), Worldwide Interoperability for Microwave Access (WiMAX) (e.g., [WiMAX] and variants thereof), Mobile Broadband Wireless Access (MBWA)/iBurst (e.g., IEEE 802.20 and variants thereof), and the like; Integrated Digital Enhanced Network (iDEN) (and variants thereof such as Wideband Integrated Digital Enhanced Network (WiDEN); millimeter wave (mmWave) technologies/standards (e.g., wireless systems operating at 10-300 GHz and above such as 3GPP 5G, Wireless Gigabit Alliance (WiGig) standards (e.g., IEEE 802.1 lad, IEEE 802.11ay, and the like); short-range and/or wireless personal area network (WPAN) technologies/standards such as Bluetooth (and variants thereof such as Bluetooth 5.3, Bluetooth Low Energy (BLE), and the like), IEEE 802.15 technologies/standards (e.g., IEEE Standard for Low-Rate Wireless Networks, IEEE Std 802.15.4-2020, pp. 1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks—Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networks—Part 15.7: Short-Range Optical Wireless Communications, IEEE Std 802.15.7-2018, pp. 1-407 (23 Apr. 2019), and the like; V2X communication including 3GPP cellular V2X (C-V2X), Wireless Access in Vehicular Environments (WAVE) (IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp. 1-51 (15 Jul. 2010) (“[IEEE80211p]”), which is now part of [IEEE80211]), IEEE 802.11bd (e.g., for vehicular ad-hoc environments), Dedicated Short Range Communications (DSRC), Intelligent-Transport-Systems (ITS) (including the European ITS-G5, ITS-G5B, ITS-G5C, and the like); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “Collective Perception” or “CP” at least in some examples refers to the concept of sharing the perceived environment of an ITS—S based on perception sensors, wherein an ITS-S broadcasts information about its current (driving) environment. CP at least in some examples refers to the concept of actively exchanging locally perceived objects between different ITS-Ss by means of a V2X RAT. CP decreases the ambient uncertainty of ITS-Ss by contributing information to their mutual FoVs. The term “Collective Perception basic service”, “CP service”, or CPS” at least in some examples refers to a facility at the ITS-S facilities layer to receive and process CPMs, and generate and transmit CPMs. The term “Collective Perception Message” or “CPM” at least in some examples refers to a CP basic service PDU. The term “Collective Perception data” or “CPM data” at least in some examples refers to a partial or complete CPM payload. The term “Collective Perception protocol” or “CPM protocol” at least in some examples refers to an ITS facilities layer protocol for the operation of the CPM generation, transmission, and reception. The term “CP object” or “CPM object” at least in some examples refers to aggregated and interpreted abstract information gathered by perception sensors about other traffic participants and obstacles. CP/CPM Objects can be represented mathematically by a set of variables describing, amongst other, their dynamic state and geometric dimension. The state variables associated to an object are interpreted as an observation for a certain point in time and are therefore always accompanied by a time reference. The term “environment model” at least in some examples refers to a current representation of the immediate environment of an ITS-S, including all perceived objects perceived by either local perception sensors or received by V2X. The term “object” at least in some examples refers to the state space representation of a physically detected object within a sensor's perception range. The term “object list” refers to a collection of objects temporally aligned to the same timestamp.

The term “confidence level” at least in some examples refers to a probability with which an estimation of the location of a statistical parameter (e.g., an arithmetic mean) in a sample survey is also true for a population (e.g., a sample survey that is also true for an entire population from which the samples were taken). The term “confidence value” at least in some examples refers to an estimated absolute accuracy of a statistical parameter (e.g., an arithmetic mean) for a given confidence level (e.g., 95%). Additionally or alternatively, the term “confidence value” or “confidence interval” at least in some examples refers to an estimated interval associated with the estimate of a statistical parameter of a population using sample statistics (e.g., an arithmetic mean) within which the true value of the parameter is expected to lie with a specified probability, equivalently at a given confidence level (e.g., 95%). In some examples, confidence intervals are neither to be confused with nor used as estimated uncertainties (covariances) associated with either the output of stochastic estimation algorithms used for tasks such as kinematic and attitude state estimation and the associated estimate error covariance, or the measurement noise variance associated with a sensor's measurement of a physical quantity (e.g. variance of the output of an accelerometer or specific force meter). The term “detection confidence” at least in some examples refers to a measure related to the certainty, generally a probability. In some examples, the “detection confidence” refers to a sensor or sensor system associates with its output or outputs involving detection of an object or objects from a set of possibilities (e.g., with X % probability the object is a chair, with Y % probability the object is a couch, and with (1−X−Y) % probability it is something else). The term “free space existence confidence” or “perceived region confidence” at least in some examples refers to a quantification of the estimated likelihood that free spaces or unoccupied areas may be detected within a perceived region.

The term “ITS data dictionary” at least in some examples refers to a repository of DEs and DFs used in the ITS applications and ITS facilities layer. The term “ITS message” at least in some examples refers to messages exchanged at ITS facilities layer among ITS stations or messages exchanged at ITS applications layer among ITS stations.

The term “ITS station” or “ITS-S” at least in some examples refers to functional entity specified by the ITS station (ITS-S) reference architecture. The term “personal ITS-S” or “P-ITS-S” refers to an ITS-S in a nomadic ITS sub-system in the context of a portable device (e.g., a mobile device of a pedestrian). The term “Roadside ITS-S” or “R-ITS-S” at least in some examples refers to an ITS-S operating in the context of roadside ITS equipment. The term “Vehicle ITS-S” or “V-ITS-S” at least in some examples refers to an ITS-S operating in the context of vehicular ITS equipment. The term “ITS central system” or “Central ITS-S” refers to an ITS system in the backend, for example, traffic control center, traffic management center, or cloud system from road authorities, ITS application suppliers or automotive OEMs.

The term “object” at least in some examples refers to a material thing that can be detected and with which parameters can be associated that can be measured and/or estimated. The term “object existence confidence” at least in some examples refers to a quantification of the estimated likelihood that a detected object exists, i.e., has been detected previously and has continuously been detected by a sensor. The term “object list” at least in some examples refers to a collection of objects and/or a data structure including a collection of detected objects.

The term “sensor measurement” at least in some examples refers to abstract object descriptions generated or provided by feature extraction algorithm(s), which may be based on the measurement principle of a local perception sensor mounted to a station/UE, wherein a feature extraction algorithm processes a sensor's raw data (e.g., reflection images, camera images, and the like) to generate an object description. The term “state space tepresentation” at least om some examples refers to a mathematical description of a detected object (or perceived object), which includes a set of state variables, such as distance, position, velocity or speed, attitude, angular rate, object dimensions, and/or the like. In some examples, state variables associated with/to an object are interpreted as an observation for a certain point in time, and are accompanied by a time reference.

The term “vehicle” at least in some examples refers to a road vehicle designed to carry people or cargo on public roads and highways such as CA/AD vehicles, busses, cars, trucks, vans, motor homes, and motorcycles; by water such as boats, ships, and the like; or in the air such as airplanes, helicopters, UAVs, satellites, and the like.

The term “Vehicle-to-Everything” or “V2X” at least in some examples refers to vehicle to vehicle (V2V), vehicle to infrastructure (V21), infrastructure to vehicle (12V), vehicle to network (V2N), and/or network to vehicle (N2V) communications and associated RATs.

The term “application” at least in some examples refers to a computer program designed to carry out a specific task other than one relating to the operation of the computer itself. Additionally or alternatively, term “application” at least in some examples refers to a complete and deployable package, environment to achieve a certain function in an operational environment. The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, operating system, database system, computer hardware, software library, and/or the like. The term “process” at least in some examples refers to an instance of a computer program that is being executed by one or more threads. In some implementations, a process may be made up of multiple threads of execution that execute instructions concurrently. The term “algorithm” at least in some examples refers to an unambiguous specification of how to solve a problem or a class of problems by performing calculations, input/output operations, data processing, automated reasoning tasks, and/or the like. The terms “instantiate,” “instantiation,” and the like at least in some examples refers to the creation of an instance. An “instance” also at least in some examples refers to a concrete occurrence of an object, which may occur, for example, during execution of program code.

The term “data unit” at least in some examples at least in some examples refers to a basic transfer unit associated with a packet-switched network; a datagram may be structured to have header and payload sections. The term “data unit” at least in some examples may be synonymous with any of the following terms, even though they may refer to different aspects: “datagram”, a “protocol data unit” or “PDU”, a “service data unit” or “SDU”, “frame”, “packet”, a “network packet”, “segment”, “block”, “cell”, “chunk”, “message”, “information element” or “IE”, “Type Length Value” or “TLV”, and/or the like. Examples of datagrams, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a [IEEE802] protocol/standard (e.g., [IEEE80211] or the like), Type Length Value (TLV), and/or other like data structures.

The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some examples refers to a data type that contains one single data. In some examples, the data stored in a data element may be referred to as the data element's content, “content item”, or “item”.

Although many of the previous examples are provided with use of specific cellular/mobile network terminology, including with the use of 4G/5G 3GPP network components (or expected terahertz-based 6G/6G+ technologies), it will be understood these examples may be applied to many other deployments of wide area and local wireless networks, as well as the integration of wired networks (including optical networks and associated fibers, transceivers, and/or the like). Furthermore, various standards (e.g, 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1. An Intelligent Transport System Station (ITS-S), comprising:
processor circuitry to operate to a collective perception service (CPS) facility to:
generate a first collective perception message (CPM) during a first CPM generation period, wherein the first CPM includes at least one perceived object container (POC), and the at least one POC includes data related to an individual object perceived by the ITS-S, and
generate a second CPM during a second CPM generation period, wherein the second CPM generation period is smaller than the first CPM generation period, the second CPM includes at least one costmap container (CMC), and the at least one CMC includes data related to a costmap generated by the ITS-S; and
communication circuitry connected to the processor circuitry, wherein the communication circuitry is to:
transmit or broadcast the first CPM during the first CPM generation period, and
transmit or broadcast the second CPM during the second CPM generation period.

2. The ITS-S of claim 1, wherein the processor circuitry is to operate the CPS facility to:
generate the first CPM in response to a first periodic CPM generation event being triggered; and
generate the second CPM in response to a second periodic CPM generation event being triggered.

3. The ITS-S of claim 1, wherein a size of the second CPM generation period is equal to or larger than a CPM generation event periodicity (T_GenCpm), wherein the T_GenCpm is a time elapsed between triggering of consecutive CPM generation events.

4. The ITS-S of claim 3, wherein a size of the first CPM generation period is based on an object type of the individual object perceived by the ITS-S.

5. The ITS-S of claim 4, wherein the individual object perceived by the ITS-S is a static object.

6. The ITS-S of claim 4, wherein the individual object perceived by the ITS-S is a non-safety critical dynamic object.

7. The ITS-S of claim 4, wherein the individual object perceived by the ITS-S is a safety critical dynamic object.

8. The ITS-S of claim 1, wherein the processor circuitry is to operate the CPS facility to:
generate the first CPM when a time elapsed since a last time the individual object was included in a previous first CPM has exceeded a first time threshold; and
generate the second CPM when a time elapsed since a last time the costmap was included in a previous second CPM has exceeded a second time threshold.

9. The ITS-S of claim 8, wherein the first time threshold is greater than or equal to the second time threshold.

10. The ITS-S of claim 1, wherein the processor circuitry is to operate the CPS facility to:
generate the first CPM when a difference between a current estimated ground speed of a to reference point of the individual object and an estimated absolute speed of the reference point of the individual object included in a previous first CPM exceeds a minimum ground speed change threshold.

11. The ITS-S of claim 1, wherein the processor circuitry is to operate the CPS facility to:
generate the first CPM when an orientation of the individual object's estimated ground velocity orientation, at its reference point, has changed by at least a ground velocity orientation change threshold since a last time the individual object was included in a previous first CPM.

12. The ITS-S of claim 1, wherein the processor circuitry is to operate the CPS facility to:
generate the first CPM without a free space addendum container (FSAC).

13. The ITS-S of claim 1, wherein the processor circuitry is to operate the CPS facility to:
generate the first CPM to include the POC and an FSAC when a previous number of first CPMs did not include an FSAC.

14. The ITS-S of claim 1, wherein the processor circuitry is to operate the CPS facility to:
generate the first CPM to include the POC and an FSAC when a previous number of first CPMs did not include an FSAC.

15. The ITS-S of claim 1, wherein the first CPM includes a first management container, the second CPM includes a second management container, and each of the first management container and the second management container include a CPM identifier (ID).

16. The ITS-S of claim 15, wherein the at least one CMC includes a reference-to-last-CPM container, and the reference-to-last-CPM container includes a CPM ID of a previously transmitted first CPM or a CPM ID of a previously transmitted second CPM.

17. The ITS-S of claim 1, wherein the ITS-S is a vehicle ITS-S, a roadside ITS-S, or a vulnerable road user ITS-S.

18. One or more non-transitory computer readable medium comprising instructions of a collective perception service (CPS) facility, wherein execution of the instructions is to cause an Intelligent Transport System Station (ITS-S) to:
generate a first collective perception message (CPM) during a first CPM generation period, wherein the first CPM includes at least one perceived object container (POC), and the at least one POC includes data related to an individual object perceived by the ITS-S;
cause transmission or broadcast of the first CPM during the first CPM generation period;
generate a second CPM during a second CPM generation period, wherein the second CPM generation period is smaller than the first CPM generation period, the second CPM includes at least one costmap container (CMC), and the at least one CMC includes data related to a costmap generated by the ITS-S; and
cause transmission or broadcast of the second CPM during the second CPM generation period.

19. The one or more non-transitory computer readable medium of claim 18, wherein the costmap includes a set of cells, each cell of the set of cells includes a cost value and an associated confidence level, wherein the cost value indicates a perceived cost of traveling through that cell.

20. The one or more non-transitory computer readable medium of claim 19, wherein the data related to the costmap generated by the ITS-S includes one or more of dimensions of the costmap, a number of cells in the set of cells, dimensions of each cell in the set of cells, a cost value for each cell, and a confidence level for each cell.

21. The one or more non-transitory computer readable medium of claim 19, wherein execution of the instructions is to cause the ITS-S to:
generate the second CPM when a threshold number of cells in the set of cells has changed cost values or changed confidence levels when compared to cost values or confidence levels included in a previously generated second CPM.

22. The one or more non-transitory computer readable medium of claim 19, wherein execution of the instructions is to cause the ITS-S to:
generate the second CPM when a distance of a center point of the costmap to be included in the second CPM and a center point of another costmap included in a previously generated second CPM exceeds a threshold distance.

23. The one or more non-transitory computer readable medium of claim 19, wherein execution of the instructions is to cause the ITS-S to:
generate the second CPM when a difference between one or more dimensions of the costmap and one or more other dimensions of another costmap included in a previously generated second CPM exceeds a threshold size.

24. The one or more non-transitory computer readable medium of claim 19, wherein execution of the instructions is to cause the ITS-S to:
generate the second CPM when a difference between an orientation of the costmap and another orientation of another costmap included in a previously generated second CPM exceeds a threshold orientation.

25. A method of operating a collective perception service (CPS) facility of an Intelligent Transport System Station (ITS-S), wherein the method comprises:
generating a first collective perception message (CPM) during a first CPM generation period, wherein the first CPM includes at least one perceived object container (POC), and the at least one POC includes data related to an individual object perceived by the ITS-S;
transmitting or broadcasting the first CPM during the first CPM generation period;
generating a second CPM during a second CPM generation period, wherein the second CPM generation period is smaller than the first CPM generation period, the second CPM includes at least one costmap container (CMC), and the at least one CMC includes data related to a costmap generated by the ITS-S; and
transmitting or broadcasting the second CPM during the second CPM generation period.
